(19) United States
(12) Patent Application Publication
(10) Pub. No.: US 2026/0153034 A1
(43) Pub. Date: Jun. 4, 2026

(54) TURBOFAN ENGINE INCLUDING A FAN ACTUATION SYSTEM

(71) Applicant: General Electric Company, Evendale, OH (US)

(72) Inventors: Randy M. Vondrell, Newport, KY (US); Keith A. Miedema, Fairfield, OH (US); Gerardo Perez, Queretaro (MX); Jeremy Bushey, Grabill, IN (US)

(21) Appl. No.: 19/465,500

(22) Filed: Jan. 30, 2026

Related U.S. Application Data
(63) Continuation-in-part of application No. 19/357,928, filed on Oct. 14, 2025.
Application No. 19/357,928 is a continuation-in-part of application No. 19/097,493, filed on Apr. 1, 2025, now Pat. No. 12,480,415.
Application No. 19/097,493 is a continuation-in-part of application No. 18/400,746, filed on Dec. 29, 2023, now Pat. No. 12,345,178.

(51) Int. Cl. F01D 7/00; B64D 27/10; F01D 17/16; F01D 25/16

(52) U.S. Cl. CPC F01D 7/00; B64D 27/10; F01D 17/16; F01D 25/16; F05D 2220/36; F05D 2240/54

(57) ABSTRACT

A turbofan engine for an aircraft includes a fan, one or more sensors for providing sensor data indicative of an excitation load, and a fan actuation system. The fan has a plurality of fan blades coupled to a fan shaft having one or more fan bearings. The fan actuation system is disposed within a fan hub and includes one or more actuators for rotating the fan blades about the pitch axis and one or more radial thrust bearings. The fan actuation system is characterized by a fan actuation system length envelope in a range from 8.5 to 24 and given by

$$\frac{{N}_{FB} \times {D}_{FT}}{{L}_{AXIAL} \times ( \frac{{R}_{TB}}{{N}_{FB}} )} .$$

N_{FB} is a number of the fan blades, D_{FT} is a fan tip diameter of the fan blades, R_{TB} is a thrust bearing radius of the radial thrust bearings, and L_{AXIAL} is an axial length from a fan hub tip to the fan bearings.

### CROSS REFERENCE TO RELATED APPLICATIONS

This application is a continuation-in-part of U.S. patent application Ser. No. 19/357,928, filed Oct. 14, 2025, which is a continuation-in-part of U.S. patent application Ser. No. 19/097,493, filed Apr. 1, 2025, which is a continuation-in-part of U.S. patent application Ser. No. 18/400,746, filed on Dec. 29, 2023, and issued as U.S. Pat. No. 12,345,178 on Jul. 1, 2025, the contents of all of which are hereby incorporated by reference herein in their entireties.

### TECHNICAL FIELD

The present disclosure relates generally to fan actuation systems for turbofan engines.

### BACKGROUND

Turbofan engines, for example, for an aircraft, generally include a fan having fan blades, a compressor section, a combustion section, and a turbine section arranged in flow communication with one another. Some turbofan engines include a fan actuation system for actuating the fan blades of the fan.

### BRIEF DESCRIPTION OF THE DRAWINGS

The foregoing and other features and advantages will be apparent from the following, more particular, description of various exemplary aspects, as illustrated in the accompanying drawings, wherein like reference numbers generally indicate identical, functionally similar, or structurally similar elements.

FIG. 1 is a schematic cross-sectional diagram of a turbofan engine, taken along a longitudinal centerline axis of the turbofan engine, according to the present disclosure.

FIG. 2 shows a schematic view of a turbofan engine, according to the present disclosure.

FIG. 3 shows a fan having a fan actuation system, according to the present disclosure.

FIG. 4 is a schematic cross-sectional diagram of a fan actuation system for a turbofan engine, taken along a longitudinal centerline axis of the turbofan engine, according to the present disclosure.

FIG. 5 is a schematic cross-sectional view of a fan actuation system for a turbofan engine, according to another aspect.

FIG. 6 is a schematic cross-sectional view of a fan actuation system for the turbofan engine, taken along the longitudinal centerline axis of the turbofan engine, according to the present disclosure.

FIG. 7 is a schematic cross-sectional view of a fan actuation system for the turbofan engine, taken along the longitudinal centerline axis of the turbofan engine, according to another aspect.

FIG. 8 is a schematic cross-sectional view of a fan actuation system for the turbofan engine, taken along the longitudinal centerline axis of the turbofan engine, according to another aspect.

FIG. 9 is a schematic cross-sectional view of a fan actuation system for the turbofan engine, taken along the longitudinal centerline axis of the turbofan engine, according to another aspect.

FIG. 10 is a schematic cross-sectional view of a fan actuation system for the turbofan engine, taken along the longitudinal centerline axis of the turbofan engine, according to another aspect.

FIG. 11 represents, in graph form, a fan actuation system envelope as a function of a loading envelope, according to the present disclosure.

FIG. 12 represents, in graph form, the fan actuation system envelope as a function of a spacing envelope, according to the present disclosure.

FIG. 13 represents, in graph form, a fan actuation system length envelope as a function of a loading envelope, according to the present disclosure.

FIG. 14 represents, in graph form, the fan actuation system length envelope as a function of a spacing envelope, according to the present disclosure.

FIG. 15 is a schematic view of a forward end of a fan of the turbofan engine of FIG. 2, according to the present disclosure.

FIG. 16 is an enlarged, schematic, cross-sectional diagram of the turbofan engine of FIG. 1 and having one or more fan bearings, taken at detail 16 in FIG. 1, according to the present disclosure.

FIG. 17 is an enlarged, schematic, cross-sectional diagram of the turbofan engine of FIG. 1 and having one or more fan bearings, taken along the longitudinal centerline axis, according to another aspect.

FIG. 18 is a schematic cross-sectional view of a fan bearing for the turbofan engine of FIG. 1, according to another aspect.

FIG. 19 represents, in graph form, a fan bearing envelope as a function of a takeoff thrust of the turbofan engine, according to the present disclosure.

FIG. 20 represents, in graph form, the fan bearing envelope as a function of the takeoff thrust, according to another aspect.

FIG. 21 is an enlarged schematic, cross-sectional view of a segment of a fan of having a fan actuation system, according to another aspect.

FIG. 22 schematically depicts an exemplary aircraft in accordance with an exemplary embodiment of the present disclosure;

FIG. 23; shows a cross-sectional view schematically depicting additional aspects of the open rotor aeronautical engine that may be utilized to provide thrust for the aircraft shown in FIG. 22;

FIGS. 24A-24H schematically depict aspects of exemplary fan actuation assemblies that may be utilized to change a pitch of one or more airfoils of an open rotor aeronautical engine;

FIGS. 25A and 25B schematically depicts aspects of exemplary airfoil excitation control modules;

FIG. 26 schematically depicts exemplary sensor data that may be utilized by an airfoil excitation control module;

FIG. 27 schematically depicts an exemplary control system that may be utilized to control and aircraft and/or one or more open rotor aeronautical engines; and

FIG. 28 shows a flow chart depicting an exemplary methods of operating an open rotor aeronautical engine.

### DETAILED DESCRIPTION

Features, advantages, and aspects of the present disclosure are set forth or apparent from a consideration of the following detailed description, drawings, and claims. Moreover, the following detailed description is exemplary and intended to provide further explanation without limiting the scope of the disclosure as claimed.

Various aspects of the present disclosure are discussed in detail below. While specific aspects are discussed, this is done for illustration purposes only. A person skilled in the relevant art will recognize that other components and configurations may be used without departing from the present disclosure.

As used herein, the terms “first,” “second,” “third,” and “fourth” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbofan engine or vehicle, and refer to the normal operational attitude of the turbofan engine or vehicle. For example, with regard to a turbofan engine, forward refers to a position closer to an engine inlet and aft refers to a position closer to an engine nozzle or exhaust.

As used herein, the terms “low,” “mid” (or “mid-level”), and “high,” or their respective comparative degrees (e.g., “lower” and “higher”, where applicable), when used with compressor, combustor, turbine, shaft, fan, or turbofan engine components, each refers to relative pressures, relative speeds, relative temperatures, or relative power outputs within an engine unless otherwise specified. For example, a “low-power” setting defines the engine or the combustor configured to operate at a power output lower than a “high-power” setting of the engine or the combustor, and a “mid-level power” setting defines the engine or the combustor configured to operate at a power output higher than a “low-power” setting and lower than a “high-power” setting. The terms “low,” “mid” (or “mid-level”) or “high” in such aforementioned terms may additionally, or alternatively, be understood as relative to minimum allowable speeds, pressures, or temperatures, or minimum or maximum allowable speeds, pressures, or temperatures relative to normal, desired, steady state, etc., operation of the engine. A mission cycle for a turbofan engine includes, for example, a low-power operation, a mid-level power operation, and a high-power operation. Low-power operation includes, for example, engine start, idle, taxiing, and approach. Mid-level power operation includes, for example, cruise. High-power operation includes, for example, takeoff and climb.

The various power levels of the turbofan engine are defined as a percentage of a sea level static (SLS) maximum engine rated thrust. Low power operation includes, for example, less than thirty percent (30%) of the SLS maximum engine rated thrust of the turbofan engine. Mid-level power operation includes, for example, thirty percent (30%) to eighty-five percent (85%) of the SLS maximum engine rated thrust of the turbofan engine. High power operation includes, for example, greater than eighty-five percent (85%) of the SLS maximum engine rated thrust of the turbofan engine. The values of the thrust for each of the low power operation, the mid-level power operation, and the high power operation of the turbofan engine are exemplary only, and other values of the thrust can be used to define the low power operation, the mid-level power operation, and the high power operation.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a centerline of the turbofan engine. Moreover, the terms “radial” and “radially” refer to directions and orientations that extend substantially perpendicular to the centerline of the turbofan engine. In addition, as used herein, the terms “circumferential” and “circumferentially” refer to directions and orientations that extend arcuately about the centerline of the turbofan engine.

As used herein, a “turbofan engine” includes a core flowpath defined by a compressor section, a combustion section, and a turbine section, and a fan that directs air into the core flowpath, and rated for use in a regional aircraft, a narrow body aircraft, or a wide body aircraft. A turbofan engine rated for use on a regional aircraft will have a maximum takeoff thrust in a range from ten thousand pound-force to twenty thousand pound-force (10,000 lbf to 20,000 lbf). A turbofan engine rated for use on a narrow body aircraft will have a maximum takeoff thrust in a range from fifteen thousand pound-force to thirty thousand pound-force (15,000 lbf to 30,000 lbf). A turbofan engine rated for use on a wide body aircraft will have a maximum takeoff thrust in a range from forty thousand pound-force to one hundred ten thousand pound-force (40,000 lbf to 110,000 lbf).

As used herein, the term “cruise” or “cruising speed” refers to operation of a turbofan engine utilized to power an aircraft that may operate at a cruising speed when the aircraft levels after climbing to a specified altitude. A turbofan engine may operate at a cruising speed that is from 50% to 90% of a rated speed, such as from 70% to 80% of the rated speed. In some example embodiments, a cruising speed may be achieved at about 80% of full throttle, such as from about 50% to about 90% of full throttle, such as from about 70% to about 80% full throttle. As used herein, the term “cruise flight” refers to a phase of flight in which an aircraft levels in altitude after a climb phase and prior to descending to an approach phase. In various examples, cruise flight may take place at a cruise altitude up to approximately 65,000 ft. In certain examples, cruise altitude is in a range from approximately 28,000 ft. to approximately 45,000 ft. In yet other examples, cruise altitude is expressed in flight levels (FL) based on a standard air pressure at sea level, in which cruise flight is between FL280 and FL650. In another example, cruise flight is between FL280 and FL450. In still certain examples, cruise altitude is defined based at least on a barometric pressure, in which cruise altitude is in a range from approximately 4.85 psia to approximately 0.82 psia based on a sea-level pressure of approximately 14.70 psia and sea-level temperature at approximately 59 degrees Fahrenheit. In another example, cruise altitude is in a range from approximately 4.85 psia to approximately 2.14 psia. In certain examples, the ranges of cruise altitude defined by pressure may be adjusted based on a different reference sea-level pressure and/or sea-level temperature.

As used herein, the term “ducted engine” means a turbofan engine with a fan casing or nacelle that circumferentially surrounds the fan.

As used herein, an “unducted fan engine” or an “open fan engine” means a turbofan engine without a fan casing or a nacelle surrounding the fan.

Hereafter, the term “turbofan engine” will refer to either a “ducted engine” or an “open fan engine.”

As used herein, a “fan tip diameter” is defined as a diameter of a fan blade and is measured from the longitudinal centerline axis of the turbofan engine to a fan tip of the fan blade at an axial location of the blade where the diameter is a maximum.

As used herein, a Mach number is a ratio of the speed of the aircraft to the speed of sound in the surrounding airflow. The Mach number at cruise as defined herein is a maximum operating Mach number as provided by a Type Certificate Data Sheet (TCDS) for the turbofan engine.

An aircraft's quoted cruise Mach number is generally known in the industry to be applied during a “standard day” temperature day. Therefore, the temperature is a fixed value based on altitude according to the established International Standard Atmosphere (ISA) tables. High speed civil gas turbine powered transport aircraft quote their speed by Mach number and have set cruising altitudes based on their size and mission profile (e.g., smaller aircraft fly at lower altitudes). Turboprops and smaller aircraft may have their cruising speed quoted in knots such as VTAS (velocity true airspeed) or KCAS (knots calibrated air speed), where ambient temperature is considered. Engine performance can be modeled for “hot days” or “cold days” where the ambient temperature is hotter or cooler than standard day by a prescribed amount, but this is part of off-design performance. Further, between 36,000 and 80,000 feet, where most commercial aircraft cruise, the ambient temperature is actually constant.

As used herein, a “thrust bearing radius” of a radial thrust bearing is defined in the radial direction from the longitudinal centerline axis to a radial center of the radial thrust bearing. Particularly, the radial center of the radial thrust bearing is a radial center of the rolling elements of the radial thrust bearing.

As used herein, a “fan hub axial length” is an axial length, in the axial direction (e.g., parallel with the longitudinal centerline axis 112) from a fan hub tip of the fan hub to a pitch axis P of the fan blades of the fan.

As used herein, a “fan actuation system axial length” is an axial length, in the axial direction (e.g., parallel with the longitudinal centerline axis 112), from an axially forward-most surface of the fan actuation system to the pitch axis P of the fan blades of the fan.

As used herein, a “fan bearing axial length” is an axial length, in the axial direction (e.g., parallel with the longitudinal centerline axis 112) from the pitch axis P of the fan blades of the fan to an axial center of one or more fan bearings that support rotation of the fan shaft.

The term “leading edge” refers to components and/or surfaces which are oriented predominately upstream relative to the fluid flow of the system, and the term “trailing edge” refers to components and/or surfaces which are oriented predominately downstream relative to the fluid flow of the system.

As used herein, a “rolling element diameter” of a rolling element of the fan bearing is a distance of a straight line passing from side to side through a center of the rolling element.

As used herein, a “fan hub trailing edge radius” or “R_{FHTE}” of a fan hub is defined in the radial direction from the longitudinal centerline axis to the fan hub at a trailing edge of the fan blades.

As used herein, a “fan tip radius” of a fan blade is defined in the radial direction from the longitudinal centerline axis to the fan tip at the trailing edge of the fan blade.

As used herein, a “fan hub radius ratio” is defined as a ratio of the fan hub trailing edge radius R_{FHTE} to the fan tip radius of the fan blades.

As used herein, a “fan hub leading edge radius” or “R_{FHLE}” of a fan hub is defined in the radial direction from the longitudinal centerline axis to the fan hub at a leading edge of the fan blades.

As used herein, a “fan bearing radius” or “R_{FBRG}” of a fan bearing is defined as a distance along the radial direction from the longitudinal centerline axis of the turbofan engine to a central axis or a center point of the fan bearing.

As used herein, a “fan bearing radius ratio” or “R_{FHLE}:R_{FBRG}” is a ratio of the fan hub leading edge radius R_{FHLE} to the fan bearing radius R_{FBRG}.

As used herein, the term “rated speed” with reference to a gas turbine engine refers to a maximum rotational speed that the gas turbine engine may achieve while operating properly. For example, the gas turbine engine may be operating at the rated speed during maximum load operations, such as during takeoff operations.

As used herein, the term “fan pressure ratio” as it relates to a plurality of fan blades of a fan, refers to a ratio of an air pressure immediately downstream of the fan blades during operation of the fan to an air pressure immediately upstream of the fan blades of the fan during operation of the fan.

Here and throughout the specification and claims, range limitations are combined and interchanged. Such ranges are identified and include all the sub-ranges contained therein unless context or language indicates otherwise. For example, all ranges disclosed herein are inclusive of the endpoints, and the endpoints are independently combinable with each other.

The present disclosure provides for turbofan engines that have a variable pitch fan. Such engines include a fan actuation system that includes one or more actuators for changing a pitch of fan blades of the variable pitch fan. The fan actuation system typically includes a hydraulic system that supplies hydraulic fluid to one or more chambers to actuate the actuators. The actuators are coupled to the fan blades and actuation of the actuators causes the fan blades to rotate about a pitch axis P to change the pitch of the fan blades. Some fan actuation systems are designed for turboprop engines that include a propeller, rather than a fan.

Turboprop engines produce less thrust than turbofan engines. Turboprop engines typically provide cruise speeds for an aircraft with a Mach number that is less than 0.7 and have fewer than ten propeller blades, such as fewer than eight propeller blades or fewer than five propeller blades. Turbofan engines include ten or more fan blades that extend from a disk and provide cruise speeds for an aircraft with a Mach number that is 0.7 or greater. To achieve these higher speeds, the fan aerodynamics for the turbofan engines are different than the propeller aerodynamics for turboprop engines, resulting in the turbofan engines having more fan blades for aerodynamic efficiency at higher Mach speeds. Turbofan engines with variable pitch fan blades also benefit from guide vanes, such as outlet guide vanes behind the fan blades, and/or inlet guide vanes forward of the fan, to reduce losses at higher speeds.

The loading environment associated with the variable pitch mechanism for turboprop engines is less than the loading environment presented for a variable pitch turbofan engine. There is a lower disk loading capability requirement on parts (e.g., trunnion, bearings, gearing, actuators, etc.) and associated less actuation force resources needed (e.g., hydraulic fluid) to operate a variable pitch turboprop as compared to a variable pitch turbofan engine. At the same time, the available space, the desirable space, or the volume in that part of the engine for the higher-load-carrying fan blade pitch actuation system and the greater number of blades of a turbofan engine is not correspondingly larger than the space available for the lower-load-carrying fan blade pitch actuation system with fewer fan blades of a turboprop. Turbofan engines having variable pitch fan blades require more compactness for the pitch change system, relative to a turboprop, when considering the larger space requirements assumed if one were to simply scale-up a pitch actuation system for a turboprop for use in a turbofan engine. This can be realized when one considers that a larger, stronger structure is needed to support the more numerous blades and react the higher pitch loads associated with a turbofan engine. One cannot simply scale-up the space available for a pitch change mechanism and associated structure, and also scale up to account for the impact of a significantly increased number of blades when designing a variable pitch turbofan engine. Accommodation of the pitch change mechanism, trunnion, and associated structure for holding and articulating the fan blades within an engine housing therefore presents unique challenges for the turbofan engine in terms of the available space. The existing pitch change mechanisms and structure used to support blades in turboprop engines are not faced with similar challenges and therefore provide limited insight into how to implement a variable pitch mechanism within the more limited space, and more numerous fan blade system of a turbofan engine.

Many actuation systems for turboprop engines include a counterweight system to help pitch the propeller blades (e.g., the weight counteracts inertial loading associated with turning the propeller blade). For turbofan engines, a counterweight system may not be feasible because there is not the space available to accommodate the counterweight system. Thus, an alternative is needed to articulate the blades without exceeding load limits, which implies more compactness given the limited space available. Additionally, it was realized that pitch lock devices to lock the more-numerous fan blades in a feather position for turbofan engines, in case of fan actuation system failure, need to be considered when determining the minimum size needed for the turbofan engine fan actuation system. Additionally, the different types of inlets between a turboprop engine, on the one hand, and turbofan engine on the other hand, impact the amount of available space within the engine housing. Inlets to the turbofan engine (e.g., inlet to the hot gas path through the compressor section, the combustion section, and the turbine section) of a turboprop engine have a relatively narrow circumferential extent (sometimes called “chin” inlets). As such, there is more space available for a pitch change mechanism. Inlets to turbofan engines, however, have annular inlets, which take up more space within the engine housing than the more limited circumferential extent occupied by a turboprop inlet. Accommodating both a pitch change mechanism and annular inlet poses a unique challenge for a turbofan engine with variable pitch fan blades.

For at least these reasons, the loading on a pitch change mechanism and packaging of this system for a turbofan engine having greater number of blades than a turboprop engine presents challenges. It is not simply a matter of scaling-up the space available and size of component parts used in a turboprop engine fan actuation system. Indeed, it has been found that the problem is both unique to the engine type and complex, not amenable to a ready solution based on pre-existing variable pitch turboprop engine design. The inventors, seeking a need to find a solution to this problem, designed and tested several different turbofan engine architectures in an effort to arrive at a fan actuation system that met both the higher loading and more compact space requirements of a turbofan engine.

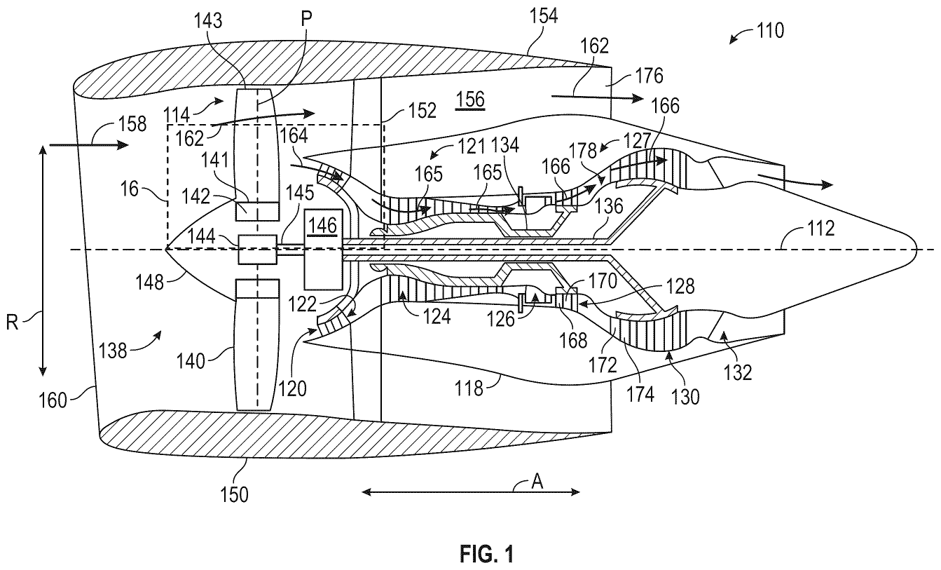

Referring now to the drawings, FIG. 1 is a schematic cross-sectional diagram of a turbofan engine 110, taken along a longitudinal centerline axis 112 of the turbofan engine 110, according to an aspect of the present disclosure. As shown in FIG. 1, the turbofan engine 110 defines an axial direction A (extending parallel to the longitudinal centerline axis 112 provided for reference) and a radial direction R that is normal to the axial direction A. In general, the turbofan engine 110 includes, in serial flow relationship, a fan assembly 114, a compressor section 121, a combustion section 126, and a turbine section 127. The compressor section 121, the combustion section 126, and the turbine section 127 are substantially enclosed within a core cowl 118 that is substantially tubular and defines a core inlet 120 having an annular shape that is annular about the longitudinal centerline axis 112. As schematically shown in FIG. 1, the compressor section 121 includes a booster or a low-pressure (LP) compressor 122 followed downstream by a high-pressure (HP) compressor 124. The combustion section 126 is downstream of the compressor section 121 and includes a combustor. The turbine section 127 is downstream of the combustion section 126 and includes a high-pressure (HP) turbine 128 followed downstream by a low-pressure (LP) turbine 130, also referred to as a power turbine. The turbofan engine 110 also includes a core exhaust nozzle 132 that is downstream of the turbine section 127. The turbofan engine 110 further includes a high-pressure (HP) shaft 134, also referred to as a high-speed shaft, that drivingly connects the HP turbine 128 to the HP compressor 124. The HP turbine 128 and the HP compressor 124 rotate in unison through the HP shaft 134. The turbofan engine 110 includes a low-pressure (LP) shaft 136, also referred to as a low-speed shaft, that drivingly connects the LP turbine 130 to the LP compressor 122. The LP turbine 130 and the LP compressor 122 rotate in unison through the LP shaft 136. The compressor section 121, the combustion section 126, the turbine section 127, and the core exhaust nozzle 132 together define a core air flow path.

In FIG. 1, the fan assembly 114 includes a fan 138 (e.g., a variable pitch fan) having a plurality of fan blades 140 coupled to a fan disk 142 in a spaced apart manner. As depicted in FIG. 1, the fan blades 140 extend outwardly from the fan disk 142 generally along the radial direction R from a fan root 141 to a fan tip 143. Each fan blade 140 is rotatable relative to the fan disk 142 about a pitch axis P by virtue of the fan blades 140 being operatively coupled to a fan actuation system 144 configured to collectively vary the pitch of the fan blades 140 in unison, as detailed further below. The fan actuation system 144 is disposed within a fan hub 148. The fan blades 140, the fan disk 142, and the fan actuation system 144 are rotatable together about the longitudinal centerline axis 112 via a fan shaft 145 that is powered by the LP shaft 136 across a power gearbox, also referred to as a gearbox assembly 146.

The gearbox assembly 146 is shown schematically in FIG. 1. The gearbox assembly 146 includes a plurality of gears for adjusting the rotational speed of the fan shaft 145 and, thus, the fan 138 relative to the LP shaft 136. The gearbox assembly 146 has a gear ratio in a range from 3.5:1 to 5:1 for a ducted engine (e.g., the turbofan engine 110). The LP shaft 136, the gearbox assembly 146, and the fan shaft 145 are disposed in an in-line configuration such that the LP shaft 136, the gearbox assembly 146, and the fan shaft 145 are coaxial and are each disposed about the longitudinal centerline axis 112. The in-line configuration helps to reduce the space needed within the turbofan engine 110 for the gearbox assembly 146 and allows a greater amount of torque to be transferred from the LP shaft 136 to the fan shaft 145 through the gearbox assembly 146 as compared to turboprop engines in which the gearbox assembly is typically disposed in a stepped configuration and is not coaxial with the LP shaft and the fan shaft.

The fan disk 142 is covered by a fan hub 148 that rotates and is aerodynamically contoured to promote an airflow through the plurality of fan blades 140. In addition, the fan assembly 114 includes an annular fan casing or a nacelle 150 that circumferentially surrounds the fan 138 and at least a portion of the core cowl 118. In this way, the turbofan engine 110 is a ducted engine. The nacelle 150 is supported relative to the core cowl 118 by a plurality of fan guide vanes 152, also referred to as outlet guide vanes, which is spaced circumferentially about the nacelle 150. Moreover, a downstream section 154 of the nacelle 150 extends over an outer portion of the core cowl 118 to define a bypass airflow passage 156 therebetween.

During operation of the turbofan engine 110, a volume of air 158 enters the turbofan engine 110 through an inlet 160 of the nacelle 150 or the fan assembly 114. As the volume of air 158 passes across the fan blades 140, a first portion of air, referred to as bypass air 162, is directed or routed into the bypass airflow passage 156, and a second portion of air, referred to as core air 164, is directed or is routed into the upstream section of the core air flow path, or, more specifically, into the core inlet 120 of the LP compressor 122. The ratio between the bypass air 162 and the core air 164 is commonly known as a bypass ratio. The pressure of the core air 164 is then increased by the LP compressor 122 to form compressed air 165, and the compressed air 165 is routed through the HP compressor 124 and into the combustion section 126, where the compressed air 165 is mixed with fuel and burned to generate combustion gases 166.

The combustion gases 166 are routed into the HP turbine 128 and expanded through the HP turbine 128 where a portion of thermal energy and kinetic energy from the combustion gases 166 is extracted via one or more stages of HP turbine stator vanes 168 that are coupled to the core cowl 118 and HP turbine rotor blades 170 that are coupled to the HP shaft 134. This causes the HP shaft 134 to rotate, thereby supporting operation of the HP compressor 124 (e.g., a self-sustaining cycle). In this way, the combustion gases 166 do work in the HP turbine 128 to cause the HP turbine rotor blades 170 (and the HP shaft 134) to rotate at a sufficient rate to maintain the compression ratio of the HP compressor 124 (e.g., self-sustaining cycle). The combustion gases 166 are then routed into the LP turbine 130 and expanded through the LP turbine 130. Here, a second portion of the thermal energy and the kinetic energy is extracted from the combustion gases 166 via one or more stages of LP turbine stator vanes 172 that are coupled to the core cowl 118 and LP turbine blades 174 that are coupled to the LP shaft 136. This causes the LP shaft 136 to rotate, thereby supporting operation of the LP compressor 122 and rotation of the fan 138 via the gearbox assembly 146 (e.g., a self-sustaining cycle). In this way, the combustion gases 166 do work in the LP turbine 130 to cause the LP turbine blades 174 (and the LP shaft 136) to rotate.

The combustion gases 166 are subsequently routed through the core exhaust nozzle 132 to provide propulsive thrust at a thrust level of the turbofan engine 110. The thrust level of the turbofan engine 110 includes a cruise thrust level defined by a cruise Mach number M_{cruise} that is the Mach number of the turbofan engine 110 at cruise conditions, or mid-level power conditions. Simultaneously, the bypass air 162 is directed through the bypass airflow passage 156 before being exhausted from a fan exhaust nozzle 176 of the turbofan engine 110, also providing propulsive thrust. The HP turbine 128, the LP turbine 130, and the core exhaust nozzle 132 at least partially define a hot gas path 178 for routing the combustion gases 166 through the turbofan engine 110.

The turbofan engine 110 depicted in FIG. 1 is by way of example only. In other exemplary embodiments, the turbofan engine 110 may have other suitable configurations. In other exemplary embodiments, any other suitable number or configuration of compressors, turbines, shafts, or a combination thereof may be provided. The turbofan engine 110 may also be a direct drive engine, which does not have a power gearbox. The fan speed is the same as the LP shaft speed for a direct drive engine. In still other exemplary embodiments, aspects of the present disclosure may be incorporated into other suitable turbofan engines, such as, for example, propfan (e.g., unducted fan) engines.

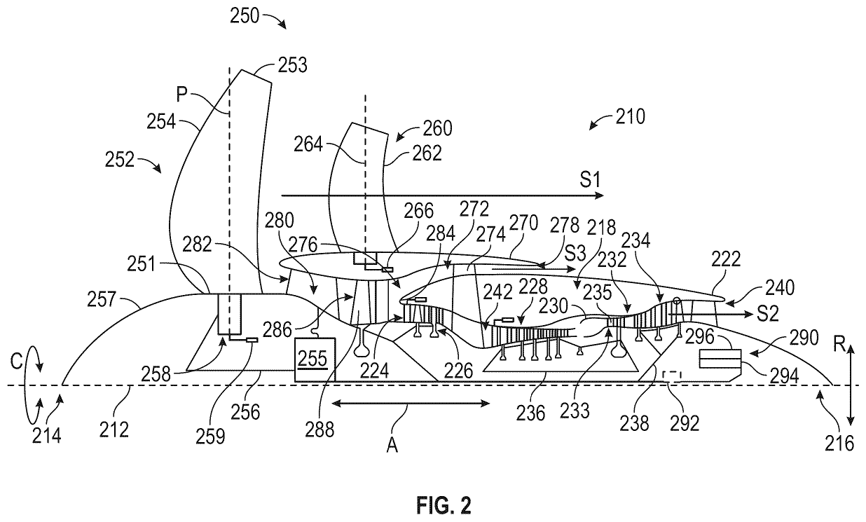

FIG. 2 shows a schematic view of an unducted, three-stream, turbofan engine 210 for an aircraft, which may incorporate one or more aspects of the present disclosure. In this way, the turbofan engine 210 is an unducted fan engine or an open fan engine. The turbofan engine 210 is a “three-stream engine” in that its architecture provides three distinct streams (labeled S1, S2, and S3) of thrust-producing airflow during operation, as detailed further below.

As shown in FIG. 2, the turbofan engine 210 defines an axial direction A, a radial direction R, and a circumferential direction C. Moreover, the turbofan engine 210 defines a longitudinal centerline axis 212 that extends along the axial direction A. In general, the axial direction A extends parallel to the longitudinal centerline axis 212, the radial direction R extends outward from, and inward to, the longitudinal centerline axis 212 in a direction orthogonal to the axial direction A, and the circumferential direction C extends three hundred sixty degrees (360°) around the longitudinal centerline axis 212. The turbofan engine 210 extends between a forward end 214 and an aft end 216, e.g., along the axial direction A.

The turbofan engine 210 includes a fan assembly 250, a compressor section, a combustion section, a turbine section, and an exhaust section. Particularly, as shown in FIG. 2, the turbofan engine 210 includes an engine core 218 and a core cowl 222 that annularly surrounds the compressor section, the combustion section, and the turbine section. The core cowl 222 define a core inlet 224 having an annular shape that is annular about the longitudinal centerline axis 212. The core cowl 222 further encloses and supports a low-pressure (LP) compressor 226 (also referred to as a booster) for pressurizing the air that enters the turbofan engine 210 through the core inlet 224. A high-pressure (HP) compressor 228 receives pressurized air from the LP compressor 226 and further increases the pressure of the air. The pressurized air flows downstream to a combustor 230 where fuel is injected into the pressurized air and ignited to raise the temperature and the energy level of the pressurized air, thereby generating combustion gases.

The combustion gases flow from the combustor 230 downstream to a high-pressure (HP) turbine 232. The HP turbine 232 drives the HP compressor 228 through a first shaft, also referred to as a high-pressure (HP) shaft 236 (also referred to as a “high-speed shaft”). In this regard, the HP turbine 232 is drivingly coupled with the HP compressor 228. Together, the HP compressor 228, the combustor 230, and the HP turbine 232 define the engine core 218. The combustion gases then flow to a power turbine or a low-pressure (LP) turbine 234. The LP turbine 234 drives the LP compressor 226 and components of the fan assembly 250 through a second shaft, also referred to as a low-pressure (LP) shaft 238 (also referred to as a “low-speed shaft”). In this regard, the LP turbine 234 is drivingly coupled with the LP compressor 226 and components of the fan assembly 250. The LP shaft 238 is coaxial with the HP shaft 236 in FIG. 2. After driving each of the HP turbine 232 and the LP turbine 234, the combustion gases exit the turbofan engine 210 through a core exhaust nozzle 240. The turbofan engine 210 defines a core flowpath, also referred to as a core duct 242, that extends between the core inlet 224 and the core exhaust nozzle 240. The core duct 242 is an annular duct positioned generally inward of the core cowl 222 along the radial direction R.

The fan assembly 250 includes a fan 252, also referred to as a primary fan. In FIG. 2, the fan 252 is an open rotor fan, also referred to as an unducted fan. However, in other exemplary embodiments, the fan 252 may be ducted, e.g., by a fan casing or a nacelle circumferentially surrounding the fan 252, similar to the aspect of FIG. 1. The fan 252 includes a plurality of fan blades 254 (only one shown in FIG. 2) that extends in the radial direction R from a fan root 251 to a fan tip 253. The plurality of fan blades 254 is rotatable about the longitudinal centerline axis 212 via a fan shaft 256. As shown in FIG. 2, the fan shaft 256 is coupled with the LP shaft 238 via a speed reduction gearbox or a power gearbox, also referred to as a gearbox assembly 255, e.g., in an indirect-drive configuration.

The gearbox assembly 255 is shown schematically in FIG. 2. The gearbox assembly 255 includes a plurality of gears for adjusting the rotational speed of the fan shaft 256 and, thus, the fan 252 relative to the LP shaft 238 to a more efficient rotational fan speed. The gearbox assembly may have a gear ratio of 4:1 to 12:1, or 7:1 to 12:1, or 4:1 to 10:1, or 5:1 to 9:1, or 6:1 to 9:1, and may be configured in an epicyclic star or a planet gear configuration. Preferably, the gearbox assembly has a gear ratio of 4:1 to 10:1 for an unducted fan engine (e.g., the turbofan engine 210). The gearbox may be a single stage gearbox or a compound gearbox (e.g., having a plurality of stages). The LP shaft 238, the gearbox assembly 255, and the fan shaft 256 are disposed in an in-line configuration such that the LP shaft 238, the gearbox assembly 255, and the fan shaft 256 are coaxial and are each disposed about the longitudinal centerline axis 212.

The fan blades 254 can be arranged in equal spacing around the longitudinal centerline axis 212. Each fan blade 254 extends outwardly from a disk (not shown in FIG. 2) generally along the radial direction R. The disk is covered by a fan hub 257 that is rotatable and aerodynamically contoured to promote an airflow through the plurality of fan blades 254. Each fan blade 254 has a root and a tip, and a span defined therebetween. Each of the plurality of fan blades 254 defines a pitch axis P. In FIG. 2, each of the plurality of fan blades 254 of the fan 252 is rotatable about their respective pitch axis P, e.g., in unison with one another. A fan actuation system 258 controls one or more actuators 259 to pitch the fan blades 254 about their respective pitch axis P. The fan actuation system 258 is disposed within the fan hub 257.

The fan assembly 250 further includes a fan guide vane array 260 that includes a plurality of fan guide vanes 262 (only one shown in FIG. 2) disposed around the longitudinal centerline axis 212. In FIG. 2, the plurality of fan guide vanes 262 is not rotatable about the longitudinal centerline axis 212. Each of the plurality of fan guide vanes 262 has a root and a tip, and a span defined therebetween. The plurality of fan guide vanes 262 can be unshrouded as shown in FIG. 2 or can be shrouded, e.g., by an annular shroud spaced outward from the tips of the fan guide vanes 262 along the radial direction R. Each of the plurality of fan guide vanes 262 defines a vane pitch axis 264. In FIG. 2, each of the plurality of fan guide vanes 262 of the fan guide vane array 260 is rotatable about their respective vane pitch axis 264, e.g., in unison with one another. One or more actuators 266 are controlled to pitch the plurality of fan guide vanes 262 about their respective vane pitch axis 264. In other exemplary embodiments, each of the plurality of fan guide vanes 262 is fixed or is unable to be pitched about the vane pitch axis 264. The plurality of fan guide vanes 262 is mounted to a fan cowl 270.

The fan cowl 270 annularly encases at least a portion of the core cowl 222 and is generally positioned outward of the core cowl 222 along the radial direction R. Particularly, a downstream section of the fan cowl 270 extends over a forward portion of the core cowl 222 to define a fan flowpath, also referred to as a fan duct 272. Incoming air enters through the fan duct 272 through a fan duct inlet 276 and exits through a fan exhaust nozzle 278 to produce propulsive thrust. The fan duct 272 is an annular duct positioned generally outward of the core duct 242 along the radial direction R. The fan cowl 270 and the core cowl 222 are connected together and supported by a plurality of struts 274 (only one shown in FIG. 2) that extends substantially radially and are circumferentially spaced about the longitudinal centerline axis 212. The plurality of struts 274 is each aerodynamically contoured to direct air flowing thereby. Other struts, in addition to the plurality of struts 274, can be used to connect and to support the fan cowl 270 and the core cowl 222.

The turbofan engine 210 also defines or includes an inlet duct 280. The inlet duct 280 extends between an engine inlet 282 and the core inlet 224 and the fan duct inlet 276. The engine inlet 282 is defined generally at the forward end of the fan cowl 270 and is positioned between the fan 252 and the fan guide vane array 260 along the axial direction A. The inlet duct 280 is an annular duct that is positioned inward of the fan cowl 270 along the radial direction R. Air flowing downstream along the inlet duct 280 is split, not necessarily evenly, into the core duct 242 and the fan duct 272 by a splitter 284 of the core cowl 222. The inlet duct 280 is wider than the core duct 242 along the radial direction R. The inlet duct 280 is also wider than the fan duct 272 along the radial direction R.

The fan assembly 250 also includes a mid-fan 286. The mid-fan 286 includes a plurality of mid-fan blades 288 (only one shown in FIG. 2). The plurality of mid-fan blades 288 is rotatable, e.g., about the longitudinal centerline axis 212. The mid-fan 286 is drivingly coupled with the LP turbine 234 via the LP shaft 238. The plurality of mid-fan blades 288 can be arranged in equal circumferential spacing about the longitudinal centerline axis 212. The plurality of mid-fan blades 288 is annularly surrounded (e.g., ducted) by the fan cowl 270. In this regard, the mid-fan 286 is positioned inward of the fan cowl 270 along the radial direction R. The mid-fan 286 is positioned within the inlet duct 280 upstream of both the core duct 242 and the fan duct 272. A ratio of a span of a fan blade 254 to that of a mid-fan blade 288 (a span is measured from a root to tip of the respective blade) is greater than 2 and less than 10, to achieve the desired benefits of the third stream (S3), particularly, the additional thrust it offers to the engine, which can enable a smaller diameter fan blade 254 (benefits engine installation).

Accordingly, air flowing through the inlet duct 280 flows across the plurality of mid-fan blades 288 and is accelerated downstream thereof. At least a portion of the air accelerated by the mid-fan blades 288 flows into the fan duct 272 and is ultimately exhausted through the fan exhaust nozzle 278 to produce propulsive thrust. Also, at least a portion of the air accelerated by the plurality of mid-fan blades 288 flows into the core duct 242 and is ultimately exhausted through the core exhaust nozzle 240 to produce propulsive thrust. Generally, the mid-fan 286 is a compression device positioned downstream of the engine inlet 282. The mid-fan 286 is operable to accelerate air into the fan duct 272, also referred to as a secondary bypass passage.

During operation of the turbofan engine 210, an initial airflow or an incoming airflow passes through the fan blades 254 of the fan 252 and splits into a first airflow and a second airflow. The first airflow bypasses the engine inlet 282 and flows generally along the axial direction A outward of the fan cowl 270 along the radial direction R. The first airflow accelerated by the fan blades 254 passes through the fan guide vanes 262 and continues downstream thereafter to produce a primary propulsion stream or a first thrust stream S1. A majority of the net thrust produced by the turbofan engine 210 is produced by the first thrust stream S1. The second airflow enters the inlet duct 280 through the engine inlet 282.

The second airflow flowing downstream through the inlet duct 280 flows through the plurality of mid-fan blades 288 of the mid-fan 286 and is consequently compressed. The second airflow flowing downstream of the mid-fan blades 288 is split by the splitter 284 located at the forward end of the core cowl 222. Particularly, a portion of the second airflow flowing downstream of the mid-fan 286 flows into the core duct 242 through the core inlet 224. The portion of the second airflow that flows into the core duct 242 is progressively compressed by the LP compressor 226 and the HP compressor 228, and is ultimately discharged into the combustion section. The discharged pressurized air stream flows downstream to the combustor 230 where fuel is introduced to generate combustion gases or products.

The combustor 230 defines an annular combustion chamber that is generally coaxial with the longitudinal centerline axis 212. The combustor 230 receives pressurized air from the HP compressor 228 via a pressure compressor discharge outlet. A portion of the pressurized air flows into a mixer. Fuel is injected by a fuel nozzle (omitted for clarity) to mix with the pressurized air thereby forming a fuel-air mixture that is provided to the combustion chamber for combustion. Ignition of the fuel-air mixture is accomplished by one or more igniters (omitted for clarity), and the resulting combustion gases flow along the axial direction A toward, and into, a first stage turbine nozzle 233 of the HP turbine 232. The first stage turbine nozzle 233 is defined by an annular flow channel that includes a plurality of radially extending, circumferentially spaced nozzle vanes 235 that turn the combustion gases so that the combustion gases flow angularly and impinge upon first stage turbine blades of the HP turbine 232. The combustion gases exit the HP turbine 232 and flow through the LP turbine 234, and exit the core duct 242 through the core exhaust nozzle 240 to produce a core air stream, also referred to as a second thrust stream S2. As noted above, the HP turbine 232 drives the HP compressor 228 via the HP shaft 236, and the LP turbine 234 drives the LP compressor 226, the fan 252, and the mid-fan 286 via the LP shaft 238.

The other portion of the second airflow flowing downstream of the mid-fan 286 is split by the splitter 284 into the fan duct 272. The air enters the fan duct 272 through the fan duct inlet 276. The air flows generally along the axial direction A through the fan duct 272 and is ultimately exhausted from the fan duct 272 through the fan exhaust nozzle 278 to produce a third stream, also referred to as a third thrust stream S3.

The third thrust stream S3 is a secondary air stream that increases fluid energy to produce a minority of total propulsion system thrust. In some example embodiments, a pressure ratio of the third stream is higher than that of the primary propulsion stream (e.g., a bypass or a propeller driven propulsion stream). The thrust may be produced through a dedicated nozzle or through mixing of the secondary air stream with the primary propulsion stream or a core air stream, e.g., into a common nozzle. In certain aspects, an operating temperature of the secondary air stream is less than a maximum compressor discharge temperature for the engine. Furthermore, aspects of the third stream (e.g., airstream properties, mixing properties, or exhaust properties), and thereby a percent contribution to total thrust, are passively adjusted during engine operation or can be modified purposefully through the use of engine control features (such as fuel flow, electric machine power, variable stators, variable inlet guide vanes, valves, variable exhaust geometry, or fluidic features) to adjust or to improve overall system performance across a broad range of potential operating conditions.

The turbofan engine 210 depicted in FIG. 2 is by way of example only. In other exemplary embodiments, the turbofan engine 210 may have other suitable configurations. For example, the fan 252 can be ducted by a fan casing or a nacelle such that a bypass passage is defined between the fan casing and the fan cowl 270. Moreover, in other exemplary embodiments, any other suitable number or configuration of compressors, turbines, shafts, or a combination thereof may be provided. Further, aspects of the present disclosure may be incorporated into any other suitable turbofan engine, such as, for example, turbofan engines defining two streams (e.g., a bypass stream and a core air stream).

Further, in FIG. 2, the turbofan engine 210 includes an electric machine 290 (e.g., a motor-generator) operably coupled with a rotating component thereof. In this regard, the turbofan engine 210 is a hybrid-electric propulsion machine. Particularly, as shown in FIG. 2, the electric machine 290 is operatively coupled with the LP shaft 238. The electric machine 290 can be mechanically connected to the LP shaft 238, either directly, or indirectly, e.g., by way of a gearbox assembly 292 (shown schematically in FIG. 2). Further, although the electric machine 290 is operatively coupled with the LP shaft 238 at an aft end of the LP shaft 238, the electric machine 290 can be coupled with the LP shaft 238 at any suitable location or can be coupled to other rotating components of the turbofan engine 210, such as the HP shaft 236 or the LP shaft 238. For instance, in some example embodiments, the electric machine 290 can be coupled with the LP shaft 238 and positioned forward of the mid-fan 286 along the axial direction A. In some example embodiments, the turbofan engine of FIG. 1 also includes an electric machine coupled to the LP shaft and located in the tail cone of the engine.

In some example embodiments, the electric machine 290 can be an electric motor operable to drive or to motor the LP shaft 238. In other exemplary embodiments, the electric machine 290 can be an electric generator operable to convert mechanical energy into electrical energy. In this way, electrical power generated by the electric machine 290 can be directed to various engine systems or aircraft systems. In some example embodiments, the electric machine 290 can be a motor/generator with dual functionality. The electric machine 290 includes a rotor 294 and a stator 296. The rotor 294 is coupled to the LP shaft 238 and rotates with rotation of the LP shaft 238. In this way, the rotor 294 rotates with respect to the stator 296, thereby generating electrical power. Although the electric machine 290 has been described and illustrated in FIG. 2 as having a particular configuration, the present disclosure may apply to electric machines having alternative configurations. For instance, the rotor 294 or the stator 296 may have different configurations or may be arranged in a different manner than illustrated in FIG. 2.

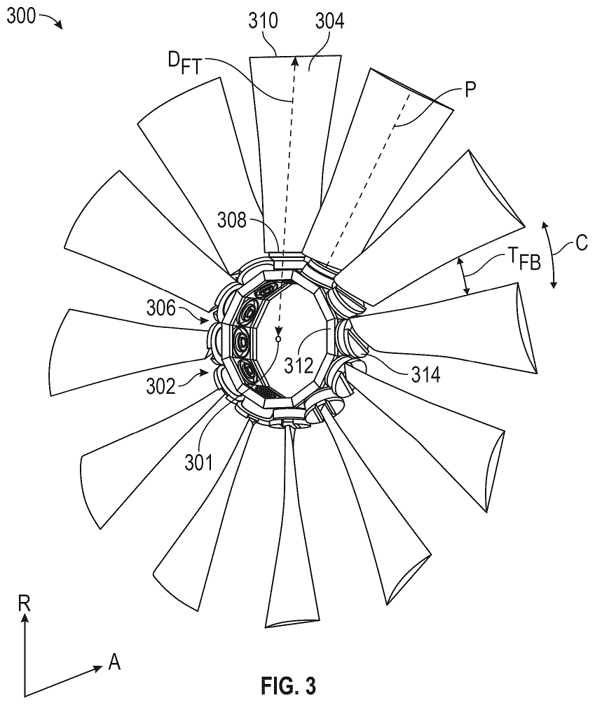

FIG. 3 shows a fan 300 having a fan actuation system 302, according to the present disclosure. The fan 300 can be utilized as the fan 138 of FIG. 1 or as the fan 252 of FIG. 2. The fan 300 includes a plurality of fan blades 304 that is coupled to a disk 306 and is spaced circumferentially about a longitudinal centerline axis 301 of the fan 300. The fan 300 includes a number of fan blades, and, in particular, includes ten to eighteen fan blades 304. In FIG. 3, the fan 300 includes twelve fan blades 304. Each fan blade 304 extends in the radial direction R along a span of the fan blade 304 and from a fan root 308 to a fan tip 310. Each fan blade 304 has a fan tip diameter D_{FT} that extends from the longitudinal centerline axis 301 to the fan tip 310 of each fan blade 304. While the fan tip diameter D_{FT} is detailed with respect to the plurality of fan blades 304, the fan tip diameter D_{FT} is a measurement of any of the fan blades detailed herein. The fan tip diameter D_{FT} is in a range from seven feet to fourteen feet (7 ft. to 14 ft.), as detailed further below. A tangential fan blade distance T_{FB} is defined in the circumferential direction C as a circumferential distance or a tangential distance between adjacent fan blades 304. As used herein, adjacent means two fan blades with no intervening fan blade therebetween.

The disk 306 includes a plurality of disk segments 312 that is rigidly coupled together or integrally molded together in a generally annular shape. One fan blade 304 is coupled to each disk segment 312 at a trunnion mechanism 314 of the fan actuation system 302. The trunnion mechanism 314 facilitates retaining the respective fan blade 304 on the disk 306 during rotation of the disk 306, while still rendering the respective fan blade 304 rotatable relative to the disk 306 about a pitch axis P of the fan blade 304. For example, the trunnion mechanism 314 provides a load path to the disk 306 for the centrifugal load generated by the fan blade 304 during rotation of the fan blade 304 about the longitudinal centerline axis 301. The trunnion mechanism 314 includes a plurality of bearings disposed within the disk segment 312 that allows the fan blade 304 to rotate about the pitch axis P.

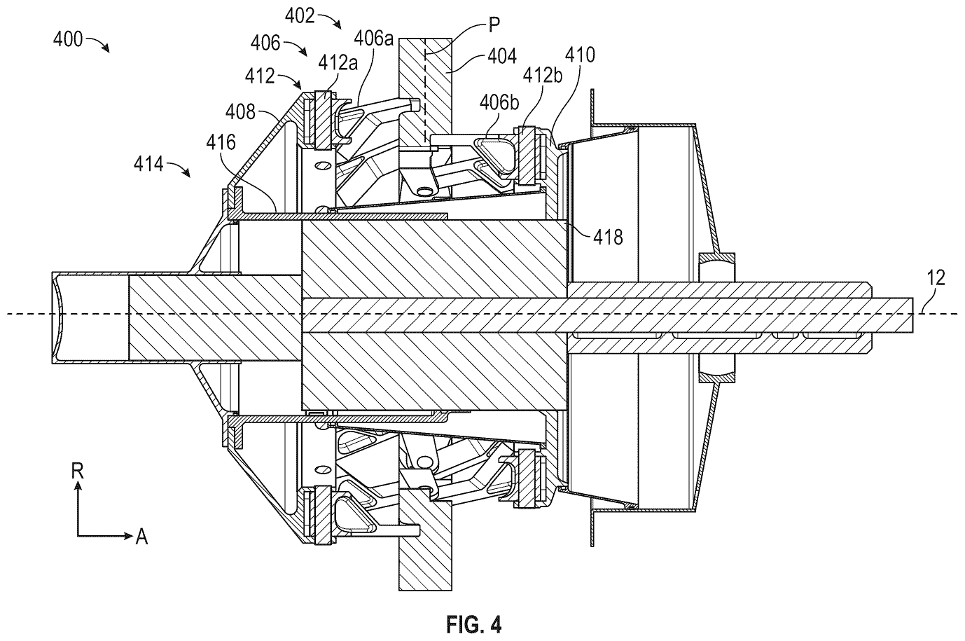

FIG. 4 is a schematic cross-sectional diagram of a fan actuation system 400 for a turbofan engine, taken along a longitudinal centerline axis 112 of the turbofan engine, according to the present disclosure. The fan actuation system 400 can be utilized for any of the fans detailed herein. The fan actuation system 400 includes a trunnion mechanism 402 and one or more actuators 414. The trunnion mechanism 402 includes a plurality of trunnions 404. Each fan blade of the fan is coupled to a respective trunnion 404. Each of the plurality of trunnions 404 is rotatable about a pitch axis P to pitch the fan blades of the fan. The trunnion mechanism 402 includes a plurality of trunnion links 406 that is coupled to the plurality of trunnions 404. For example, a respective trunnion link 406 is coupled to a respective trunnion 404. The plurality of trunnion links 406 includes a plurality of forward trunnion links 406a and a plurality of aft trunnion links 406b that are coupled to the plurality of trunnions 404. The plurality of forward trunnion links 406a is pivotably coupled to the plurality of trunnions 404.

The trunnion mechanism 402 includes a plurality of unison rings 408, 410 including a forward unison ring 408 positioned forward of the plurality of trunnions 404 and an aft unison ring 410 positioned aft of the plurality of trunnions 404. The forward unison ring 408 and the aft unison ring 410 couple the plurality of trunnions 404 together. The plurality of trunnion links 406 is coupled to the forward unison ring 408 or the aft unison ring 410 via a plurality of pins 412. The plurality of forward trunnion links 406a is pivotably coupled to the forward unison ring 408 by a plurality of forward pins 412a such that the plurality of trunnions 404 is coupled to the forward unison ring 408. For example, each forward trunnion link 406a extends forward from a respective trunnion 404 to the forward unison ring 408 and a respective forward pin 412a is disposed through the forward trunnion link 406a at the forward unison ring 408 to pivotably couple the forward trunnion link 406a to the forward unison ring 408. Each aft trunnion link 406b extends aftward from the respective trunnion 404 to the aft unison ring 410 and a respective aft pin 412b is disposed through the aft trunnion link 406b at the aft unison ring 410 to pivotably couple the aft trunnion link 406b to the aft unison ring 410. In this way, each of the plurality of trunnions 404 is pivotably coupled to the forward unison ring 408 and to the aft unison ring 410 such that the plurality of trunnions 404 can pivot about the pitch axis P in unison.

The one or more actuators 414 include a hydraulic cylinder 416 and a piston 418 disposed within the hydraulic cylinder 416. The hydraulic cylinder 416 and the piston 418 are movable along the axial direction A. In this way, the one or more actuators 414 are hydraulic linear actuators such that the hydraulic cylinder 416 and the piston 418 move linearly along the axial direction A (e.g., in opposite directions along the longitudinal centerline axis 112). The forward unison ring 408 is coupled to the hydraulic cylinder 416 such that the forward unison ring 408 moves when the hydraulic cylinder 416 moves. The aft unison ring 410 is coupled to the piston 418 such that aft unison ring 410 moves when the piston 418 moves.

In operation, the fan actuation system 400 moves the plurality of fan blades 140 (FIG. 1) between a first end position and a second end position. The first end position, referred to herein as a feather position, corresponds to a position in which the plurality of fan blades 140 produces the least (e.g., minimal) amount of resistance or drag. In some examples, this position corresponds to a position in which the plurality of fan blades 140 is aligned or substantially aligned (e.g., ±5°) with the flow of the volume of air (e.g., the volume of air 158 of FIG. 1). The second end position is a reverse position in which the plurality of fan blades 140 exceeds, for example, a plane that is transverse to the longitudinal centerline axis 112 (the direction of forward movement of the aircraft) by a certain degree (e.g., 30°) so as to assist with the braking of the aircraft. Therefore, in some examples, the angular stroke of the plurality of fan blades 140 between the feather position and the reverse position is, for example, approximately 120°. The plurality of fan blades 140 can be moved to any position or any angle between the feather position and the reverse position depending on the phase of flight to improve (e.g., optimize) efficiency of the turbofan engine 110 (FIG. 1). In some examples, one or more stops or limits are provided to prevent the plurality of fan blades 140 from being rotated beyond the two end positions. In other examples, the fan actuation system 400 can be configured to provide a greater stroke or a lesser stroke and/or the end positions may be different.

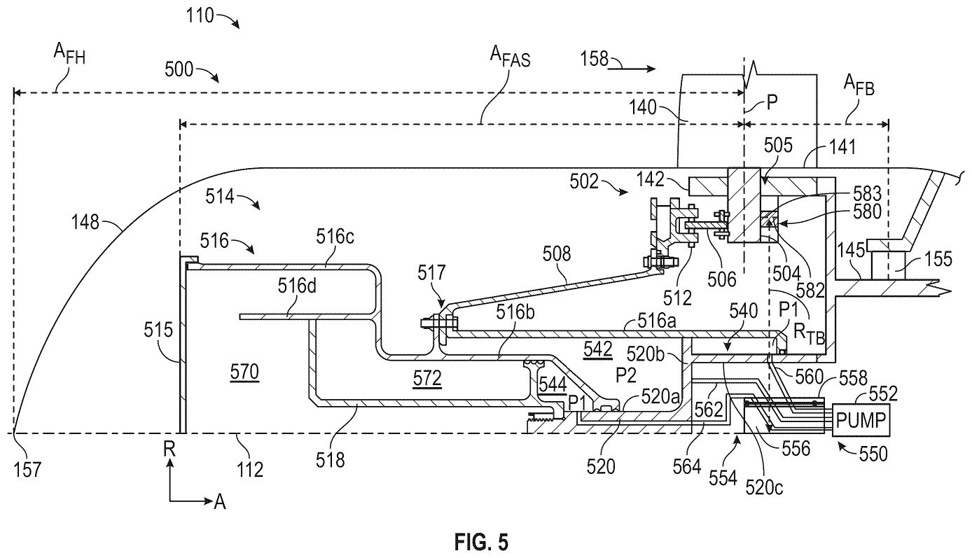

A hydraulic system supplies a hydraulic fluid (e.g., oil) to one or more hydraulic chambers of the one or more actuators 414 to move the hydraulic cylinder 416 and the piston 418 to pitch the plurality of fan blades 140. An exemplary hydraulic system and hydraulic chambers are detailed below with respect to FIG. 5. The plurality of trunnions 404 is disposed in FIG. 4 such that the plurality of fan blades 140 is in the first end position (e.g., the feather position). The pressure of the hydraulic fluid in the one or more hydraulic chambers can be increased to move the hydraulic cylinder 416 in a first direction and to move the piston 418 in a second direction such that the plurality of trunnions 404 move the plurality of fan blades 140 from the feather position towards the reverse position (e.g., the second end position). For example, the hydraulic cylinder 416 can move axially aftward (e.g., to the right in FIG. 4) and the piston 418 can move axially forward (e.g., to the left in FIG. 4) when the pressure of the hydraulic fluid is increased. To move the plurality of fan blades 140 from the reverse position to the feather position, the pressure of the hydraulic fluid in the one or more hydraulic chambers can be decreased to move the hydraulic cylinder 416 in the second direction (e.g., axially forward) and to move the piston 418 in the first direction (e.g., axially aftward).

As the hydraulic cylinder 416 moves axially along the axial direction A, the hydraulic cylinder 416 causes the forward unison ring 408 to move, thereby causing the plurality of forward trunnion links 406a to pivot and to pitch the plurality of trunnions 404, and, therefore, pitching the plurality of fan blades 140 about the pitch axis P. At the same time, movement of the piston 418 along the axial direction A causes the aft unison ring 410 to move, thereby, causing the plurality of aft trunnion links 406b to pivot in an opposite direction as the forward trunnion links 406a, and, therefore, pitching the plurality of fan blades 140 about the pitch axis P. In this way, the fan actuation system 400 translates linear motion of the one or more actuators 414 (e.g., along the axial direction A) into rotational motion of the plurality of fan blades 140. Such a configuration enables a compact and lightweight design of the fan actuation system 400. Further, each of the hydraulic cylinder 416 and the piston 418 provides only half of the force needed to actuate the plurality of trunnions 404 and provides a redundant path in the event that one of the hydraulic cylinder 416 or the piston 418 fails.

FIG. 5 is a schematic cross-sectional view of a fan actuation system 500 for a turbofan engine, according to another aspect. The fan actuation system 500 is shown as being utilized in the turbofan engine 110, but can be utilized in the turbofan engine 210. Only the top half of the fan actuation system 500 is shown in FIG. 5. However, the fan actuation system 500 is symmetrical about the longitudinal centerline axis 112. The fan actuation system 500 may also be referred to as a fan pitch actuation system (FPAS). The fan actuation system 500 controls the pitch (e.g., angle, orientation) of the plurality of fan blades 140 about the pitch axis P. In some examples, the fan actuation system 500 can move the fan blades 140 between a first end position and a second end position.

FIG. 5 shows the fan shaft 145 of the turbofan engine 110 (FIG. 1). The fan shaft 145 is coupled to, and driven by, the LP shaft 136 (FIG. 1). One or more fan bearings 155 support rotation of the fan shaft 145. The one or more fan bearings 155 can include roller bearings, tapered roller bearings, ball bearings, or the like. The one or more fan bearings 155 are disposed aft of the fan disk 142. As shown in FIG. 5, the fan disk 142 is coupled to (e.g., directly or indirectly), and driven by, the fan shaft 145. Each of the plurality of fan blades 140 is coupled to, and extends radially outward from, the fan disk 142. Therefore, as the fan shaft 145 is rotated (via the LP shaft 136), the fan shaft 145 rotates the fan disk 142, which rotates the plurality of fan blades 140 to generate thrust. The fan hub 148 (shown schematically in FIG. 5) includes a fan hub tip 157 that defines an axially forward-most point of the fan hub 148.

The fan actuation system 500 includes a trunnion mechanism 502 including a plurality of trunnions 504. Each fan blade 140 is coupled to a respective one of the plurality of trunnions 504. The plurality of trunnions 504 extends through an opening 505 in the fan disk 142. The plurality of trunnions 504 is rotatable in the opening 505. This enables the plurality of fan blades 140 to rotate about the pitch axis P. As such, the pitch of the plurality of fan blades 140 can be changed relative to the flow of the volume of air 158. In particular, the plurality of fan blades 140 can be rotated (e.g., pitched) to any position between the first end position (e.g., the feather position) and the second end position (e.g., the reverse position). In FIG. 5, the plurality of fan blades 140 is shown in the feather position. In the feather position, the plurality of fan blades 140 is substantially aligned with the flow of the volume of air 158, which reduces resistance or drag. The plurality of fan blades 140 is typically held in the feather position when the turbofan engine 110 (FIG. 1) is not operating.

The fan actuation system 500 includes a plurality of trunnion links 506 and a unison ring 508. The plurality of trunnion links 506 is pivotably coupled to the plurality of trunnions 504. For example, each trunnion link 506 is coupled to a respective trunnion 504 and to the unison ring 508. In this way, the unison ring 508 couples the plurality of trunnions 504 together. The plurality of trunnion links 506 is coupled to the unison ring 508 via a plurality of pins 512. In this way, the plurality of trunnions 504 is pivotably coupled to the unison ring 508 such that the plurality of trunnions 504, and, thus, the plurality of fan blades 140, can pivot about the pitch axis P in unison, as detailed further below.

The fan actuation system 500 includes one or more actuators 514 that include a hydraulic cylinder 516, a piston 518, and a piston retainer 520. The piston retainer 520 is coupled (e.g., bolted) to the fan shaft 145 such that the piston retainer 520 rotates with the fan shaft 145. Therefore, the piston retainer 520 is coupled (e.g., indirectly) to, and rotated by, the LP shaft 136 (FIG. 1). Also, the piston 518 is coupled to, and extends in a forward direction, from the piston retainer 520. Therefore, the piston 518 also rotates with the piston retainer 520 and the fan shaft 145. The hydraulic cylinder 516 also rotate with the piston retainer 520 and the piston 518, but is axially slidable relative to the piston retainer 520 and the piston 518, as disclosed in further detail herein. In some examples, the hydraulic cylinder 516 is disposed within the fan hub 148 (FIG. 1) of the turbofan engine 110 (FIG. 1).

In the illustrated example of FIG. 5, the piston retainer 520 has a first portion 520a (e.g., a post), a second portion 520b (e.g., a flange) that extends radially outward from the first portion 520a, and a third portion 520c (e.g., a shaft) that extends axially from the second portion 520b. The third portion 520c is coupled (e.g., bolted) to the fan shaft 145. The piston retainer 520 can be constructed as multiple parts coupled (e.g., welded) together or as a single unitary part or component (e.g., a monolithic structure). The piston 518 is coupled to, and extends forward from, the first portion 520a of the piston retainer 520.

The hydraulic cylinder 516 is disposed radially outward of (e.g., around, surrounding) the piston retainer 520 and the piston 518. The hydraulic cylinder 516 is keyed to the piston retainer 520. As such, the piston retainer 520 rotates the hydraulic cylinder 516. However, the hydraulic cylinder 516 is slidable along the piston retainer 520 in the axial direction A (left and right in FIG. 5). This movement is used to change the pitch of the plurality of fan blades 140. The hydraulic cylinder 516 is coupled to the unison ring 508 at a joint 517 such that the hydraulic cylinder 516 is coupled to the plurality of fan blades 140 via the trunnion mechanism 502. The fan actuation system 500 can be activated to move the hydraulic cylinder 516 axially (left or right in FIG. 5), which causes the plurality of trunnion links 506 to rotate the plurality of trunnions 504, which rotates the plurality of fan blades 140 about the pitch axis P. As such, movement of the hydraulic cylinder 516 causes all of the fan blades 140 to rotate (e.g., pitch) simultaneously. When the hydraulic cylinder 516 is moved in a first axial direction (the forward direction, or to the left in FIG. 5), the plurality of fan blades 140 is rotated to the feather position, and when the hydraulic cylinder 516 is moved in a second axial direction (the rearward direction, or to the right in FIG. 5), the plurality of fan blades 140 is rotated away from the feather position and toward the reverse position. However, in other examples, the fan actuation system 500 can be configured so that the movement of the hydraulic cylinder 516 is reversed.

The hydraulic cylinder 516 has a first portion 516a, a second portion 516b, a third portion 516c, and a fourth portion 516d. The first portion 516a extends generally in the axial direction A and is coupled to the unison ring 508 at the joint 517 (e.g., a bolted joint). The second portion 516b is disposed radially inward of the first portion 516a and is coupled to the first portion 516a and to the unison ring 508 at the joint 517. The third portion 516c extends forward from the joint 517 (e.g., from the first portion 516a, the second portion 516b, and the unison ring 508) and forms a pressurized pneumatic chamber 570, disclosed in further detail herein. The fourth portion 516d is coupled to, and extends axially within, the third portion 516c. The first portion 516a, the second portion 516b, the third portion 516c, and the fourth portion 516d form the hydraulic cylinder 516. In some examples, the first portion 516a, the second portion 516b, the third portion 516c, and the fourth portion 516d are separate parts or components that are coupled (e.g., welded, bolted) together. In other examples, one or more of the first portion 516a, the second portion 516b, the third portion 516c, and the fourth portion 516d can be constructed as a single unitary part or component (e.g., a monolithic structure). In some example embodiments, the hydraulic cylinder 516 and the unison ring 508 form a single unitary part or component.

The first portion 516a of the hydraulic cylinder 516 is sealingly engaged with (e.g., engaged with a seal to prevent fluid leakage) the third portion 520c of the piston retainer 520. The second portion 520b of the piston retainer 520 is sealingly engaged with the first portion 516a of the hydraulic cylinder 516. The second portion 516b of the hydraulic cylinder 516 is sealingly engaged with the first portion 520a of the piston retainer 520. The piston 518 is sealingly engaged with the second portion 516b and with the fourth portion 516d of the hydraulic cylinder 516.

The fan actuation system 500 includes one or more hydraulic chambers defined between the hydraulic cylinder 516, the piston 518, and the piston retainer 520. These hydraulic chamber(s) are used to control the position of the hydraulic cylinder 516, and, thus, to control the pitch of the plurality of fan blades 140. As shown in FIG. 5, the fan actuation system 500 includes a first hydraulic chamber 540, a second hydraulic chamber 542, and a third hydraulic chamber 544. The first hydraulic chamber 540 is formed or is defined between the first portion 516a of the hydraulic cylinder 516, the second portion 520b of the piston retainer 520, and the third portion 520c of the piston retainer 520. The second hydraulic chamber 542 is formed or is defined between the first portion 516a of the hydraulic cylinder 516, the second portion 516b of the hydraulic cylinder 516, the first portion 520a of the piston retainer 520, and the second portion 520b of the piston retainer 520. The third hydraulic chamber 544 is formed or is defined between second portion 516b of the hydraulic cylinder 516, an aft end of the piston 518, and the first portion 520a of the piston retainer 520. In this example, the first hydraulic chamber 540 and third hydraulic chamber 544 are provided with hydraulic fluid at a first pressure, referred to herein as P1, and the second hydraulic chamber 542 is provided with hydraulic fluid at a second pressure, referred to herein as P2. The first pressure P1 and the second pressure P2 can be any amount depending on the specific design. In some examples, the first pressure P1 and the second pressure P2 can be as high as one thousand pounds per square inch (1000 psi) or even higher. The first pressure P1 and the second pressure P2 can be increased or can be decreased to cause the hydraulic cylinder 516 to move axially forward or axially rearward, thus changing the pitch of the plurality of fan blades 140. For example, if the force acting on the hydraulic cylinder 516 from the first pressure P1 in the first hydraulic chamber 540 and the third hydraulic chamber 544 is greater than the force acting on the hydraulic cylinder 516 from the second pressure P2 in the second hydraulic chamber 542, the hydraulic cylinder 516 moves (e.g., slides) rearward (axially aftward, or to the right in FIG. 5) along the piston 518 and the piston retainer 520. Conversely, if the force acting on the hydraulic cylinder 516 from the first pressure P1 in the first hydraulic chamber 540 and the third hydraulic chamber 544 is less than the force acting on the hydraulic cylinder 516 from the second pressure P2 in the second hydraulic chamber 542, the hydraulic cylinder 516 moves (e.g., slides) axially forward (to the left in FIG. 5) along the piston 518 and the piston retainer 520. Therefore, the first hydraulic chamber 540 and the third hydraulic chamber 544 receive hydraulic fluid to move the hydraulic cylinder 516 in the rearward direction (e.g., aftward direction) while the second hydraulic chamber 542 receives hydraulic fluid to move the hydraulic cylinder 516 in the forward direction.

The fan actuation system 500 includes a hydraulic system 550 to provide hydraulic fluid, such as oil, to one or more of the hydraulic chambers 540, 542, 544 to control the movement of the hydraulic cylinder 516. The hydraulic system 550 includes a pump 552 to control the first pressure P1 and the second pressure P2. The pump 552 is activated to move the hydraulic fluid into, or out of, the hydraulic chambers 540, 542, 544 to increase or to decrease the first pressure P1 and the second pressure P2, and, therefore, to cause the hydraulic cylinder 516 to move forward or to move rearward. In the illustrated example, the hydraulic system 550 includes an oil transfer bearing 554. The oil transfer bearing 554 includes a fixed portion 556 (e.g., a shaft) with fluid passageways fluidly coupled to the pump 552. The fixed portion 556 is a static component and does not rotate or move axially. The oil transfer bearing 554 includes a sleeve 558 that is rotatable about the fixed portion 556. The hydraulic system 550 includes a first fluid line 560, a second fluid line 562, and a third fluid line 564 fluidly coupled between the oil transfer bearing 554 and the respective hydraulic chambers 540, 542, and 544. The first fluid line 560 is in fluid communication with the first hydraulic chamber 540, the second fluid line 562 is in fluid communication with the second hydraulic chamber 542, and the third fluid line 564 is in fluid communication with the third hydraulic chamber 544. The first fluid line 560, the second fluid line 562, and the third fluid line 564 are coupled to the sleeve 558. The sleeve 558 enables fluid communication among the first fluid line 560, the second fluid line 562, and the third fluid line 564, which are rotating with the fan actuation system 500, and the fixed portion 556 of the oil transfer bearing 554. Thus, the oil transfer bearing 554 enables the hydraulic fluid to be transferred between a stationary component and a rotating component. As disclosed above, the first hydraulic chamber 540 and the third hydraulic chamber 544 are provided with the hydraulic fluid at the same first pressure P1. The oil transfer bearing 554 fluidly couples the hydraulic fluid in the first fluid line 560 and the third fluid lines 564 such that the first hydraulic chamber 540 and the third hydraulic chamber 544 remain at the same first pressure P1.

To move the plurality of fan blades 140 away from the feather position and toward the reverse position, the pump 552 is activated to increase the first pressure P1 in the first hydraulic chamber 540 and the third hydraulic chamber 544 and to reduce the second pressure P2 in the second hydraulic chamber 542. As a result, the hydraulic cylinder 516 moves in the rearward direction (to the right in FIG. 5). The hydraulic cylinder 516 pushes the plurality of trunnion links 506 rearward (to the right in FIG. 5), which causes the plurality of fan blades 140 to rotate away from the feather position and toward the reverse position. In this way, the plurality of fan blades 140 can be moved between the feather position and the reverse position. When the desired position is reached, the pump 552 is deactivated or can otherwise balance the loads on the hydraulic cylinder 516 to maintain the current position. The pump 552 can further increase the first pressure P1 or decrease the second pressure P2 to further move the plurality of fan blades 140 toward the reverse position. Otherwise, to move the plurality of fan blades 140 back to the feather position, the pump 552 is activated to reduce the first pressure P1 in the first hydraulic chamber 540 and the third hydraulic chamber 544 or to increase the second pressure P2 in the second hydraulic chamber 542. Thus, the hydraulic system 550 is used to control the position of the hydraulic cylinder 516 for controlling the pitch of the plurality of fan blades 140 along the pitch axis P. The first pressure P1 being the same in the first hydraulic chamber 540 and the third hydraulic chambers 544 reduces the overall first pressure P1 required to control the hydraulic cylinder 516. In other examples, however, the first hydraulic chamber 540 and the third hydraulic chamber 544 can be pressurized at different pressures.

The pressurized pneumatic chamber 570 is formed or is defined by the third portion 516c of the hydraulic cylinder 516 and the piston 518. The pressurized pneumatic chamber 570 is filled with a pressurized gas. In some examples, the pressurized pneumatic chamber 570 contains pressurized nitrogen. In other examples, the pressurized pneumatic chamber 570 can be filled with another pressurized gas (e.g., air). The pressurized pneumatic chamber 570 is sealed. A such, the volume of the pressurized gas (e.g., nitrogen) in the pressurized pneumatic chamber 570 does not change. During manufacture or assembly of the fan actuation system 500, the pressurized pneumatic chamber 570 can be charged with gas (e.g., nitrogen) and then sealed. The pressurized pneumatic chamber 570 can be pressurized to any amount depending on the size of the pressurized pneumatic chamber 570 and on the size of the hydraulic chambers 540, 542, 544 and the desired biasing force. In some examples, the pressure in the pressurized pneumatic chamber 570 is in a range from seven hundred twenty pounds per square inch to nine hundred twenty pounds per square inch (720 psi to 920 psi). In other examples, however, the pressure may be less than, or greater than, these exemplary values.

The pressurized gas in the pressurized pneumatic chamber 570 generates a constant force or a constant load that biases the hydraulic cylinder 516 in the forward direction (to the left in FIG. 5), which corresponds to the feather position of the plurality of fan blades 140. This provides a failsafe to move the plurality of fan blades 140 to the feather position in an event of failure of the hydraulic system 550 or a shutdown of the turbofan engine 110. For example, if the hydraulic system 550 or the turbofan engine 110 fails or is shut down, the hydraulic system 550 is not able to provide pressurized hydraulic fluid to the hydraulic chambers 540, 542, and 544 to control or to maintain the position of the hydraulic cylinder 516. In such an instance, the force on the hydraulic cylinder 516 from the pressurized gas in the pressurized pneumatic chamber 570 overcomes the force on the hydraulic cylinder 516 from the first hydraulic chamber 540 and the third hydraulic chamber 544. As such, the hydraulic cylinder 516 moves in the forward direction (to the left in FIG. 5), which moves the plurality of fan blades 140 to the feather position shown in FIG. 5. As such, the pressurized pneumatic chamber 570 provides a passive system that moves the plurality of fan blades 140 to the feather position in the event of a failure or a deactivation of the hydraulic system 550, which may occur if the turbofan engine 110 fails or is shut down. Therefore, if one of the turbofan engines of an aircraft fails or is deactivated during flight, the fan actuation system 500 automatically moves the plurality of fan blades 140 to the feather position (FIG. 5). This is advantageous because, in the feather position, the plurality of fan blades 140 produces less resistance, which reduces drag on the turbofan engine 110 and on the aircraft. This also reduces or prevents the plurality of fan blades 140 from spinning (due to incoming airflow) the internal turbo-machinery parts of the turbofan engine 110.

The example pressurized pneumatic chamber 570 is advantageous because it has a high load capability due to the compressibility of the pneumatic gas (e.g., nitrogen). Further, the pressurized pneumatic chamber 570 enables a longer travel of the hydraulic cylinder 516 with relatively little change in load. Therefore, the pressurized pneumatic chamber 570 provides a relatively constant load throughout the stroke. Also, the volume and areas of the pressurized pneumatic chamber 570 and the piston 518 can be varied to optimize the load versus travel of the hydraulic cylinder 516.

Therefore, during normal operation of the fan actuation system 500, the first hydraulic chamber 540 and the third hydraulic chamber 544 act to bias the hydraulic cylinder 516 in the rearward direction, while the second hydraulic chamber 542 and the pressurized pneumatic chamber 570 act to bias the hydraulic cylinder 516 in the forward direction. The pressures in the hydraulic chambers 540, 542, and 544 and in the pressurized pneumatic chamber 570 can be controlled to substantially balance the forces and to maintain the hydraulic cylinder 516 in a desired position. In the illustrated example of FIG. 5, a chamber 572 is formed or is defined between the hydraulic cylinder 516 and the piston 518. The chamber 572 is vented to the atmosphere. As such, the chamber 572 does not provide a force in either direction. In this example, the pressurized pneumatic chamber 570 is forward of the piston retainer 520 and the piston 518. In some examples, this is beneficial because there is additional space forward of these components. In other examples, however, the pressurized pneumatic chamber 570 can be disposed rearward of the piston 518 and the piston retainer 520.

In the example of FIG. 5, the fan actuation system 500 is devoid of a pitch lock device and counterweights for reducing inertial loading associated with rotation of fan blades. In particular, in known fan actuation systems, a separate pitch lock device is required to hold the plurality of fan blades 140 once the plurality of fan blades 140 is in the feather position. Further, in known fan actuation systems, a counterweight is used to provide additional force to help pitch the fan blades. However, with the fan actuation system 500, the pressurized pneumatic chamber 570 provides a constant biasing force to hold the plurality of fan blades 140 in the feather position, which eliminates the need for a separate pitch lock device. Further, the hydraulic system 550 provides the first pressure P1 in both the first hydraulic chamber 540 and the third hydraulic chamber 544 to provide a higher pressure to pitch the fan blades 140, which eliminates the need for a counterweight. This reduces parts, complexity, weight, and costs of the fan actuation system 500.

Examples have been disclosed herein that improve the ability for the fan actuation system 500 to move the fan blades 140 to the feather position in the event of failure of the fan actuation system 500 or a shutdown of the turbofan engine 110. The example systems disclosed herein are passive and, thus, do not require complicated activation components or control systems. The example pressurized pneumatic chamber 570 is capable of handling high rotational speeds and a large variation in operating temperatures, such as encountered during use on aircraft. The examples disclosed herein also eliminate the need for a pitch lock device. As such, the example systems can result in fewer parts, less complexity, reduced weight, and lower costs compared to known systems. The fan actuation system 500 is particularly useful in turbofan engines (e.g., the turbofan engine 110 of FIG. 1 or the turbofan engine 210 of FIG. 2) in which the space for the fan actuation system 500 is smaller as compared to turboprop engines. Components of the fan actuation system 500 can be used in combination with any of the fan actuation systems disclosed herein.

The turbofan engine 110 also includes one or more thrust bearings, also referred to as one or more radial thrust (radial blade load) bearings 580, disposed between the trunnion 504 and the fan disk 142 such that the trunnion 504 rotates about the pitch axis P with respect to the fan disk 142. The one or more radial thrust bearings 580 transmit the load (the radial blade load) from the respective fan blade 140 to a static structure of the turbofan engine 110. In particular, the radial thrust bearings 580 include a plurality of rolling elements 582. The rolling elements 582 can include, for example, ball bearings, tapered roller bearings, or the like, for transmitting the radial blade load from the fan blade 140 to the static structure.

The one or more radial thrust bearings 580 are disposed radially at a thrust bearing radius R_{T}B. The thrust bearing radius R_{T}B is defined in the radial direction R from the longitudinal centerline axis 112 to a radial center 583 of the one or more radial thrust bearings 580. The radial center 583 is a center of the radial thrust bearings 580 in the radial direction R. Particularly, the radial center 583 is defined as a radial center of the rolling elements 582. The amount of space, or the volume, beneath the fan 138 that is available for the fan actuation system 500 is defined by the thrust bearing radius R_{T}B. The fan actuation system 500 needs to be accommodated radially below the one or more radial thrust bearings 580 and within the thrust bearing radius R_{TB}.

The turbofan engine 110 includes a fan hub axial length A_{FH}, a fan actuation system axial length A_{FAS}, and a fan bearing axial length A_{FB}. The fan hub axial length A_{FH} is an axial length, in the axial direction (e.g., parallel with the longitudinal centerline axis 112) from the fan hub tip 157 to the pitch axis P of the fan blades 140. The fan actuation system axial length A_{FAS} is an axial length, in the axial direction (e.g., parallel with the longitudinal centerline axis 112), from an axially forward-most surface 515 of the fan actuation system 500 to the pitch axis P of the fan blades 140. In FIG. 5, the axially forward-most surface 515 is defined by an axially forward-most surface of the actuators 514 (e.g., of the hydraulic cylinder 516). The fan actuation system axial length A_{FAS} is a maximum of 80% of the fan hub axial length A_{FH}. In this way, the fan actuation system 500 fits within the fan hub 148 such that the actuators 514 can move axially without contacting the fan hub 148. The fan bearing axial length A_{FB} is an axial length, in the axial direction (e.g., parallel with the longitudinal centerline axis 112) from the pitch axis P of the fan blades 140 to an axial center of the fan bearings 155.

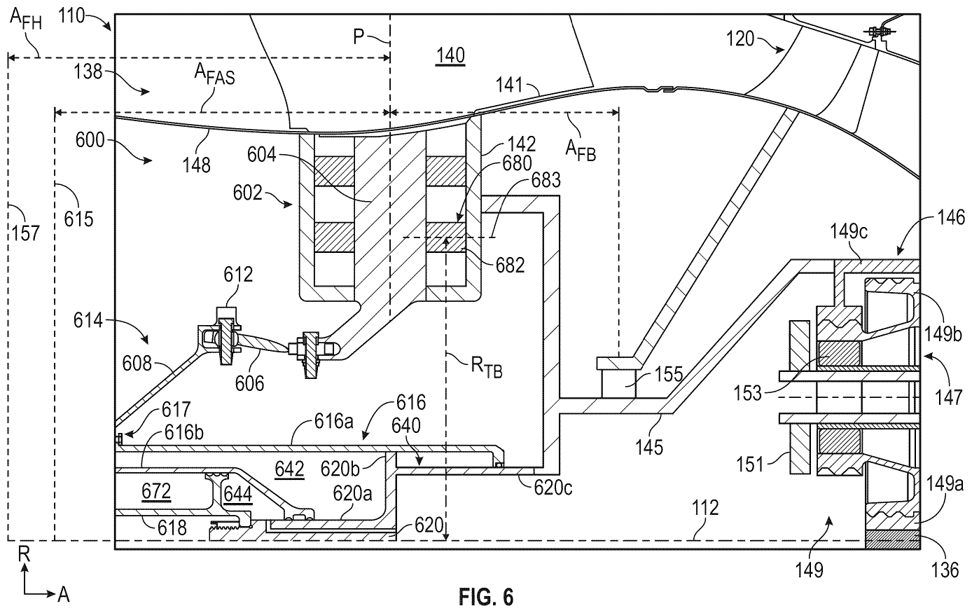

FIG. 6 is a schematic cross-sectional view of a fan actuation system 600 for the turbofan engine 110, taken along the longitudinal centerline axis 112 of the turbofan engine 110, according to the present disclosure. While the fan actuation system 600 is described as being utilized in the turbofan engine 110, the fan actuation system 600 can be utilized in the turbofan engine 210 of FIG. 2. The fan actuation system 600 is substantially similar to the fan actuation system 500 of FIG. 5. The same reference numerals will be used for components of the fan actuation system 600 that are the same as or similar to the components of the fan actuation system 500 discussed above. The description of these components above also applies to this aspect, and a detailed description of these components is omitted here.

The fan actuation system 600 includes a trunnion mechanism 602, a plurality of trunnions 604, a plurality of trunnion links 606, a unison ring 608, a plurality of pins 612, one or more actuators 614, a hydraulic cylinder 616, a joint 617, a piston 618, and a piston retainer 620. The hydraulic cylinder 616 has a first portion 616a and a second portion 616b. Although not shown in the view of FIG. 6, the hydraulic cylinder 616 also includes a third portion and a fourth portion similar to the third portion 516c and the fourth portion 516d of the hydraulic cylinder 516 of FIG. 5. The piston retainer 620 has a first portion 620a, a second portion 620b, and a third portion 620c. The fan actuation system 600 also includes a first hydraulic chamber 640, a second hydraulic chamber 642, a third hydraulic chamber 644, and a pressurized pneumatic chamber (not shown in the view of FIG. 6), and a chamber 672. The first hydraulic chamber 640 and the third hydraulic chamber 644 receive the hydraulic fluid at a first pressure P1, and the second hydraulic chamber 642 receives the hydraulic fluid at a second pressure P2, as detailed above with respect to FIG. 5. The fan actuation system 600 operates substantially similar as to the fan actuation system 500 of FIG. 5.

FIG. 6 shows one fan blade 140 of the fan 138, the core inlet 120, and the gearbox assembly 146. The gearbox assembly 146 includes a gear assembly 147 having a plurality of gears 149 including a first gear 149a, one or more second gears 149b secured by a planet carrier 151, and a third gear 149c. In FIG. 6, the first gear 149a is a sun gear, the one or more second gears 149b are planet gears, and the third gear 149c is a ring gear. The gear assembly 147 is an epicyclic gear assembly. When the gear assembly 147 is an epicyclic gear assembly, the one or more second gears 149b include a plurality of second gears 149b (e.g., two or more second gears 149b).

In the epicyclic gear assembly, the gear assembly 147 can be in a star arrangement or a rotating ring gear type gear assembly (e.g., the third gear 149c is rotating and the planet carrier 151 is fixed and stationary). In such an arrangement, the fan 138 is driven by the third gear 149c. For example, the third gear 149c is coupled to the fan shaft 145 such that rotation of the third gear 149c causes the fan shaft 145, and, thus, the fan 138, to rotate. In this way, the third gear 149c is an output of the gear assembly 147. However, other suitable types of gear assemblies may be employed. In one non-limiting aspect, the gear assembly 147 is a planetary arrangement, in which the third gear 149c is held fixed, with the planet carrier 151 allowed to rotate. In such an arrangement, the fan 138 is driven by the planet carrier 151. For example, the planet carrier 151 is coupled to the fan shaft 145 such that rotation of the planet carrier 151 causes the fan shaft 145, and, thus, the fan 138, to rotate. In this way, the one or more second gears 149b (e.g., via the planet carrier 151) are the output of the gear assembly 147. In another non-limiting aspect, the gear assembly 147 may be a differential gear assembly in which the third gear 149c and the planet carrier 151 are both allowed to rotate. While an epicyclic gear assembly is detailed herein, the gear assembly can include any type of gear assembly including, for example, a single stage gear assembly or a compound gear assembly (e.g., a gear assembly having a plurality of stages).

The plurality of gears 149 includes one or more gear bearings 153 disposed therein. For example, the one or more second gears 149b each includes one or more gear bearings 153 disposed therein. The one or more gear bearings 153 enable the plurality of gears 149 to rotate about the one or more gear bearings 153 such that the plurality of gears 149 rotates. The one or more gear bearings 153 can include any type of bearing for a gear, such as, for example, journal bearings, roller bearings, or the like. The gearbox assembly 146 can include a plurality of gear bearings that includes a forward gear bearing and an aft gear bearing. The one or more gear bearings 153 shown in the view of FIG. 6 are the forward gear bearing.

The first gear 149a is coupled to an input shaft of the turbofan engine 110. For example, the first gear 149a is coupled to the LP shaft 136 such that rotation of the LP shaft 136 causes the first gear 149a to rotate. Radially outward of the first gear 149a, and intermeshing therewith, is the one or more second gears 149b that are coupled together and supported by the planet carrier 151. The planet carrier 151 supports and constrains the one or more second gears 149b such that the each of the one or more second gears 149b is enabled to rotate about a corresponding axis of each second gear 149b without rotating about the periphery of the first gear 149a. Radially outwardly of the one or more second gears 149b, and intermeshing therewith, is the third gear 149c, which is an annular ring gear. The third gear 149c is coupled via an output shaft to the fan 138 and rotates to drive rotation of the fan 138 about the longitudinal centerline axis 112. For example, the fan shaft 145 is coupled to the third gear 149c.

The fan shaft 145 is coupled to the fan disk 142 such that rotation of the fan shaft 145 causes the plurality of fan blades 140 to rotate about the longitudinal centerline axis 112. The turbofan engine 110 also includes one or more radial thrust bearings 680, disposed between the trunnion 604 and the fan disk 142 such that the trunnion 604 rotates about the pitch axis P with respect to the fan disk 142. In particular, the radial thrust bearings 680 include a plurality of rolling elements 682.

The one or more radial thrust bearings 680 are disposed radially at the thrust bearing radius R_{TB} defined in the radial direction R from the longitudinal centerline axis 112 to a radial center 683 of the one or more radial thrust bearings 680, as discussed above. The fan actuation system axial length A_{FAS} is an axial length, in the axial direction (e.g., parallel with the longitudinal centerline axis 112), from an axially forward-most surface 615 (shown schematically in FIG. 6) of the fan actuation system 600 to the pitch axis P of the fan blades 140.

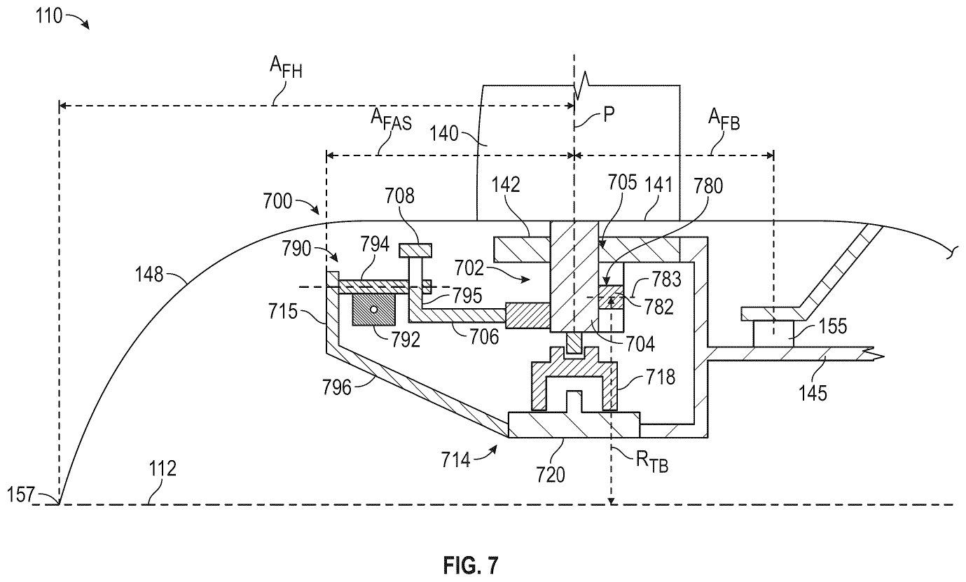

FIG. 7 is a schematic cross-sectional view of a fan actuation system 700 for the turbofan engine 110, taken along the longitudinal centerline axis 112 of the turbofan engine 110, according to the present disclosure. While the fan actuation system 700 is described as being utilized in the turbofan engine 110, the fan actuation system 700 can be utilized in the turbofan engine 210 of FIG. 2. The fan actuation system 700 is substantially similar to the fan actuation system 500 of FIG. 5. The same or similar reference numerals will be used for components of the fan actuation system 700 that are the same as or similar to the components of the fan actuation system 500 discussed above. The description of these components above also applies to this aspect, and a detailed description of these components is omitted here.

The fan actuation system 700 includes a trunnion mechanism 702, a plurality of trunnions 704, an opening 705, one or more trunnion links 706, a unison ring 708, one or more actuators 714, an axially forward-most surface 715, a piston 718, a piston retainer 720, and one or more radial thrust bearings 780. The piston retainer 720 is stationary (e.g., coupled to a static structure of the turbofan engine 110) and the piston 718 moves with respect to the piston retainer 720 to change a pitch of the fan blades 140. For example, the piston 718 can be coupled to a hydraulic cylinder that receives hydraulic fluid for moving the piston 718, as detailed above. The one or more trunnion links 706 include one or more ring gears that mesh with a corresponding gear of the trunnions 704.

The fan actuation system 700 also includes a counterweight assembly 790 including one or more counterweights 792. The counterweights 792 are axially spaced from the trunnions 704 to counter a centrifugal twisting moment of the fan blades 140. The counterweights 792 can be any high-density mass that can rotate about a counterweight centerline. The counterweights 792 can have offset masses that are movable relative to the counterweight centerline. In particular, the counterweights 792 are coupled to one or more counterweight shafts 794 that are drivingly coupled to the trunnion links 706 via one or more counterweight gears 795. The counterweight shafts 794 are supported by one or more counterweight support members 796 that are coupled to the piston retainer 720. In FIG. 7, the axially forward-most surface 715 is defined by an axially forward-most surface of the counterweight support member 796. In this way, the axially forward-most surface 715 is defined by the counterweight assembly 790.

As the trunnions 704 rotate, the trunnions 704 cause the trunnion links 706 to rotate with respect to the unison ring 708, and in turn, the trunnion links 706 cause the counterweight shafts 794 to rotate. As the trunnion links 706 and the counterweight shafts 794 rotate, the counterweights 792 rotate via the counterweight shafts 794. In this way, the counterweights 792 change position relative to the counterweight centerline. Thus, the counterweight assembly 790 counters a centrifugal twisting moment of the fan blades 140 to help rotate the fan blades 140 when the pitch of the fan blades 140 changes.

A mass of the counterweights 792 can be changed based on a length of the counterweight shafts 794. In particular, the counterweights 792 can have less mass with longer counterweight shafts 794 and can have more mass with shorter counterweight shafts 794. In this way, the axially further the counterweights 792 are disposed from the pitch axis P of the fan blades 140, the lesser mass the counterweights 792 can have, while still countering the centrifugal twisting moment of the fan blades 140 and helping to rotate the fan blades 140 when the pitch of the fan blades 140 changes. Accordingly, the mass of the counterweights 792 needed to pitch the fan blades 140 and counter the twisting moment is a function of the axial position of the counterweights 792 with respect to the pitch axis P.

The one or more radial thrust bearings 780 are disposed radially at the thrust bearing radius R_{TB} defined in the radial direction R from the longitudinal centerline axis 112 to a radial center 783 of a plurality of rolling elements 782 of the radial thrust bearings 780, as discussed above. The fan actuation system axial length A_{FAS} is an axial length, in the axial direction (e.g., parallel with the longitudinal centerline axis 112), from an axially forward-most surface 715 of the fan actuation system 700 to the pitch axis P of the fan blades 140.

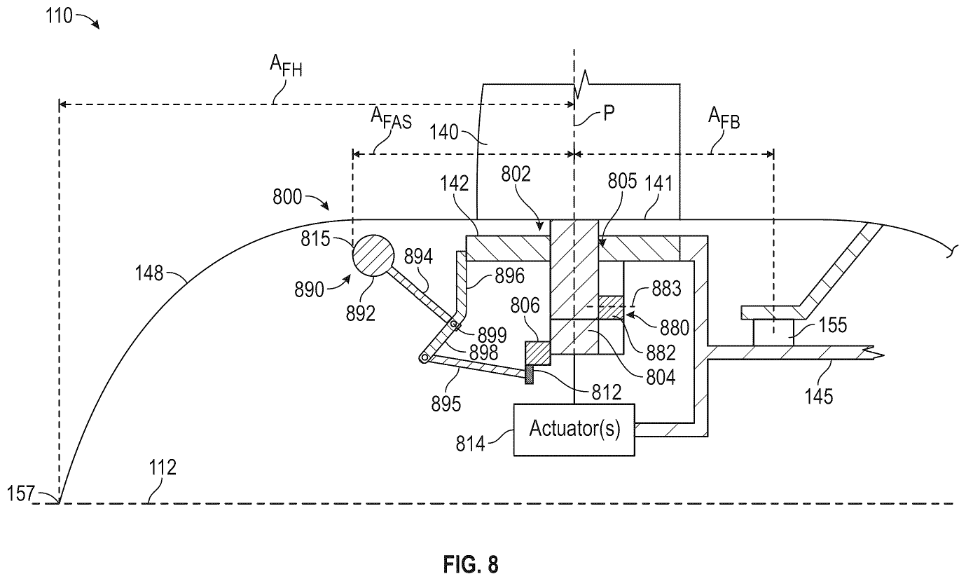

FIG. 8 is a schematic cross-sectional view of a fan actuation system 800 for the turbofan engine 110, taken along the longitudinal centerline axis 112 of the turbofan engine 110, according to the present disclosure. While the fan actuation system 800 is described as being utilized in the turbofan engine 110, the fan actuation system 800 can be utilized in the turbofan engine 210 of FIG. 2. The fan actuation system 800 is substantially similar to the fan actuation system 700 of FIG. 7. The same or similar reference numerals will be used for components of the fan actuation system 800 that are the same as or similar to the components of the fan actuation system 700 discussed above. The description of these components above also applies to this aspect, and a detailed description of these components is omitted here.

The fan actuation system 800 includes a trunnion mechanism 802, a plurality of trunnions 804, an opening 805, one or more trunnion links 806, a plurality of pins 812, one or more actuators 814 (shown schematically in FIG. 8), an axially forward-most surface 815, and one or more radial thrust bearings 880. The actuators 814 can include any of the actuators disclosed herein for changing a pitch of the fan blades 140. The one or more trunnion links 806 include arms that extend from the trunnions 804. The pins 812 extend through the arms and are coupled to a counterweight assembly 890.

The counterweight assembly 890 includes one or more counterweights 892, one or more counterweight shafts 894, and one or more counterweight support members 896. The one or more counterweight support members 896 are coupled to the fan disk 142 such that the counterweight assembly 890 rotates about the longitudinal centerline axis 112 with rotation of the fan 138. The counterweight assembly 890 also includes one or more link arms 895 and one or more lever arms 898. The one or more lever arms 898 are pivotably coupled to the counterweight support members 896 via a pivot 899. The link arms 895 are coupled to the trunnion links 806 via the pins 812 and are pivotably coupled to the lever arms 898. The counterweight shafts 894 are pivotably coupled to the lever arms 898 at the pivot 899.

In FIG. 8, the axially forward-most surface 815 is defined by an axially forward-most surface of the counterweights 892 at a maximum axial extent of the counterweights 892, as detailed further below. In this way, the axially forward-most surface 815 is defined by the counterweight assembly 890.

As the trunnions 804 rotate, the trunnions 804 cause the trunnion links 806 to rotate, and in turn, the trunnion links 806 cause the pins 812 to rotate, and, thus, cause the link arms 895 to pivot. As the link arms 895 pivot, the link arms 895 cause the lever arms 898 to pivot, and, thus, cause the counterweight shafts 894 to pivot about the pivot 899. In this way, the counterweight shafts 894 cause the counterweights 892 to travel along a partially circular arc radially outward away from the longitudinal centerline axis 112 or radially inward towards the longitudinal centerline axis 112. Thus, the counterweight assembly 890 counters a centrifugal twisting moment of the fan blades 140 to help rotate the fan blades 140 when the pitch of the fan blades 140 changes.

The one or more radial thrust bearings 880 are disposed radially at the thrust bearing radius R_{TB} defined in the radial direction R from the longitudinal centerline axis 112 to a radial center 883 of a plurality of rolling elements 882 of the radial thrust bearings 880, as discussed above. The fan actuation system axial length A_{FAS} is an axial length, in the axial direction (e.g., parallel with the longitudinal centerline axis 112), from an axially forward-most surface 815 of the fan actuation system 800 to the pitch axis P of the fan blades 140.

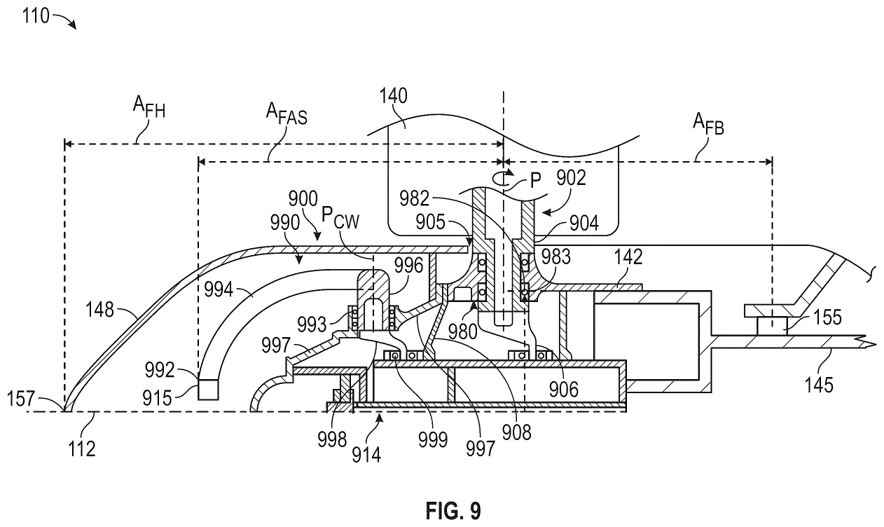

FIG. 9 is a schematic cross-sectional view of a fan actuation system 900 for the turbofan engine 110, taken along the longitudinal centerline axis 112 of the turbofan engine 110, according to the present disclosure. While the fan actuation system 900 is described as being utilized in the turbofan engine 110, the fan actuation system 900 can be utilized in the turbofan engine 210 of FIG. 2. The fan actuation system 900 is substantially similar to the fan actuation system 700 of FIG. 7. The same or similar reference numerals will be used for components of the fan actuation system 900 that are the same as or similar to the components of the fan actuation system 700 discussed above. The description of these components above also applies to this aspect, and a detailed description of these components is omitted here.

The fan actuation system 900 includes a trunnion mechanism 902, a plurality of trunnions 904, an opening 905, one or more trunnion links 906, a unison ring 908, one or more actuators 914, an axially forward-most surface 915, and one or more radial thrust bearings 980. The actuators 914 can include any of the actuators disclosed herein for changing a pitch of the fan blades 140. The one or more trunnion links 906 and the unison ring 908 couple the trunnions 904 to the actuators 914 such that movement of the actuators 914 causes the trunnions 904 to rotate, thus, causing the fan blades 140 to rotate about the pitch axis P.

The counterweight assembly 990 includes one or more counterweights 992, one or more counterweight shafts 994, one or more counterweight support members 996, and one or more lever arms 998. In FIG. 9, the counterweight shafts 994 are counterweight levers and the counterweight support members 996 are counterweight trunnions.

The counterweight assembly 990 includes a counterweight hub 997 that may be connected to the fan disk 142, such that rotation of the fan disk 142 about the longitudinal centerline axis 112 drives rotation of the counterweight hub 997 about the longitudinal centerline axis 112. The counterweight shafts 994 are rotationally connected to the counterweight hub 997. For example, each of the counterweight shafts 994 may be mounted to the counterweight hub 997 via one or more counterweight bearings 993 that provide the ability for the counterweight shafts 994 to rotate about a counterweight lever rotational axis P_{CW}. The counterweight bearings 993 may be any type of bearing (e.g., tapered roller bearings, spherical roller bearings, cylindrical roller bearings, needle roller bearings, thrust ball bearings, angular contact roller bearings, deep groove ball bearings, etc.), and are not limited to any particular type of bearing Each of the counterweight support members 996 are rotational about a counterweight lever rotational axis P_{CW} that extends through a respective counterweight support member 996 and extends radially (i.e., in the radial direction R) from the longitudinal centerline axis 112.

Each counterweight shaft 994 is a cantilever arm having a first end connected to a respective counterweight support member 996 and a second end offset from the respective counterweight lever rotational axis P_{CW}. A respective counterweight 992 is connected to the second end of the counterweight shaft 994. Each counterweight 992 has a counterweight center-of-gravity that is utilized in locating the counterweight 992 within the counterweight assembly 990.

The one or more counterweight support members 996 are coupled to the fan disk 142 such that the counterweight assembly 990 rotates about the longitudinal centerline axis 112 with rotation of the fan 138. The counterweight assembly 990 also includes one or more lever arms 998 that are rotationally connected to the actuators 914 via one or more lever bearings 999. The lever arms 998 are connected to the counterweight support members 996 such that axial translation of the actuators 914 along the longitudinal centerline axis 112 drives the lever arms 998 and the counterweight support members 996 about the respective counterweight lever rotational axis P_{CW} so as to rotate the counterweight shafts 994. In FIG. 9, the counterweight shafts 994 are at a ninety-degree rotated position.

In FIG. 9, the axially forward-most surface 915 is defined by an axially forward-most surface of the counterweights 992 at a maximum axial extent of the counterweights 992 (e.g., at the ninety-degree rotated position). In this way, the axially forward-most surface 915 is defined by the counterweight assembly 990.

As the actuators 914 move axially, the actuators 914 cause the trunnions 904 and the counterweight support members 996 to rotate. In turn, the counterweight support members 996 cause the counterweight shafts 994 to rotate about the counterweight lever rotational axis P_{CW}, and, thus, cause the counterweights 992 to rotate. In particular, the counterweight shafts 994, and the counterweights 992, rotate in to or out of the page between the ninety-degree rotated position that defines a maximum axial extent of the counterweights 992 and a zero-degree rotated position that defines a minimum axial extend of the counterweights 992. Thus, the counterweight assembly 990 counters a centrifugal twisting moment of the fan blades 140 to help rotate the fan blades 140 when the pitch of the fan blades 140 changes.

The one or more radial thrust bearings 980 are disposed radially at the thrust bearing radius R_{TB} defined in the radial direction R from the longitudinal centerline axis 112 to a radial center 983 of a plurality of rolling elements 982 of the radial thrust bearings 980, as discussed above. The fan actuation system axial length A_{FAS} is an axial length, in the axial direction (e.g., parallel with the longitudinal centerline axis 112), from an axially forward-most surface 915 of the fan actuation system 900 to the pitch axis P of the fan blades 140.

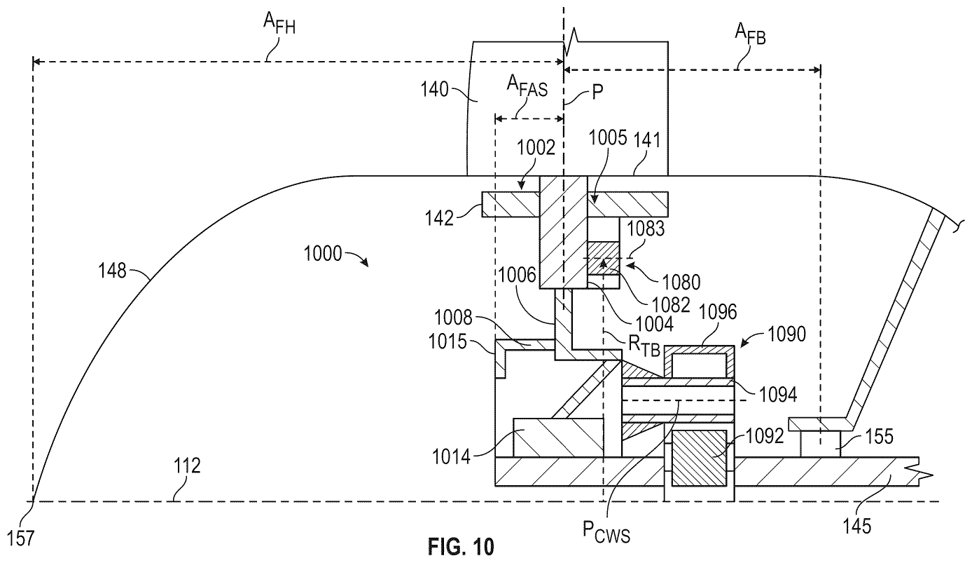

FIG. 10 is a schematic cross-sectional view of a fan actuation system 1000 for the turbofan engine 110, taken along the longitudinal centerline axis 112 of the turbofan engine 110, according to the present disclosure. While the fan actuation system 1000 is described as being utilized in the turbofan engine 110, the fan actuation system 1000 can be utilized in the turbofan engine 210 of FIG. 2. The fan actuation system 1000 is substantially similar to the fan actuation system 500 of FIG. 5. The same or similar reference numerals will be used for components of the fan actuation system 1000 that are the same as or similar to the components of the fan actuation system 500 discussed above. The description of these components above also applies to this aspect, and a detailed description of these components is omitted here.

The fan actuation system 1000 includes a trunnion mechanism 1002, a plurality of trunnions 1004, an opening 1005, one or more trunnion links 1006, a unison ring 1008, one or more actuators 1014, an axially forward-most surface 1015, one or more radial thrust bearings 1080, and a counterweight assembly 1090. The actuators 1014 can include any of the actuators disclosed herein for changing a pitch of the fan blades 140. The one or more trunnion links 1006 and the unison ring 1008 couple the trunnions 1004 to the actuators 1014 such that movement of the actuators 1014 causes the trunnions 1004 to rotate, thus, causing the fan blades 140 to rotate about the pitch axis P. In FIG. 10, the axially forward-most surface 1015 is defined by an axially forward-most surface of the unison ring 1008.

The counterweight assembly 1090 includes one or more counterweights 1092, one or more counterweight shafts 1094, and one or more counterweight support members 1096. The one or more counterweight support members 1096 are coupled to the fan disk 142 via the unison ring 1008 such that the counterweight assembly 1090 rotates about the longitudinal centerline axis 112 with rotation of the fan 138. The counterweights 1092 are positioned axially aft of the fan blades 140, particularly, axially aft of the pitch axis P. For example, the counterweights 1092 are positioned axially between the pitch axis P and the fan bearings 155.

The counterweight support members 1096 act as a carrier for the counterweight shafts 1094. The counterweight shafts 1094 are generally aligned parallel to the longitudinal centerline axis 112 and pass through the counterweight support members 1096. The counterweight shafts 1094 are rotatably connected (e.g., via one or more gears) at a first end to the unison ring 1008. The counterweights 1092 are connected to a second end of the counterweight shafts 1094. The counterweight shafts 1094, and the counterweights 1092, are rotatable relative to the counterweight support members 1096, about a respective counterweight shaft axis P_{CWS}.

All of the counterweight shafts 1094 are meshed via one or more gears with the unison ring 1008. Thus connected, the movement of the fan blades 140, unison ring 1008, and the counterweights 1092 are linked together such that rotary motion of the unison ring 1008, for example, caused by the actuators 1014, will cause a simultaneous change in the pitch angle of all of the fan blades 140, and of the angular orientation of the counterweights 1092. The unison ring 1008 transmits forces between the fan blades 140 and the counterweights 1092. In this way, the counterweight shafts 1094 cause the counterweights 1092 to travel along a partially circular arc radially outward away from the longitudinal centerline axis 112 or radially inward towards the longitudinal centerline axis 112, and axially closer to, or axially further from, the pitch axis P. Thus, the counterweight assembly 1090 counters a centrifugal twisting moment of the fan blades 140 to help rotate the fan blades 140 when the pitch of the fan blades 140 changes.

The one or more radial thrust bearings 1080 are disposed radially at the thrust bearing radius R_{TB} defined in the radial direction R from the longitudinal centerline axis 112 to a radial center 1083 of a plurality of rolling elements 1082 of the radial thrust bearings 1080, as discussed above. The fan actuation system axial length A_{FAS} is an axial length, in the axial direction (e.g., parallel with the longitudinal centerline axis 112), from an axially forward-most surface 1015 of the fan actuation system 1000 to the pitch axis P of the fan blades 140.

As mentioned earlier, the inventors sought to address the problem implementing a variable pitch actuation system within the more limited packaging space available in a turbofan engine and while accounting for the significantly higher loading environment and more numerous blades relative to a turboprop engine. By way of testing various engine architectures the inventors experimented with different configurations of the pitch actuation system, fine and coarse pitch actuators, hydraulic actuators, and bearing placement that could sustain the higher loading associated with more numerous blades, higher disk loading, and Mach speed sufficient to satisfy operational and safety requirements in the event of, e.g., loss of hydraulic pressure. Additionally, while it was possible to arrive at such a system after experiments and testing, there was a challenge to determine how to fit the system within a comparatively more limited space of a turbofan engine.

During the course of evaluating the different embodiments as set forth herein, with the goal of providing the necessary force to pitch the fan blades, taking due account for the number of blades, accounting for loss in fluid pressure or generally lost power conditions, aerodynamic performance, cooling, aeromechanics, and disc loading/fan blade loading, etc., the inventors had discovered there was indeed much less space available for this system to operate as required for the engine's pitch actuation system. After evaluating several different architectures of pitch change mechanisms (with and without counterweight, oil transfer devices, fine and coarse pitch system, torque transfer load path for pitching blades and delivery of shaft power from gearbox, etc.—both for a ducted engine and an open fan engine—it was discovered, unexpectedly, that there is relationships among the number of fan blades, the fan tip diameter D_{FT}, the cruise Mach number, and the thrust bearing radius R_{TB}, and an axial length L_{AXIAL} capable of differentiating an architecture that satisfies operational and packaging requirements from an architecture that does not satisfy these requirements. These relationships moreover are capable of uniquely identifying a finite and readily ascertainable number of embodiments suitable for a particular architecture that accounts for the size and the loading requirements needed to pitch the fan blades without overly sacrificing the aerodynamic performance, cooling aeromechanics, and load margins on the fan blades. For example, the cruise Mach number was not expected to be a significant factor, but as discussed further below, the cruise Mach number was found to be a factor and particularly in conjunction with fan diameter at higher Mach numbers. The inventors submit that the relationships enable one to select a size for the fan pitch actuation system that can reduce the size and the weight of the fan pitch actuation system, while accounting for the factors discussed above. The inventors further submit that the relationships can help identify an improved fan efficiency, or penalties to efficiency by choosing one fan pitch actuation system architecture over another. A relationship is referred to as a fan actuation system (FAS) envelope, in relationship (1):

$$FAS envelope = \frac{{N}_{FB} \times {D}_{FT} \times {M}_{cruise}}{( \frac{{R}_{TB}}{{N}_{FB}} )} . \qquad ( 1 )$$

N_{FB} is the number of fan blades of the fan, D_{FT} is the fan tip diameter, M_{cruise} is the Mach number at cruise (mid-level power operation), and R_{TB} is the thrust bearing radius of the radial thrust bearings (any of the radial thrust bearings detailed herein). N_{FB}×D_{FT}×M_{cruise} is referred to as a loading envelope, and R_{TB}/N_{FB} is referred to as a spacing envelope. Accordingly, the FAS envelope is given by the loading envelope divided by the spacing envelope.

A second relationship is referred to as a fan actuation system length (FASL) envelope, in relationship (2):

$$FASL envelope = \frac{{N}_{FB} \times {D}_{FT}}{{L}_{AXIAL} ( \frac{{R}_{TB}}{{N}_{FB}} )} . \qquad ( 2 )$$

N_{FB} is the number of fan blades of the fan, D_{FT} is the fan tip diameter, R_{TB} is the thrust bearing radius of the radial thrust bearings, and L_{AXIAL} is an axial length, along the longitudinal centerline axis 112 from the fan hub tip 157 to the fan bearings 155. In particular, L_{AXIAL} is a summation of the fan hub axial length A_{FH} and the fan bearing axial length A_{FB}. N_{FB}×D_{FT} is referred to as a loading envelope, and L_{AXIAL}×(R_{TB}/N_{FB}) is referred to as a spacing envelope. Accordingly, the FASL envelope is given by the loading envelope divided by the spacing envelope.

As discussed further below, the inventors identified a range for the FAS envelope and the FASL envelope that enables a fan actuation system design for different turbofan engine architectures that accounts for the integrity/reliability of load paths needed to pitch the fan blades within the space constraints imposed by a turbofan engine (vs. a turboprop's space constraints). Fan pitch actuation system architectures that fall within this range are believed to satisfy packaging requirements for a turbofan engine, while those architectures that do not fall within the FAS envelope range or the FASL envelope range are believed to not satisfy the packaging requirements, which indicate that the system would be unacceptably large and not result in an aircraft engine that met aero efficiency and weight requirements (i.e., an undesirable engine architecture). Using these unique relationships, the size of the fan actuation system can be selected to achieve a more compact fan pitch actuation system for a turbofan engine. Using the FAS envelope or the FASL envelope as a guide, a fan pitch actuation system can be developed that takes into account the loading associated with pitching of the fan blades based on the size of the fan blades, the number of fan blades, the size of thrust bearing, the cruise Mach number, or the axial length, which factors were found—as a result of the extensive number of architectures considered for different thrust class engines, some successful and some not successful—to largely define the packaging size needed to accommodate a pitch actuation system capable of handling the fan loading environment.

Table 1 represents exemplary embodiments 1 to 14 and their corresponding FAS envelope and FASL envelope values for various turbofan engines at various cruise Mach numbers. Embodiments 1 to 14 may represent the turbofan engine 110 of FIG. 1 (e.g., ducted engine) or the turbofan engine 210 of FIG. 2 (e.g., unducted fan engine) and can be applied to any of the pitch actuation systems detailed herein. In particular, embodiments 7, 9, and 13 are ducted engines (e.g., such as the turbofan engine 110 of FIG. 1), and embodiments 1 to 6, 8, 10 to 12, and 14 are unducted fan engines (e.g., such as the turbofan engine 210 of FIG. 2). In Table 1, the FAS envelope values were determined based on relationship (1) described above, the FASL envelope values were determined based on relationship (2) described above, and using fan tip diameters D_{FT}, thrust bearing radiuses R_{TB}, and axial lengths L_{AXIAL} in inches.

TABLE 1

| | | D_{FT} | R_{TB} | A_{FH} | A_{FB} | | FAS | FASL |
|---|---|---|---|---|---|---|---|---|
| Emb. | N_{FB} | (in.) | (in.) | (in.) | (in.) | M_{cruise} | Envelope | Envelope |
| 1 | 12 | 156.0 | 26.9 | 60.60 | 21.60 | 0.8 | 668 | 10.2 |
| 2 | 14 | 156.0 | 24.9 | 60.60 | 20.98 | 0.8 | 982 | 15.1 |
| 3 | 14 | 154.0 | 24.7 | 59.82 | 20.92 | 0.8 | 978 | 15.1 |
| 4 | 14 | 153.8 | 24.3 | 59.75 | 20.79 | 0.8 | 992 | 15.4 |
| 5 | 14 | 164.3 | 24.6 | 63.82 | 20.89 | 0.8 | 1047 | 15.5 |
| 6 | 14 | 110.4 | 19.5 | 42.89 | 19.31 | 0.8 | 888 | 17.8 |
| 7 | 12 | 88.7 | 19.0 | 34.46 | 19.15 | 0.9 | 605 | 12.5 |
| 8 | 10 | 120.0 | 14.8 | 46.62 | 17.85 | 0.9 | 730 | 12.6 |
| 9 | 10 | 84.0 | 14.0 | 32.63 | 17.61 | 0.75 | 450 | 11.9 |
| 10 | 18 | 168.0 | 27.0 | 65.26 | 21.63 | 0.9 | 1814 | 23.2 |
| 11 | 10 | 120 | 14.0 | 46.62 | 17.61 | 0.8 | 686 | 13.3 |
| 12 | 14 | 168.0 | 19.0 | 65.26 | 19.15 | 0.88 | 1525 | 20.5 |
| 13 | 10 | 84.0 | 19.0 | 32.63 | 19.15 | 0.8 | 354 | 8.5 |
| 14 | 14 | 120.0 | 27.0 | 46.62 | 21.63 | 0.88 | 767 | 12.8 |
| 15 | 14 | 180.0 | 19.0 | 69.92 | 19.15 | 0.92 | 1708 | 20.8 |

The FAS envelope and the FASL envelope are only valid for an engine with fan blades N_{FB} in a range from ten to eighteen for a ducted engine, and from ten to sixteen for an open fan engine. In some example embodiments, the number of fan blades N_{FB} is in ten to fourteen for an open fan engine. The number of fan blades N_{FB} affects the volume (e.g., amount of space) circumscribed by the fan blades. Increasing the number of fan blades N_{FB} increases the amount of airflow that the fan can produce for a particular fan tip diameter and fan rotation speed, but a higher N_{FB} also reduces the tangential distance T_{FB} between fan blades at the fan hub, which impacts the available space for pitch actuation of each individual blade, referring to the space needed per blade for pitch levers, gearing, oil transfer devices, related mechanisms for pitching fan blades and size of load bearing parts of the trunnion and related supporting structure capable of carrying the fan blade loads. This space is at a premium because with an increased number of fan blades the loading capability per blade needs to be satisfied within a smaller space compared to an engine with fewer blades (e.g., such as a turboprop engine). The FAS envelope values and the FASL envelope values account for the number of fan blades N_{F}B selected to increase the amount of airflow but without imposing an unrealistically narrow tangential fan blade distance T_{FB} between adjacent fan blades in order to fit within the desired packaging envelope.

The FAS envelope and the FASL envelope are only valid for a fan tip diameter D_{FT} in a range from eighty-four inches to one hundred ninety-two inches (84.0 in. to 192.0 in.). In some example embodiments, the FAS envelope and the FASL envelope are valid for a fan tip diameter D_{FT} in a range from eighty-four inches to one hundred eighty inches (84.0 in. to 180.0 in.). In some example embodiments, the FAS envelope and the FASL envelope are valid for a fan tip diameter D_{FT} in a range from eighty-four inches to one hundred sixty-eight inches (84.0 in. to 168.0 in.). The fan tip diameter D_{FT} also affects the volume needed for supporting the fan blades during operation. Increasing the fan tip diameter D_{FT} increases the fan tip speed for a given rotational speed and therefore the load that needs to get reacted at the trunnion, and torque needed in the pitching mechanism for pitching the blade. The radial spacing between blades and within the volume circumscribed by the fan blades (e.g., within the space circumscribed by the radial thrust bearings) decreases, thereby decreasing the volume beneath the fan and providing less space for the load bearing structure that can react the blade loads. Furthermore, as the bearing radius R_{TB} is extended out, the structure supporting the blade at its root needs to be capable of sustaining higher loads because the blade is disposed further from the fan rotation axis. The more robust root results in a larger fan disk, further providing less space underneath the fan for the fan actuation system. In view of these weight and size considerations, as well as the ability to install such fan blades and fans without resulting in unacceptable aero efficiency penalties, the inventors determined that a fan tip diameter D_{FT} should be less than one hundred ninety-two inches (192.0 in.). In some example embodiments, the fan tip diameter D_{FT} should be less than one hundred eighty inches (180.0 in.). In some example embodiments, the fan tip diameter D_{FT} should be less than one hundred sixty-eight inches (168.0 in.). The fan tip diameter D_{FT} may therefore be limited as it impacts the space available for a pitch actuation system suitable for carrying fan blade loads. The size of the fan blades in ducted engines is limited by the duct (e.g., the nacelle). In embodiments for a ducted engine (e.g., the turbofan engine 110 of FIG. 1), the fan tip diameter D_{FT} is in a range from eighty-four inches to one hundred twenty inches (84.0 in. to 120.0 in.). In embodiments for an open fan engine (e.g., the turbofan engine 210 of FIG. 2), the fan tip diameter D_{FT} is in a range from one hundred twenty inches to one hundred ninety-two inches (120.0 in. to 192.0 in.). In some aspects for an open fan engine (e.g., the turbofan engine 210 of FIG. 2), the fan tip diameter D_{FT} is in a range from one hundred twenty inches to one hundred eighty inches (120.0 in. to 180.0 in.). In some aspects for an open fan engine (e.g., the turbofan engine 210 of FIG. 2), the fan tip diameter D_{FT} is in a range from one hundred twenty inches to one hundred sixty-eight inches (120.0 in. to 168.0 in.).

The FAS envelope and the FASL envelope are only valid for a thrust bearing radius R_{T}B in a range from ten inches to twenty-seven inches (10 in. to 27 in.). In some example embodiments, the thrust bearing radius R_{T}B is in a range from twelve inches to twenty-seven inches (12 in. to 27 in.). In some example embodiments, the thrust bearing radius R_{T}B is in a range from fourteen inches to twenty-seven inches (14 in. to 27 in.). The thrust bearing radius R_{TB} defines the amount of space, or the volume available for the fan actuation system. Increasing the thrust bearing radius R_{T}B provides more space for the fan actuation system but sacrifices aerodynamic performance by making the fan hub radius ratio (i.e., the ratio of the fan hub radius to the fan blade radius) larger. Decreasing the thrust bearing radius R_{T}B reduces the fan hub radius ratio and reduces the size of the turbofan engine but provides less space to carry the loads from the fan blades. The thrust bearing radius R_{T}B reflects the need for adequately accommodating the diameter needed for packaging the fan actuation system but without overly sacrificing aerodynamic performance of the turbofan engine. In embodiments for a ducted engine (e.g., the turbofan engine 110 of FIG. 1), the thrust bearing radius R_{T}B is in a range from twelve inches to nineteen inches (12 in. to 19 in.). In some aspects for a ducted engine, the thrust bearing radius R_{T}B is in a range from fourteen inches to nineteen inches (14 in. to 19 in.). In embodiments for an open fan engine (e.g., the turbofan engine 210 of FIG. 2), the thrust bearing radius R_{T}B is in a range from ten inches to twenty-seven inches (10 in. to 27 in.). In some aspects for an open fan engine (e.g., the turbofan engine 210 of FIG. 2), the thrust bearing radius R_{T}B is in a range from twelve inches to twenty-seven inches (12 in. to 27 in.). In some aspects for an open fan engine, the thrust bearing radius R_{T}B is in a range from nineteen inches to twenty-seven inches (19 in. to 27 in).

The FAS envelope and the FASL envelope are valid for a cruise Mach number M_{cruise} in a range from 0.7 to 0.92. In some example embodiments, the FAS envelope and the FASL envelope are valid for a cruise Mach number M_{cruise} in a range from 0.7 to 0.9. As mentioned above, turbofan engines operate at higher cruise speeds than turboprop engines. At higher cruise speeds, the aerodynamic loads on fan blades increase, thereby requiring more torque for actuating blades in pitch. This means a larger actuation system is needed to handle the higher reaction loads resulting when a torque is applied in flight to change the blade pitch, to move the blade to a feathered position, or coarse/fine pitch changes. The cruise Mach number M_{cruise} reflects this higher loading environment when pitching fan blades. In some example embodiments, the cruise Mach number M_{cruise} in a range from 0.75 to 0.9. In some example embodiments, the cruise Mach number M_{cruise} is in a range from 0.8 to 0.88.

The FAS envelope and the FASL envelope are only valid for a fan hub axial length A_{FH} of twenty-five inches to eighty-five inches (25 in. to 85 in.). In some example embodiments, the FAS envelope and the FASL envelope are only valid for a fan hub axial length A_{FH} of twenty-five inches to seventy-five inches (25 in. to 75 in.). In some example embodiments, the FAS envelope and the FASL envelope are only valid for a fan hub axial length A_{FH} of forty inches to eighty-five inches (40 in. to 85 in.). The fan hub axial length A_{FH} defines the amount of axial space, or the volume available for the fan actuation system, forward of the pitch axis P of the fan blades 140. Increasing the fan hub axial length A_{FH} provides more space for the fan actuation system but increases the overall weight of the turbofan engine. Decreasing the fan hub axial length A_{FH} reduces the fan performance and the pressure distribution to the fan due to a smaller axial length for the aerodynamic flow lines into the fan hub but provides less axial space to fit the fan actuation system within the fan hub 148. The fan hub axial length A_{FH} reflects the need for aerodynamic performance for the fan and adequately accommodating the axial length needed for packaging the fan actuation system but without overly sacrificing aerodynamic performance of the turbofan engine and allowing for a more efficient fan actuation system. In embodiments for a ducted engine (e.g., the turbofan engine 110 of FIG. 1), the fan hub axial length A_{FH} is in a range from twenty-five inches to forty inches (25 in. to 40 in.). In some aspects for an open fan engine (e.g., the turbofan engine 210 of FIG. 2), the fan hub axial length A_{FH} is in a range from twenty-five inches to seventy-five inches (25 in. to 75 in). In some aspects for an open fan engine (e.g., the turbofan engine 210 of FIG. 2), the fan hub axial length A_{FH} is in a range from forty inches to eighty-five inches (40 in. to 85 in). In this way, the fan hub axial length AFH is greater for open fan engines as compared to ducted fan engines as more space is needed due to the longer fan blades of the open fan engines as compared to the ducted engines.

The FAS envelope and the FASL envelope are only valid for a fan bearing axial length A_{FB} of ten inches to twenty-three inches (10 in. to 23 in.). In some example embodiments, the FAS envelope and the FASL envelope are only valid for a fan bearing axial length A_{FB} of sixteen inches to twenty-three inches (16 in. to 23 in.). The fan bearing axial length A_{FB} defines the amount of axial space, or the volume available for the fan actuation system, aft of the pitch axis P of the fan blades 140. Increasing the fan bearing axial length A_{FB} provides more space for the fan actuation system but increases the overall weight of the engine and increases loads on the bearings. Decreasing the fan bearing axial length A_{FB} decreases overall engine weight and reduces loads on the bearings but provides less axial space to fit the fan actuation system within the fan hub 148. The fan bearing axial length A_{FB} reflects the need for adequately accommodating the axial length needed for packaging the fan actuation system while minimizing the fan bearing axial length AFB to reduce loads on the bearings and reduce overall weight of the engine. In embodiments for a ducted engine (e.g., the turbofan engine 110 of FIG. 1), the fan hub axial length A_{F}H is in a range from seventeen inches to twenty inches (17 in. to 20 in.). In embodiments for an open fan engine (e.g., the turbofan engine 210 of FIG. 2), the fan hub axial length A_{F}H is in a range from ten inches to twenty-three inches (10 in. to 23 in). In some aspects for an open fan engine (e.g., the turbofan engine 210 of FIG. 2), the fan hub axial length A_{F}H is in a range from sixteen inches to twenty-three inches (16 in. to 23 in).

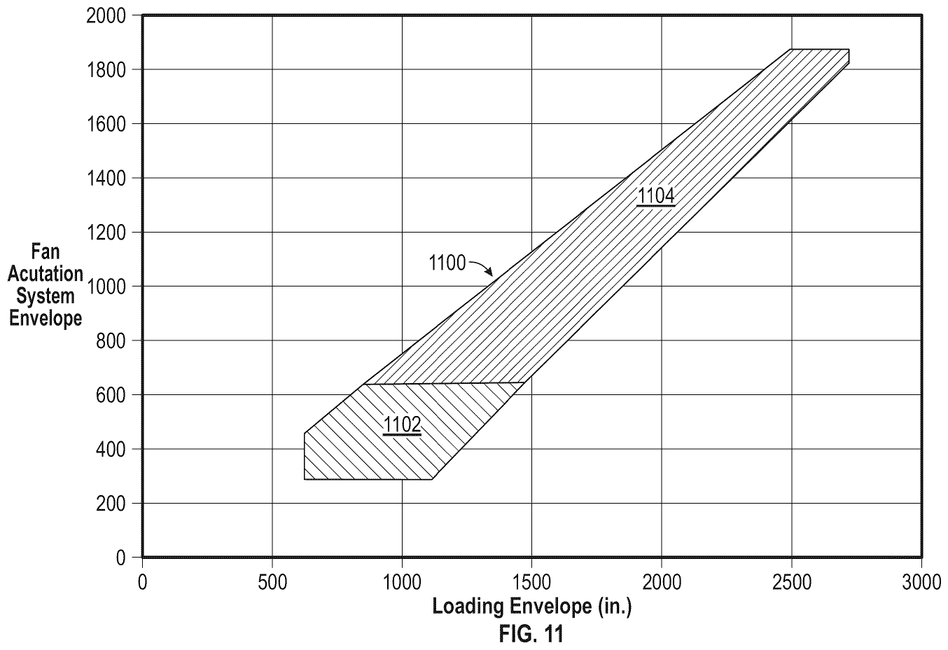

FIG. 11 represents, in graph form, the FAS envelope as a function of the loading envelope (N_{FB}×D_{FT}×M_{cruise}). An area 1100 represents the boundaries of the FAS envelope. The FAS envelope is in a range from three hundred to one thousand eight hundred sixty (300 to 1860) for a loading envelope in a range from five hundred eighty-eight inches to two thousand seven hundred twenty-two inches (588 in. to 2722 in.). Table 1 and FIG. 11 show that the FAS envelope increases as the loading envelope increases. In this way, the FAS envelope increases as the number of fan blades N_{FB}, the fan tip diameter D_{FT}, or the cruise Mach number M_{cruise} increase. The range of the FAS envelope identifies the specific architectures that can accommodate the fan pitch actuation system, accounting for both the mechanisms and structural load paths needed to pitch the fan blades under an aerodynamic loading, but without exceeding the volume available for packaging the pitch actuation system within the limited space of a turbofan engine.

A first area 1102 represents the boundaries of the FAS envelope for ducted engines, such as, for example, the turbofan engine 110 of FIG. 1. A second area 1104 represents the boundaries of the FAS envelope for unducted fan engines, such as, for example, the turbofan engine 210 of FIG. 2. Ducted engines tend to have more limited space for the fan actuation system due to the presence of a fan casing, fan duct, or outer nacelle. On the other hand, the fan actuation system of ducted engines are expected to experience lower loads associated with supporting fan blades and pitching fan blades due to the fan blades having a smaller diameter compared to an open fan engine. The FAS envelope, represented by the first area 1102, is in a range from three hundred to six hundred sixty (300 to 660) for ducted engines. The FAS envelope, represented by the second area 1104, is in a range from six hundred sixty to one thousand eight hundred sixty (660 to 1860) and, preferably, in a range from six hundred sixty to one thousand twenty (660 to 1020) and includes open fan engines.

FIG. 12 represents, in graph form, the FAS envelope as a function of the spacing envelope (R_{TB}/N_{FB}). An area 1200 represents the boundaries of the FAS envelope. The FAS envelope is in a range from three hundred to one thousand eight hundred sixty (300 to 1860) for a spacing envelope in a range from one point three five inches to two point two five inches (1.35 in. to 2.25 in.). Table 1 and FIG. 12 show that the FAS envelope decreases as the spacing envelope increases. In this way, the FAS envelope decreases as the thrust bearing radius R_{TB} increases or the number of fan blades N_{FB} decreases. A first area 1202 represents the boundaries of the FAS envelope for ducted engines, and is in a range from three hundred to six hundred sixty (300 to 660) for ducted engines, as detailed above. A second area 1204 represents the boundaries of the FAS envelope for unducted fan engines, and is in a range from six hundred sixty to one thousand eight hundred sixty (660 to 1860) and, preferably, in a range from six hundred sixty to one thousand twenty (660 to 1020), as detailed above.

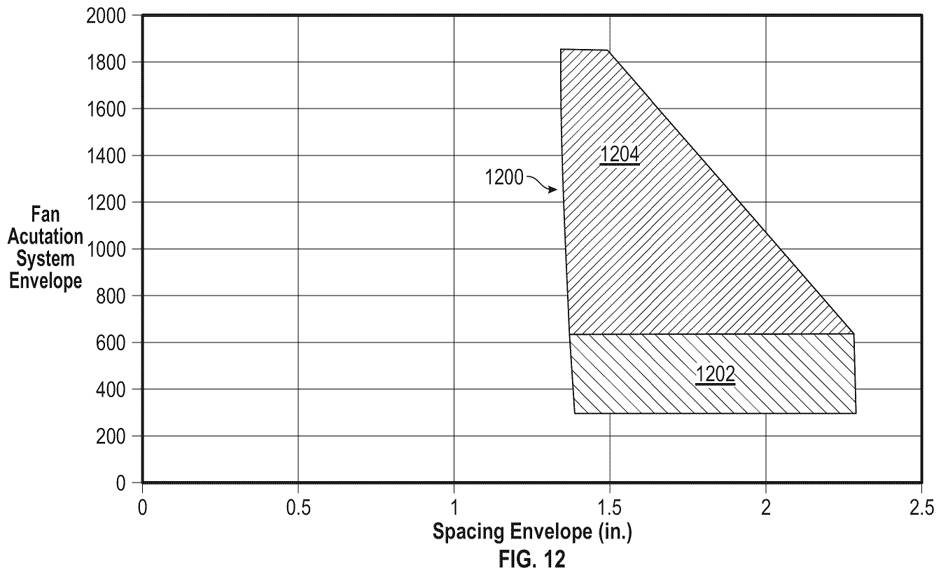

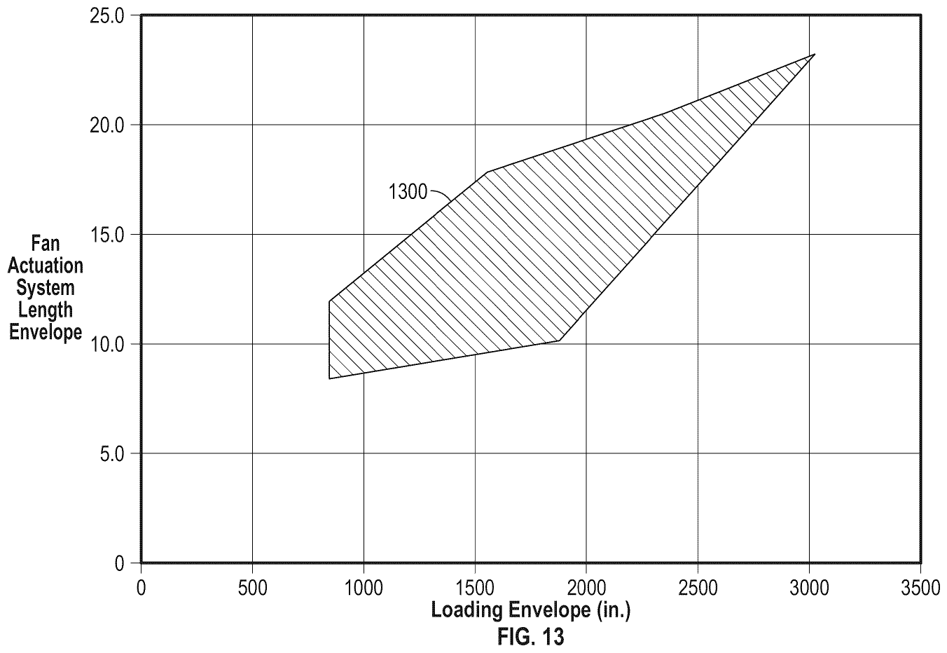

FIG. 13 represents, in graph form, the FASL envelope as a function of the loading envelope (N_{FB}×D_{FT}). An area 1300 represents the boundaries of the FASL envelope. The FASL envelope is in a range from eight point five to twenty-four (8.5 to 24) for a loading envelope in a range from eight hundred forty inches to three thousand twenty-four inches (840 in. to 3,024 in.). Table 1 and FIG. 13 show that the FASL envelope increases as the loading envelope increases. In this way, the FASL envelope increases as the number of fan blades N_{F}B or the fan tip diameter D_{FT} increase. The range of the FASL envelope identifies the specific architectures that can accommodate the fan pitch actuation system, accounting for both the mechanisms and structural load paths needed to pitch the fan blades under an aerodynamic loading, but without exceeding the volume available for packaging the pitch actuation system within the limited space of a turbofan engine. As mentioned above, ducted engines tend to have more limited space for the fan actuation system due to the presence of a fan casing, fan duct, or outer nacelle, while experiencing lower loads associated with supporting fan blades and pitching fan blades due to the fan blades having a smaller diameter compared to an open fan engine. For ducted engines, the FASL envelope is in a range from eight point five to thirteen (8.5 to 13).

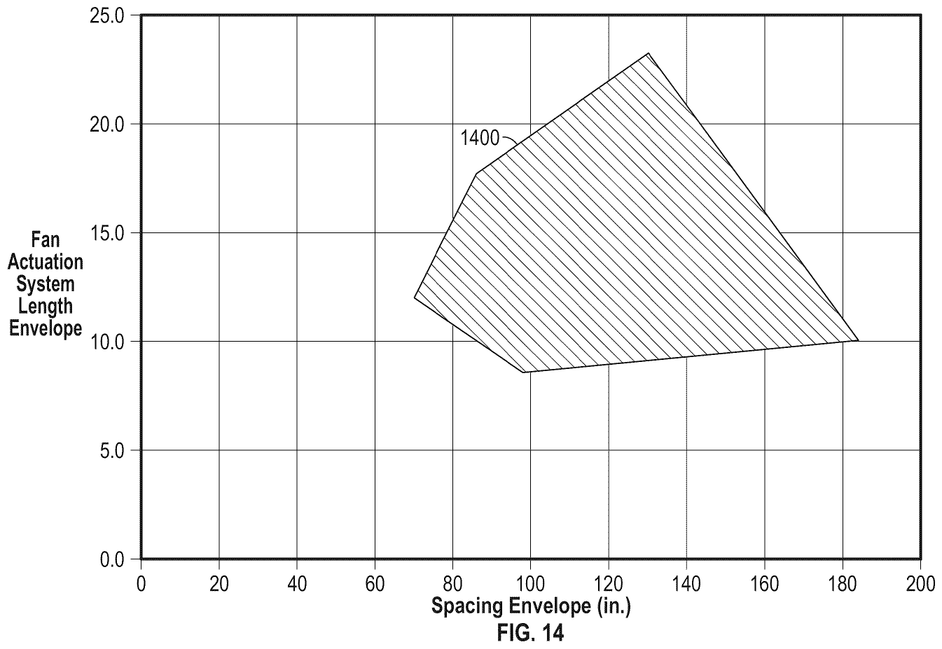

FIG. 14 represents, in graph form, the FASL envelope as a function of the spacing envelope L_{AXIAL}×(R_{TB}/N_{FB}). An area 1400 represents the boundaries of the FASL envelope. The FASL envelope is in a range from eight point five to twenty-four (8.5 to 24) for a spacing envelope in a range from seventy square inches to one hundred eighty-five square inches (70 in.² to 185 in.²). Table 1 and FIG. 14 show that the FASL envelope decreases as the spacing envelope increases. In this way, the FASL envelope decreases as the thrust bearing radius R_{T}B increases, or the number of fan blades N_{FB} or the axial length L_{AXIAL} decreases. As mentioned above, for ducted engines, the FASL envelope is in a range from eight point five to thirteen (8.5 to 13).

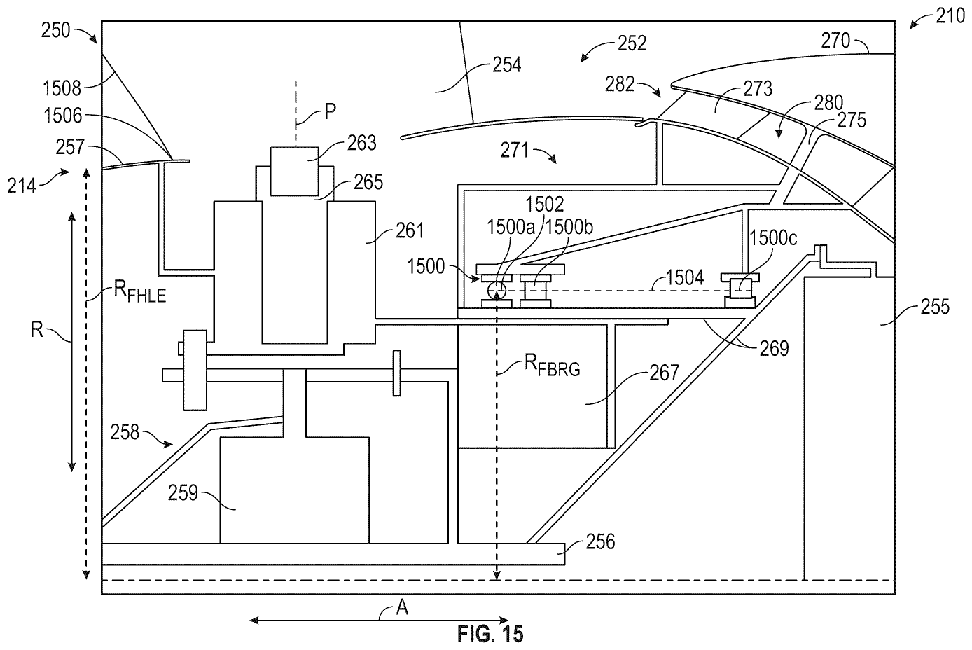

The FAS envelope and the FASL envelope herein provide a fan actuation system a low fan hub radius ratio (a ratio of the hub radius of the blades to the tip radius of the blades of the fan) and a high fan blade count. In one example, a low hub fan radius ratio is in a range from 0.22 to 0.30. This allows the fan diameter to be minimized to meet competing efficiency and installation requirements. To further enable a low fan hub radius ratio, the turbofan engine can include a relatively high fan bearing radius relative to the fan hub radius, as detailed further below with respect to FIGS. 15 to 20. Such a high fan bearing radius allows for a desired packaging of, e.g., the fan actuation system and the fan counterweights. The increased fan bearing radius allows the fan bearings to carry the forward thrust load of the turbofan engine while minimizing, e.g., any moments on the fan bearings in the event of a variation in a distribution of the forward thrust load on the fan bearings. In this way, the high fan bearing radius allows for a variable pitch fan (e.g., the inclusion of a fan actuation system) while maintaining a low fan hub radius ratio and a smaller outer casing, which provides for less drag and a larger frontal area for a given fan blade size.

FIG. 15 is a schematic view of the forward end 214 of the fan assembly 250 of the turbofan engine 210 of FIG. 2. As depicted in FIG. 15, each fan blade 254 defines a base 263 at an inner end along a radial direction R. Each fan blade 254 is coupled at the base 263 to a disk 261 via a trunnion mechanism 265. In FIG. 15, the base 263 is configured as a dovetail received within a correspondingly shaped dovetail slot of the trunnion mechanism 265. In other exemplary embodiments, the base 263 may be attached to the trunnion mechanism 265 in any other suitable manner. For example, the base 263 may be attached to the trunnion mechanism 265 using a pinned connection, or any other suitable connection. In still other exemplary embodiments, the base 263 may be formed integrally with the trunnion mechanism 265. Notably, the trunnion mechanism 265 facilitates rotation of a respective fan blade 254 about the pitch axis P of the respective fan blades 254. The fan assembly 250 can also include one or more fan counterweights 267 to balance the fan 252 during operation. Further, the disk 261 is attached to the gearbox assembly 255 through the fan shaft 256, which includes one or more individual structural members 269.

The fan assembly 250 includes a fan frame 271 that is connected to the fan cowl 270 through an inlet vane 273 and a strut 275. In this way, the fan frame 271 is a static or a stationary component that supports static components of the fan assembly 250. While the fan frame 271 is depicted as being connected to the fan cowl 270 through both the inlet vane 273 and the strut 275, the fan frame 271 can be connected to the fan cowl 270 through at least one of the inlet vane 273 or the strut 275.

The fan assembly 250 also includes one or more fan bearings 1500 for supporting rotation of the various rotating components of the fan assembly 250, such as the plurality of fan blades 254 via the fan shaft 256 and the disk 261. More particularly, the various rotating components of the fan assembly 250 rotate with respect to the fan frame 271 via the one or more fan bearings 1500. In FIG. 15, the one or more fan bearings 1500 includes a first fan bearing 1500a, a second fan bearing 1500b, and a third fan bearing 1500c. The first fan bearing 1500a is a ball bearing, the second fan bearing 1500b is a roller bearing, and the third fan bearing 1500c is a roller bearing. The first fan bearing 1500a is positioned forward of the second fan bearing 1500b and the third fan bearing 1500c. The fan bearings 1500 can include any other suitable number or type of bearings for supporting rotation of the plurality of fan blades 254. For example, the one or more fan bearings 1500 can include a pair (two) tapered roller bearings, or any other suitable bearings.

Referring still to FIG. 15, the one or more fan bearings 1500 are located axially aft of the disk 261 and the trunnion mechanisms 265 and radially outward of the one or more actuators 259 along the radial direction R and also outward of the one or more fan counterweights 267 along the radial direction R. In particular, the fan bearings 1500 are located axially between the disk 261 and the gearbox assembly 255. Such a configuration of the fan bearings 1500 allows for the actuators 259 to be axially aligned with the disk 261 and the trunnion mechanisms 265 along the axial direction A and radially inward of the disk 261 and the trunnion mechanisms 265 along the radial direction R. Moreover, such a configuration allows for the one or more fan counterweights 267 to be positioned adjacent to the one or more actuators 259.

As shown in FIG. 15, the one or more fan bearings 1500 define a fan bearing radius R_{FBRG} along the radial direction R. The fan bearing radius R_{FBRG} is defined as a distance along the radial direction R from the longitudinal centerline axis 212 of the turbofan engine 210 to a central axis or a center point of the one or more fan bearings 1500. More particularly, each of the first fan bearing 1500a, the second fan bearing 1500b, and the third fan bearing 1500c are radially aligned such that a center point 1502 of the first fan bearing 1500a and a central axis 1504 of the second fan bearing 1500b and the third fan bearing 1500c are each positioned at the same radial distance from the longitudinal centerline axis 212. In some example embodiments, one or more of the fan bearings 1500 may be stepped or otherwise positioned at different distances from the longitudinal centerline axis 212 along the radial direction R. In such aspects, the fan bearing radius R_{FBRG} refers to a radius of the innermost fan bearing 1500 along the radial direction R (i.e., a distance of the central point 1502 or the center axis 1504 of the innermost fan bearing 1500 along the radial direction R to the longitudinal centerline axis 212).

The fan hub 257 defines a fan hub leading edge radius R_{FHLE} along the radial direction R. The fan hub leading edge radius R_{FHLE} is defined as a radial distance of an outermost point of the fan hub 257 along the radial direction R to the longitudinal centerline axis 212 of the turbofan engine 210. In particular, the fan hub leading edge radius R_{FHLE} is a distance along the radial direction R from the longitudinal centerline axis 212 to a radially innermost point 1506 of a leading edge 1508 of the fan blades 254 (to the fan root 251 at the leading edge 1508. The fan hub leading edge radius R_{FHLE} is indicative of an overall size of a core portion of the fan assembly 250. Accordingly, the fan assembly 250 defines a fan bearing radius ratio R_{FHLE}:R_{FBRG} (i.e., a ratio of the fan hub leading edge radius R_{FHLE} to the fan bearing radius R_{FBRG}) in a range from 1.0 to 2.75. In some example embodiments, the fan bearing radius ratio is less than or equal to 2.75, such as less than or equal to 2.5, such as less than or equal to 2.0, such as less than or equal to 1.75. More particularly, the hub radius to fan bearing radius ratio R_{FHLE}:R_{FBRG} is greater than or equal to 1.0 and less than or equal to 1.5.

The plurality of fan blades 254 are rotatable about the axial direction A at a maximum rotational speed during operation of the fan assembly 250. The maximum rotational speed refers to a maximum speed at which the fan blades 254 are configured to rotate during a full power condition of the turbofan engine 210, such as when the turbofan engine 210 is generating a maximum takeoff thrust. The one or more fan bearings 1500 supporting rotation of the plurality of fan blades 254 may define a DN value during operation of the fan assembly 250 and rotation of the plurality of fan blades 254 at the maximum rotational speed of at least about 0.6 million. For example, in certain exemplary embodiments, the one or more fan bearings 1500 supporting rotation of the plurality of fan blades 254 may define a DN value during rotation of the plurality of fan blades 254 of at least 0.7 million, at least 0.8 million, at least 1 million, or at least 1.5 million. As used herein, the term “DN value” refers to a fan bearing speed quantifier calculated by multiplying a bore of the bearing in millimeters by a rotational speed in revolutions per minute (RPM). The bore of the one or more fan bearings 1500 supporting rotation of the plurality of fan blades 254 of the fan assembly 250 refers to a distance from the longitudinal centerline axis 112 to an inner race of the one or more fan bearings 1500.

Accordingly, in order to maintain the DN value of the one or more fan bearings 1500 below one or more of the above stated DN values, the fan assembly 250 may define a relatively low maximum rotational speed during operation. For example, in certain exemplary embodiments, the fan assembly 250 may define a maximum rotational speed in a range from 300 RPM to 8,500 RPM during operation. In some example embodiments, the maximum rotational speed is less than 8,500 RPM during operation. More specifically, in certain exemplary embodiments, the fan assembly 250 may define a maximum rotational speed of less than 8,000 RPM during operation, less than 7,500 rpm during operation, less than 7,000 RPM during operation, less than 6,500 rpm during operation, or less than 6,000 RPM during operation. In some example embodiments, the maximum rotational speed is in a range from 300 RPM to 1,100 RPM during operation.

As discussed above, inclusion of a relatively high fan bearing radius relative to a fan hub radius may allow for a desired packaging of, e.g., the fan actuation system and one or more fan counterweights in the fan assembly of the turbofan engine. Moreover, when the turbofan engine is an indirect drive turbofan engine (e.g., including a gearbox connecting a driveshaft and a fan shaft while reducing a rotational speed of the fan shaft relative to the driveshaft) the increased fan bearing radius may additionally provide for a more stable fan during operation. Specifically, with direct drive turbofan engine (e.g., without a gearbox), a forward thrust load generated by the fan during operation may be counteracted by a reverse thrust load generated by the turbine section of the turbofan engine (the turbine section being directly connected to the fan via a shaft in such a configuration). By contrast, within an indirect drive turbofan engine, such as the turbofan engine 110 depicted in FIG. 1 and the turbofan engine 210 in FIG. 2, the forward ball bearing (e.g., the first fan bearing 1500a) is required to carry substantially all of an amount of forward thrust generated by the fan during operation, as the gearbox assembly prevents the LP shaft from offsetting such forward thrust load of the fan with a reverse thrust load of the turbine section. Accordingly, the increased fan bearing radius allows the one or more fan bearings to carry the forward thrust load while minimizing, e.g., any moments on such one or more fan bearings in the event of a variation in a distribution of the forward thrust load on the one or more fan bearings.

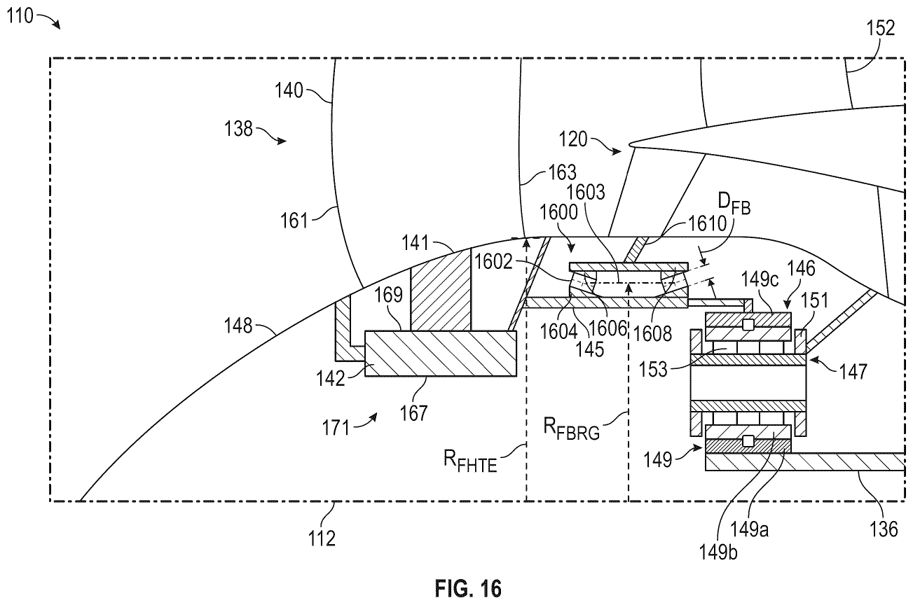

FIG. 16 is an enlarged, schematic, cross-sectional diagram of the turbofan engine 110 of FIG. 1 and having one or more fan bearings 1600, taken along the longitudinal centerline axis 112, according to the present disclosure. While FIG. 16 shows the turbofan engine 110 of FIG. 1, the fan bearings 1600 can also be implemented in the turbofan engine 210 of FIG. 2. FIG. 16 shows one fan blade 140 of the fan 138, the fan disk 142, the core inlet 120, and the gearbox assembly 146. Further, although not shown for clarity, the turbofan engine 110 can include any of the fan actuation systems disclosed herein.

The fan shaft 145 is coupled to the fan disk 142 such that rotation of the fan shaft 145 causes the plurality of fan blades 140 to rotate about the longitudinal centerline axis 112. Each of the fan blades 140 extends from a leading edge 161 and a trailing edge 163. The fan root 141 is at the fan hub 148. The fan disk 142 is defined between an inner surface 167 and an outer surface 169. The inner surface 167 is a radially-most inner surface of the fan disk 142 and the outer surface 169 is a radially-most outer surface of the fan disk 142. The fan disk 142 includes a disk bore 171 defined by the inner surface 167 of the fan disk 142. In particular, the disk bore 171 is defined from the longitudinal centerline axis 112 to the inner surface 167. The fan hub 148 includes a fan hub trailing edge radius R_{FHTE} that is defined in the radial direction from the longitudinal centerline axis 112 to the fan hub 148 at the trailing edge 163 of the fan blades 140.

The turbofan engine 110 also has a fan hub radius ratio that is defined as a ratio of the fan hub trailing edge radius R_{FHTE} to a fan tip radius of the fan blades 140 (e.g., the radius from the longitudinal centerline axis 112 to the fan tip 143 at the trailing edge 163 of the fan blades 140). The fan hub radius ratio is in a range from 0.1 to 0.4. Lower fan hub radius ratios result in lower core engine inlets. A lower fan hub radius and a lower core engine inlet radius result in a core engine with a lesser diameter (e.g., smaller core engine), and, thus, a reduced overall engine weight, as compared to turbofan engines with fan hub radius ratios greater than 0.4. In some example embodiments, the fan hub radius ratio is in a range from 0.15 to 0.32. In some example embodiments, the fan hub radius ratio is in a range from 0.2 to 0.35. In some example embodiments, the fan hub radius ratio is in a range from 0.2 to 0.3. The lower fan hub can also reduce the probability of foreign object damage (FOD), such as, for example, from bird strikes, in the core engine, as the fan tends to push the foreign objects radially outward by the centripetal force imparted to the foreign object by the spinning fan blades. A lower fan hub also improves aerodynamic efficiency of the fan. The lower fan hub radius ratios disclosed herein are enabled by the fan actuation system being characterized by the FASL as detailed above. In particular, the FASL enables a smaller fan actuation system to fit within a tighter packaging underneath the fan while ensuring the fan actuation system can provide an adequate force or torque to pitch the fan blades in the higher loading environment of a turbofan engine (as compared to a turboprop engine). In this way, if the fan actuation system has a FASL that falls within the ranges detailed above, the fan hub radius ratio can be made lower to achieve the improved aerodynamic efficiency of the fan in guiding the incoming airflow into the core inlet.

The fan bearings 1600 are radial thrust (radial shaft load) bearings that transmit a load (e.g., the radial shaft load) from the fan shaft 145 to a static structure of the turbofan engine 110. The fan bearings 1600 each includes one or more rolling elements 1602, an inner race 1604, and an outer race 1606. The fan bearings 1600 support rotation of the fan shaft 145. In FIG. 16, fan bearings 1600 include a forward fan bearing and an aft fan bearing. The rolling elements 1602 are tapered rolling elements that include tapered cylindrical bodies and are disposed between the inner race 1604 and the outer race 1606. In this way, the one or more fan bearings 1600 are roller bearings. The outer race 1606 of each of the fan bearings 1600 is connected to a fan bearing support member 1608. The fan bearing support member 1608 is connected to a fan bearing housing 1610 that is connected to a static component of the turbofan engine 110. The inner race 1604 is connected to the fan shaft 145. In this way, the fan bearings 1600 are connected to the static component and to the fan shaft 145 such that the inner race 1604, and the rolling elements 1602, rotates with respect to the outer race 1606, such that the fan bearings 1600 support rotation of the fan shaft 145.

The fan bearings 1600 are positioned aft, and radially outward, of the fan disk 142. In particular, the fan bearings 1600 are positioned entirely axially aft of the fan disk 142 and entirely radially outward of the fan disk 142 (e.g., radially outward of the outer surface 169 of the fan disk 142). In this way, the fan bearings 1600 are positioned radially outward of the disk bore 171 (e.g., of the inner surface 167) of the fan disk 142. The fan bearings 1600 are positioned axially between the fan disk 142 and the gearbox assembly 146. Further, the fan bearings 1600 are positioned radially outward of the gearbox assembly 146, particularly, radially outward of the third gear 149c.

The fan bearings 1600 have a fan bearing radius R_{FBRG} that is defined in the radial direction from the longitudinal centerline axis 112 to a radial center 1603 of the fan bearings 1600. Particularly, the radial center 1603 of the fan bearings 1600 is the radial center 1603 of the rolling elements 1602. The fan bearings 1600 also have a rolling element diameter D_{F}B of the rolling elements 1602 that is defined as a distance of a straight line passing from side to side of a respective rolling element 1602 through a center (e.g., the radial center 1603) of the respective rolling element 1602.

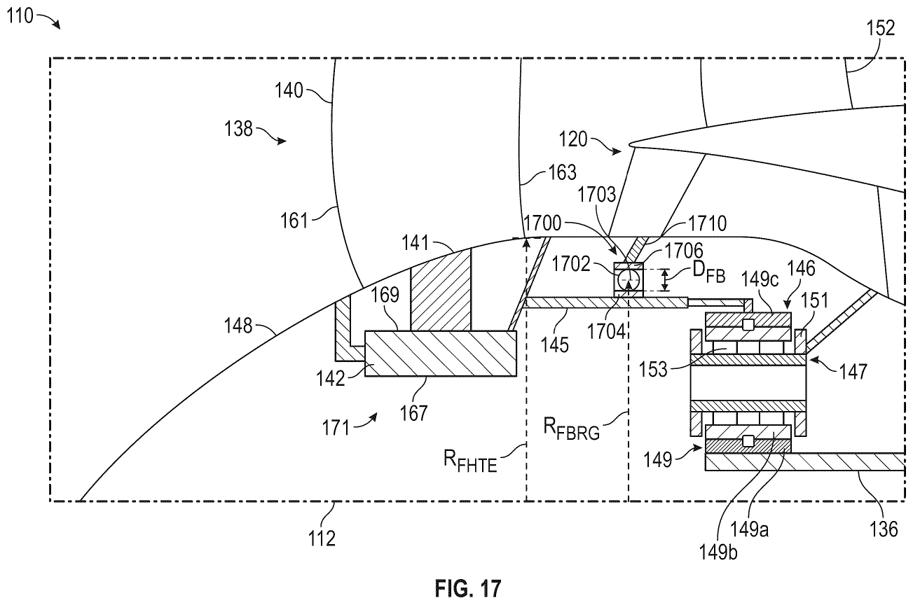

FIG. 17 is an enlarged, schematic, cross-sectional diagram of the turbofan engine 110 and having one or more fan bearings 1700, taken along the longitudinal centerline axis 112, according to another aspect. The fan bearings 1700 are substantially similar to the fan bearings 1600 of FIG. 16. The same reference numerals will be used for components of the fan bearings 1700 that are the same as or similar to the components of the fan bearings 1600 discussed above. The description of these components above also applies to this embodiment, and a detailed description of these components is omitted here.

The fan bearings 1700 each includes one or more rolling elements 1702, an inner race 1704, and an outer race 1706. The fan bearings 1700 support rotation of the fan shaft 145. The rolling elements 1702 are balls that are disposed between the inner race 1704 and the outer race 1706. In this way, the fan bearings 1700 are ball bearings. The turbofan engine 110 also includes a fan bearing housing 1710.

The fan bearings 1700 are positioned aft, and radially outward, of the fan disk 142. In particular, the fan bearings 1700 are positioned entirely axially aft of the fan disk 142 and entirely radially outward of the fan disk 142 (e.g., radially outward of the outer surface 169 of the fan disk 142). In this way, the fan bearings 1700 are positioned radially outward of the disk bore 171 (e.g., of the inner surface 167) of the fan disk 142. The fan bearings 1700 are positioned axially between the fan disk 142 and the gearbox assembly 146. Further, the fan bearings 1700 are positioned radially outward of the gearbox assembly 146, particularly, radially outward of the third gear 149c.

The fan bearings 1700 have a fan bearing radius R_{FBRG} that is defined in the radial direction from the longitudinal centerline axis 112 to a radial center 1703 of the fan bearings 1700 (e.g., of the rolling elements 1702). The fan bearings 1700 also have a rolling element diameter D_{FB} of the rolling elements 1702 that is defined as a distance of a straight line passing from side to side of a respective rolling element 1702 through a center (e.g., the radial center 1703) of the respective rolling element 1702.

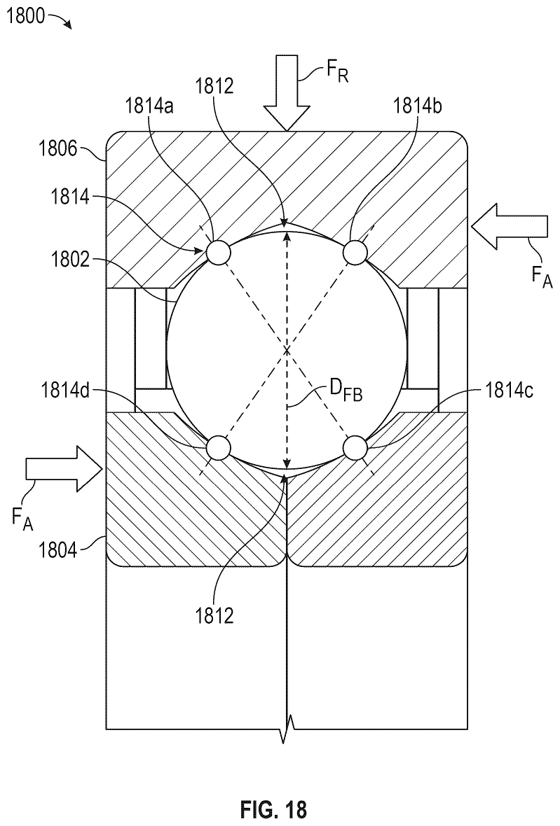

FIG. 18 is a schematic cross-sectional view of a fan bearing 1800 for the turbofan engine 110, according to another aspect. The fan bearing 1800 can be utilized as any of the fan bearings detailed herein. The fan bearing includes one or more rolling elements 1802, an inner race 1804, and an outer race 1806. In at least one example embodiment, the inner race 1804 has a split ring configuration to facilitate easier mounting of the bearing and improved precision. In at least one example embodiment, each of the inner race 1804 and the outer race 1806 defines a concavity having an arch 1812 to allow the rolling element 1802 to have four contact points 1814 with the inner race 1804 and the outer race 1806. In particular, the fan bearing 1800 has two contact points, including a first contact point 1814a and a second contact point 1814b, on the outer race 1806 and two contact points, including a third contact point 1814c and a fourth contact point 1814d, on the inner race 1804. In this way, the fan bearing 1800 is a four-point contact ball bearing. The four-point contact design allows the fan bearing 1800 to handle both radial loads F_{R} and axial loads F_{A} by transmitting the load between the second contact point 1814b and the fourth contact point 1814d, and between the first contact point 1814a and the third contact point 1814c.

In at least one example embodiment, the fan bearing 1800 has a tight bearing configuration, i.e., there is minimal clearance between the rolling elements 1802 and the inner race 1804 and the outer race 1806. In particular, the clearance between the rolling elements 1802 and the inner race 1804 and the outer race 1806 is dimensioned to limit axial movement of the fan shaft 145 (FIG. 1) in relation to the gearbox assembly 146 (FIG. 1) to no greater than 0.010 inches or 10 mil. In at least one example embodiment, the clearance between the rolling elements 1802 and the inner race 1804 and the outer race 1806 is dimensioned to limit axial movement of the fan shaft 145 to no greater than 0.007 inches or 7 mil. The fan bearing 1800 limits axial endplay, i.e., axial movement of the fan shaft 145 in relation to the gearbox assembly 146, thus protecting the gearbox assembly 146 from excessive stress and facilitating a reduction in size and extension of the life of the gearbox assembly 146.

The fan bearing 1800 is designed to withstand extreme conditions including high temperatures, high loads, and high rotational speeds. The materials used to construct the fan bearing 1800 are selected to maximize durability, temperature resistance, and fatigue life. In at least one example embodiment, the fan bearing 1800 can be formed from steel, steel alloys, ceramic materials, cobalt and nickel-based superalloys, or polytetrafluoroethylene (PTFE) and phenolic resins. In addition, the fan bearing 1800 may include coatings, such as, for example, titanium nitride or other anti-friction coatings to further reduce wear and to minimize friction.

The fan bearings of FIGS. 15 to 18 are designed to address the problem of sizing the fan bearings to account for the stresses encountered from the fan shaft, while balancing for minimizing the space under the fan for the fan bearings and other fan components, as well as providing a required amount of thrust for a particular size of the turbofan engine. Additionally, the fan bearings address the challenge in reducing the inner radius of the engine flow path and lowering the fan hub radius ratio, while increasing the fan bearing radius.

Moving the fan bearings aft of the fan disk and increasing the fan bearing radius provide for a reduction in the inner radius of the flow path and the fan hub radius, without overly increasing the heat load on the fan bearings. Further, moving the fan bearings radially outward enables a greater number of rolling elements, which results in a reduced rolling element diameter.

The set of novel embodiments detailed herein include several different architectures of fan bearings and turbofan engines with various sizes and locations. A set of fan bearing designs, producing favorable results, can be characterized by a combination of the fan hub trailing edge radius, the fan bearing radius, the rolling element diameter, and the takeoff thrust, capable of differentiating an architecture that satisfies the operational requirements (e.g., fan bearings capable of handling the stresses from the fan shaft) and the packaging requirements (e.g., lowering the fan hub radius and the inner radius of the flow path) from an architecture that does not satisfy these requirements. As such, a finite and readily ascertainable number of embodiments of the fan bearings account for the operational requirements and the packaging requirements without overly increasing the fan bearing heat load. The novel designs are based on a size of the fan bearings, a size of the rolling elements, and a location of the fan bearings that can reduce the size and the weight of the turbofan engine, while accounting for the factors discussed above. These novel designs can be characterized as a fan bearing envelope (FBE), as set forth in expression (3):

$$FBE = ( \frac{{R}_{FBRG}}{{R}_{FHTE}} ) \times ( \frac{{D}_{FB}}{( \frac{{Thrust}_{TO}}{1000} )} ) . \qquad ( 3 )$$

In expression (3), R_{FBRG} is the fan bearing radius, R_{FHTE} is the fan hub trailing edge radius, D_{FB} is the rolling element diameter, and Thrust_{TO} is the takeoff thrust of the turbofan engine. The takeoff thrust Thrust_{TO} is a high power operation (e.g., greater than 85% of the SLS maximum engine rated thrust) of the turbofan engine during a takeoff condition of the aircraft.

As discussed further below, the fan bearings include fan bearing designs for different turbofan engine architectures that accounts for handling the stresses from the fan shaft during operation, while reducing the fan hub radius, and, thus, providing for an improved specific flow through the fan and reducing the fan diameter required to achieve a certain thrust or reduces the fan pressure ratio and improves propulsive efficiency of the fan. These improved fan bearing designs can be characterized according to a defined range for the FBE.

Table 2 below represents exemplary embodiments 16 to 27 and their corresponding FBE values for various turbofan engines and fan bearings. Embodiments 16 to 27 may represent the turbofan engine 110 of FIG. 1 (e.g., ducted engine) or the turbofan engine 210 of FIG. 2 (e.g., unducted fan engine) and can be applied to any of the fan bearings detailed herein. In Table 2, the FBE values were determined based on expression (3) described above, and using fan hub trailing edge radius, fan bearing radius, fan bearing diameter values in millimeters and takeoff thrust values in kilo-Newtons. In particular, embodiments 16, 17, 22, 24, and 26 are tapered roller bearings (e.g., the fan bearings 1600 of FIG. 16). Embodiments 18 to 21, 23, 25, and 27 are ball bearings (e.g., the fan bearings 1700 of FIG. 17 or the fan bearing 1800 of FIG. 18).

TABLE 2

| | | | | | | Fan Bearing |
|---|---|---|---|---|---|---|
| | R_{FHTE} | R_{FBRG} | R_{FBRG}/ | D_{FB} | Thrust_{TO} | Envelope |
| Emb. | (mm) | (mm) | R_{FHTE} | (mm) | (kN) | (FBE) |
| 16 | 360.934 | 212.09 | 0.588 | 19.05 | 155.688 | 71.901 |
| 17 | 628.396 | 312.42 | 0.497 | 19.05 | 155.688 | 60.834 |
| 18 | 360.934 | 212.09 | 0.588 | 50.80 | 155.688 | 191.735 |
| 19 | 628.396 | 312.42 | 0.497 | 50.80 | 155.688 | 162.224 |
| 20 | 360.934 | 212.09 | 0.588 | 57.15 | 155.688 | 215.702 |
| 21 | 360.934 | 212.09 | 0.588 | 63.50 | 155.688 | 239.669 |
| 22 | 103.124 | 60.60 | 0.588 | 5.00 | 44.482 | 66.050 |
| 23 | 103.124 | 60.60 | 0.588 | 15.00 | 44.482 | 198.151 |
| 24 | 902.335 | 530.23 | 0.588 | 50.80 | 389.220 | 76.694 |
| 25 | 902.335 | 530.23 | 0.588 | 127.00 | 389.220 | 191.735 |
| 26 | 1191.082 | 699.90 | 0.588 | 63.50 | 513.770 | 72.627 |
| 27 | 1191.082 | 699.90 | 0.588 | 170.00 | 513.770 | 194.434 |

The fan bearing designs provide the aforementioned benefits including achieving a lower radius ratio (ratio of hub to fan tip radii) for a rated thrust, or a percentage thereof at takeoff. During the course of creating those designs it was determined what ranges would be suitable to achieve the desired results, while taking into account fan shaft stresses, packaging and accessibility, reliability, and lubrication requirements for the engine. The values for terms used to compute an FBE value are strictly limited to certain ranges based on the various designs evaluated where those values had varied. Otherwise, the engine made will not produce the favorable results.

The FBE is only valid for a fan hub trailing edge radius R_{FHTE} in a range from ninety millimeters (90 mm) to one thousand two hundred millimeters (1,200 mm). In at least one example embodiment, the fan hub trailing edge radius R_{FHTE} is in a range from one hundred millimeters (100 mm) to nine hundred millimeters (900 mm). The ranges of the fan hub trailing edge radius R_{FHTE} provide for a fan hub radius ratio that satisfies the operational requirements and the packaging requirements of a particular engine without overly increasing the fan bearing heat load. Values of the fan hub trailing edge radius R_{FHTE} outside of the ranges disclosed herein either have a fan hub radius ratio that is too small such that the fan bearings cannot be packaged under the fan disk or too great such that the aerodynamic efficiency of the fan is reduced.

The FBE is only valid for a fan bearing radius R_{FBRG} in a range from fifty millimeters (50 mm) to seven hundred millimeters (700 mm). In at least one example embodiment, the fan bearing radius R_{FBRG} is in a range from sixty millimeters (60 mm) to five hundred fifty millimeters (550 mm). The ranges of the fan bearing radius R_{FBRG} provide for a lower fan hub radius ratio that satisfies the operational requirements and the packaging requirements of a particular engine without overly increasing the fan bearing heat load. Values of the fan bearing radius R_{FBRG} outside of the ranges disclosed herein either have a fan hub radius ratio that is too small such that the fan bearings cannot be packaged under the fan disk or too great such that the aerodynamic efficiency of the fan is reduced and the heat load on the fan bearings is increased so much that the fan bearings require a great amount of lubricant to cool the fan bearings. Thus, fan bearings having a fan bearing radius R_{FBRG} greater than seven hundred millimeters (700 mm) also result in a greater sized lubrication system, and, thus, results in a heavier turbofan engine.

The FBE is only valid for a radius ratio of the fan bearing radius to the fan hub trailing edge radius (R_{FBRG}/R_{FHTE}) in a range from 0.4 to 1.0. The range of R_{FBRG}/R_{FHTE} provides satisfies the operational requirements and the packaging requirements of a particular engine without overly increasing the fan bearing heat load. Values of the R_{FBRG}/R_{FHTE} outside of the ranges disclosed herein either have a fan hub radius ratio that is too small such that the fan bearings cannot be packaged under the fan disk or too great such that the aerodynamic efficiency of the fan is reduced. In particular, values of R_{FBRG}/R_{FHTE} greater than 1.0 provide for the fan bearings to be radially outward of the fan hub trailing edge, and, thus, reduce the radius of the core engine inlet. Values of R_{FBRG}/R_{FHTE} less than 0.4 provide for fan bearings that require larger rolling elements to account for the stresses, while also increasing the fan hub radius and the inner radius of the flow path.

The FBE is only valid for a rolling element diameter D_{F}B in a range from three millimeters (3 mm) to one hundred fifty millimeters (150 mm). In at least one example embodiment, the rolling element diameter D_{F}B is in a range from five millimeters (5 mm) to one hundred twenty-seven millimeters (127 mm).

The FBE is only valid for a takeoff thrust Thrust_{TO} in a range from forty kilo-Newtons (40 kN) to five hundred twenty-five kilo-Newtons (525 kN). In at least one example embodiment, the takeoff thrust Thrust_{TO} is in a range from forty-four kilo-Newtons (44 kN) to four hundred fifty kilo-Newtons (450 kN).

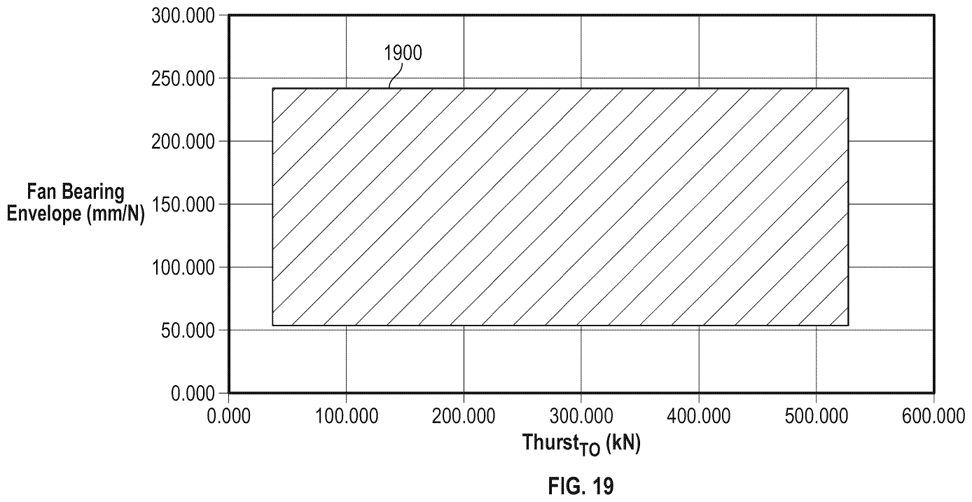

FIG. 19 represents, in graph form, the FBE as a function of the Thrust_{TO} of the turbofan engine, according to the present disclosure. An area 1900 represents the boundaries of the FBE. The FBE is in a range from fifty-four millimeters per Newton (54 mm/N) to two hundred forty millimeters per Newton (240 mm/N) for a takeoff thrust Thrust_{TO} in a range from forty kilo-Newtons (40 kN) to five hundred twenty-five kilo-Newtons (525 kN). The range of the FBE identifies the specific architectures (fan bearing sizing and location), rolling elements sizing, and takeoff thrusts, while accounting for the stresses from the fan shaft and the inner flow path radius and the fan hub radius. In particular, if the FBE is within the area 1900, then the fan bearing and the turbofan engine architecture are capable of handling the stresses from the fan shaft during operation, while reducing the fan hub radius, and, thus, providing for an improved specific flow through the fan and reducing the fan diameter required to achieve a certain thrust, or reduces the fan pressure ratio and improves propulsive efficiency of the fan. If the FBE is outside of the area 1900, then the fan bearings may become damaged or fail under the stresses from the fan shaft, or the fan hub radius (e.g., the inner radius of the flow path) is too great, such that the fan efficiency decreases or the specific flow through the fan is reduced for a certain thrust. Thus, the turbofan engine having an FBE within the area 1900 provides for an improved fan bearing architecture that is capable of handling the stresses from the fan shaft, while accounting for the fan hub radius to improve propulsive efficiency and specific flow for achieving a certain thrust.

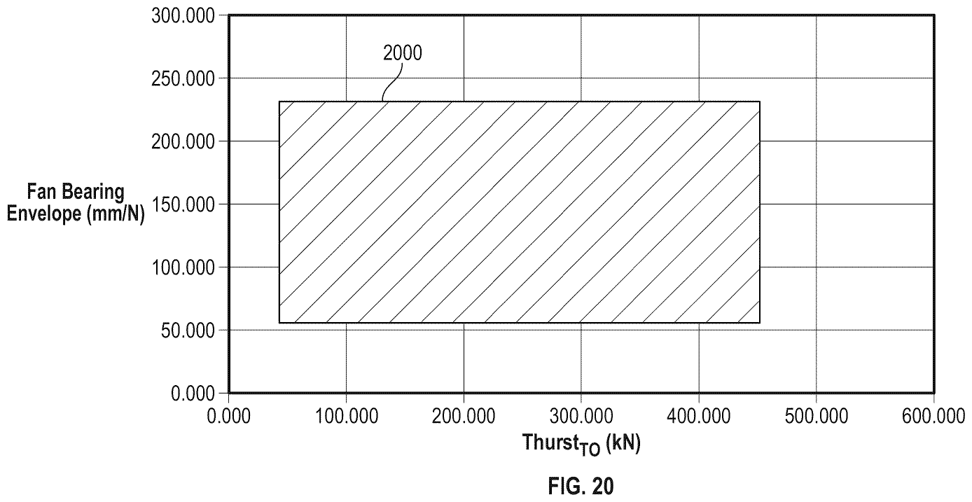

FIG. 20 represents, in graph form, the FBE as a function of the Thrust_{TO}, according to another aspect. An area 2000 represents the boundaries of the FBE. The FBE is in a range from fifty-eight millimeters per Newton (58 mm/N) to two hundred thirty millimeters per Newton (230 mm/N) for a takeoff thrust Thrust_{TO} in a range from forty-four kilo-Newtons (44 kN) to four hundred fifty kilo-Newtons (450 kN). The range of the FBE identifies the specific architectures (fan bearing sizing and location), rolling elements sizing, and takeoff thrusts, while accounting for the stresses from the fan shaft and the inner flow path radius and the fan hub radius. In particular, if the FBE is within the area 2000, then the fan bearing and the turbofan engine architecture are capable of handling the stresses from the fan shaft during operation, while reducing the fan hub radius, and, thus, providing for an improved specific flow through the fan and reducing the fan diameter required to achieve a certain thrust, or reduces the fan pressure ratio and improves propulsive efficiency of the fan. If the FBE is outside of the area 2000, then the fan bearings may become damaged or fail under the stresses from the fan shaft, or the fan hub radius (e.g., the inner radius of the flow path) is too great, such that the fan efficiency decreases or the specific flow through the fan is reduced for a certain thrust. Thus, the turbofan engine having an FBE within the area 2000 provides for an improved fan bearing architecture that is capable of handling the stresses from the fan shaft, while accounting for the fan hub radius to improve propulsive efficiency and specific flow for achieving a certain thrust.

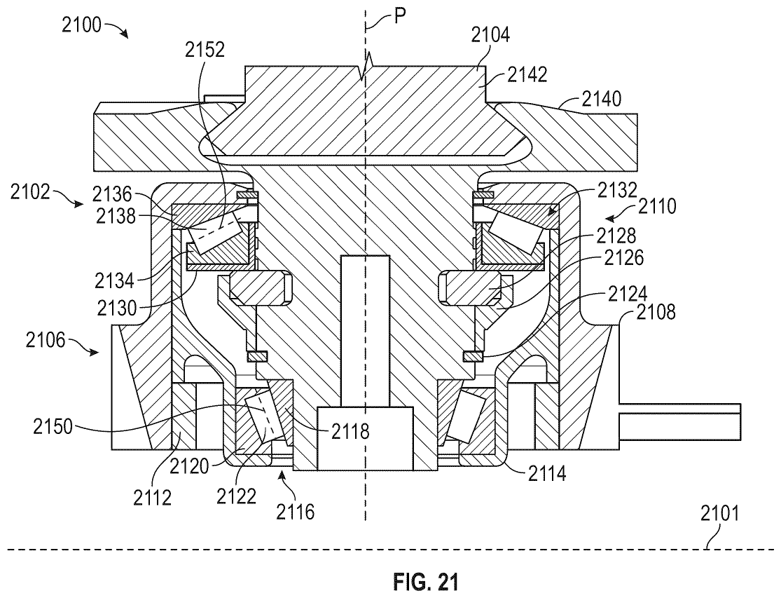

FIG. 21 is an enlarged schematic, cross-sectional view of a segment of a fan 2100 having a fan actuation system 2102, taken along a longitudinal centerline axis 2101 of the fan 2100, according to the present disclosure. The fan 2100 can be utilized as the fan 138 of FIG. 1 or as the fan 252 of FIG. 2. The fan 2100 includes a plurality of fan blades 254 that is coupled to a disk 2106 and is spaced circumferentially about the longitudinal centerline axis 2101 of the fan 2100.

The disk 2106 includes a plurality of disk segments 2108 (only one shown in FIG. 21) that is rigidly coupled together or integrally molded together in a generally annular shape. One fan blade 254 is coupled to each disk segment 2108 at a trunnion mechanism 2110 of the fan actuation system 2102. The trunnion mechanism 2110 facilitates retaining the respective fan blade 254 on the disk 2106 during rotation of the disk 2106, while still rendering the respective fan blade 254 rotatable relative to the disk 2106 about a pitch axis P of the fan blade 104. The trunnion mechanism 2110 includes a plurality of bearings disposed within the disk segment 2108 that allows the fan blade 254 to rotate about the pitch axis P, as detailed above and below.

The trunnion mechanism 2110 extends through a respective disk segment 2108 and includes a coupling nut 2112, a lower bearing support 2114, a first radial thrust bearing 2116 (having, for example, an inner race 2118, an outer race 2120, and a plurality of rolling elements 2122), a snap ring 2124, a key hoop retainer 2126, a segmented key 2128, a bearing support 2130, a second radial thrust bearing 2132 (having, for example, an inner race 2134, an outer race 2136, and a plurality of rolling elements 2138), a trunnion 2140, and a base 2142 (e.g., a dovetail). The first radial thrust bearing 2116 and the second radial thrust bearing 2132 can include any type of roller bearings, including, for example, cylindrical roller radial thrust bearings, tapered roller radial thrust bearings, spherical roller radial thrust bearings (e.g., ball bearings), needle roller radial thrust bearings, or tapered roller needle radial thrust bearings. The coupling nut 2112 is threadedly engaged with the disk segment 2108 so as to sandwich the remaining components of the trunnion mechanism 2110 between the coupling nut 2112 and the disk segment 2108, thus, retaining the trunnion mechanism 2110 attached to the disk segment 2108.

The first radial thrust bearing 2116 is oriented at a different angle than the second radial thrust bearing 2132 (as measured from a rolling element longitudinal centerline axis 2150 of the plurality of rolling elements 2122 relative to the pitch axis P, and from a rolling element longitudinal centerline axis 2152 of the plurality of rolling elements 2138 relative to the pitch axis P). More specifically, the first radial thrust bearing 2116 and the second radial thrust bearing 2132 are preloaded against one another in a face-to-face (or duplex) arrangement, in which the rolling element longitudinal centerline axes 2150, 2152 are oriented substantially perpendicular to one another, as opposed to being arranged in tandem so as to be oriented substantially parallel to one another.

The centrifugal loads experienced closer to the pitch axis P are larger than the centrifugal loads experienced further away from the pitch axis P. As such, to facilitate making the trunnion mechanism 2110 more compact, the bearings of the trunnion mechanism 2110 are positioned closer to the pitch axis P. Such a configuration enables a greater number of trunnion mechanisms 2110 to be assembled on the disk 2106 and, thus, more fan blades 254 to be coupled to the disk 2106 for a given diameter of the disk 2106. The trunnion mechanism 2110 herein is made more compact due to the first radial thrust bearing 2116 and the second radial thrust bearing 2132 being line contact bearings as compared to trunnion mechanisms that utilize angular point contact ball bearings. In this way, the trunnion mechanism 2110 is made more compact while being better able to withstand larger centrifugal loads associated with such a bearing placement without fracturing or plastically deforming. In particular, the first radial thrust bearing 2116 and the second radial thrust bearing 2132 being line contact bearings provide for larger contact surfaces, and, thus, can withstand larger centrifugal loads as compared to angular point contact ball bearings. Thus, line contact bearings (e.g., the first radial thrust bearing 2116 and the second radial thrust bearing 2132) can be spaced closer to the pitch axis P than angular point contact ball bearings.

In one aspect, the first radial thrust bearing 2116 and the second radial thrust bearing 2132 are a tapered roller bearings in which the rolling elements 2122 and the rolling elements 2138 are tapered. In one example, the first radial thrust bearing 2116 is fabricated from a steel material and has twenty rolling elements 2122 arranged at a 200 contact angle and a 3.6 inch pitch diameter, with each rolling element 2122 being 0.6 inches long and having a 0.525 inch minor diameter, a 0.585 inch major diameter, and a 6° taper angle. In the same example, the second radial thrust bearing 2132 is fabricated from a steel material and has 36 rolling elements 2138 arranged at a 650 contact angle and a 6 inch pitch diameter, with each rolling element 2138 being 0.8 inches long and having a 0.45 inch minor diameter, a 0.6 inch major diameter, and a 9° taper angle. In other exemplary embodiments, the first radial thrust bearing 2116 and the second radial thrust bearing 2132 can be configured in any suitable manner that facilitates enabling the first radial thrust bearing 2116 and the second radial thrust bearing 2132 to function as described herein.

The first radial thrust bearing 2116 and the second radial thrust bearing 2132 facilitate providing a turbofan engine with a smaller variable pitch fan that can generate larger amounts of thrust. Particularly, the first radial thrust bearing 2116 and the second radial thrust bearing 2132 facilitate providing a turbofan engine with a variable pitch fan having a higher blade count and a lower blade length, while also providing the turbofan engine with a lower fan hub radius ratio. The first radial thrust bearing 2116 and the second radial thrust bearing 2132 further facilitate providing a trunnion mechanism that is more compact and is better able to withstand the higher centrifugal loads associated with higher blade counts, given that higher blade counts tend to yield a higher tip velocity and, therefore, a higher centrifugal loading. The first radial thrust bearing 2116 and the second radial thrust bearing 2132 further facilitate providing a smaller diameter disk for a variable pitch fan by providing the variable pitch fan with a fan counterweight device for the fan blades.

In various exemplary aspects of the present disclosure, an open rotor aeronautical engine is provided, equipped with an excitation load control system. The excitation load control system includes one or more sensors configured to provide sensor data indicative of an excitation load acting upon the engine, a fan actuation assembly including one or more actuators actuatable to change a pitch angle of one or more airfoils of the engine, and an electronic controller. The electronic controller is configured to determine an airfoil pitch control command based at least in part on the excitation load, and output the command to the one or more actuators to augment or compensate for the excitation load.

In particular, the inventors of the present disclosure found that by incorporating the excitation load control system in the gas turbine engine, in combination with one or more of the embodiments described hereinabove (e.g., an engine having a fan actuation system characterized by FAS, FASL, and FBE, for example), results in an engine having unexpected and complementary benefits. For example, the relationship described above defines a compact packaging volume for the fan actuation system within the fan hub, which enables a low fan hub radius ratio and high aerodynamic efficiency. This compact packaging, however, inherently limits the physical size and force capability of the actuation components compared to less constrained designs. The excitation load control system beneficially mitigates the peak loads that this compact actuation system must react to. By actively sensing and compensating for asymmetric or cyclic excitation loads (e.g., due to off-axis airflow or maneuvers), the control system reduces the structural demands on the trunnions, bearings, and actuators.

Furthermore, the disclosed excitation load control system allows the engine to operate safely within the tighter design margins permitted by the above envelopes. The relationship described above identifies architectures where the actuation system is sized to handle typical loads while fitting within a confined space. However, transient or extreme excitation events could potentially exceed the capabilities of such a system. By integrating the excitation load control system, the engine dynamically adjusts airfoil pitch to shed or redistribute these high loads, effectively expanding the operational envelope of the compact actuation system. This synergy allows for the maintenance of the aerodynamically advantageous low fan hub radius ratio without compromising structural integrity or reliability under adverse conditions.

Additionally, the combination of the above defined actuation system and the excitation load control system facilitates a more robust response to autogenous excitations, such as aeroelastic flutter. The relationship ensure that the fan bearings and actuation linkages are positioned and sized to handle steady-state stresses and packaging constraints. The addition of the excitation load control system provides a dynamic layer of protection, utilizing the fan actuation assembly to actively damp or avoid resonance conditions that could otherwise damage the compact components defined by the FAS, FASL, and FBE parameters. This dual approach, improving the physical architecture via the FAS, FASL, and FBE parameters and managing dynamic loads via active control, results in a high-bypass, open rotor engine that is both lightweight and operationally robust.

As used herein, and with reference to the disclosure below, the terms “airfoil excitation phenomena” and “airfoil excitation phenomenon” refer to aerodynamic phenomena that impart an excitation load upon an open rotor aeronautical engine. An airfoil excitation phenomena may impart an excitation load upon one or more airfoils of an open rotor engine. The excitation load may be translated to other portions of the open rotor engine, such as to one or more bearing assemblies and/or one or more support structures. An airfoil excitation phenomena may be attributable at least in part to uneven or variable airflow incident upon the one or more airfoils in relation to an axis of thrust of the open rotor engine. The axis of thrust may generally be oriented along a longitudinal axis of the fan assembly; however, it will be appreciated that in some embodiments the axis of thrust may differ or diverge from the longitudinal axis of the fan assembly (e.g., up, down, left, and/or right), for example, according to the configuration of the open rotor engine and/or under various operation conditions. Additionally, the longitudinal axis of the fan assembly may generally be aligned with a longitudinal axis of the open rotor engine; however, it will be appreciated that the longitudinal axis of the fan assembly may differ or diverge from the longitudinal axis of the open rotor engine (e.g., up, down, left, and/or right), for example, according to the configuration of the open rotor engine and/or under various operating conditions. The axis of thrust may be augmented by changing a pitch angle of one or more airfoils, such as a pitch angle of one or more fan blades and/or a pitch angle of one or more guide vanes.

As used herein, the term “excitation load” refers to a load acting upon an open rotor aeronautical engine as a result of, or in relation to, one or more airfoil excitation phenomenon. The excitation load may act upon one or more airfoils, such as one or more fan blades and/or one or more guide vanes. The excitation load may translate to other portions of the open rotor engine, such as to one or more bearing assemblies and/or one or more engine support structures. As used herein, the term “asymmetric load” refers to an excitation load that has asymmetry, or is asymmetric, as between one or more airfoils of an open rotor engine, and/or as between one or more circumferential positions about a longitudinal axis of the open rotor engine. An excitation load, such as an asymmetric load, may have a frequency corresponding to rotation of the fan assembly and/or a circumferential position of one or more respective airfoils. An excitation load, such as an asymmetric load, may occur in a cyclic nature corresponding to one or more rotational circumferential positions of the fan blades, for example, at a frequency of n-instances per revolution of the fan assembly, and may sometimes be referred to as “cyclic load.” A cyclic load that occurs at a frequency of one instance per revolution of the fan assembly may be referred to as a “1P load,” where 1P stance for once per revolution. In at least one example embodiment, an excitation load, such as an asymmetric load, may have a frequency that corresponds to a multiple or a fraction of a full revolution of the fan assembly. In at least one example embodiment, an excitation load, such as an asymmetric excitation load, may include an “nP load,” where n is the number of instances per revolution. For example, an nP load may include a 2P load, a 3P load, a 4P load, or even higher order cyclic loads. Such nP loads may be amplified in proximity to a natural frequency or resonant frequency of the airfoils.

An excitation load may act upon one or more airfoils to varying degrees during operation of an open rotor engine, for example, based at least in part on varying airfoil excitation phenomenon that may contribute to the excitation load. The excitation load may translate from the airfoils to one or more components of the open rotor engine, such as to one or more bearing assemblies, and/or to an engine support structure, such as to one or more support arms that mount the open rotor engine to the aircraft. In accordance with the present disclosure, an open rotor engine may include one or more sensors that provide sensor data that may be utilized by an electronic controller to determine airfoil excitation phenomenon and/or an excitation load and to provide control commands to one or more controllable components to augment and/or compensate for such airfoil excitation phenomenon and/or excitation load.

In at least one example embodiment, a relatively high excitation load may arise during maneuvers in which at least some of the airfoils exhibit a relatively high aerodynamic incidence vector. By augmenting and/or compensating for such airfoil excitation phenomenon and/or excitation loads, propulsive efficiency of an open rotor engine may be improved. For example, fuel efficiency, specific fuel consumption, thrust-specific fuel consumption, and/or thrust-to-weight ratio, may be improved. Additionally, or in the alternative, cycle fatigue and/or load bearing design requirements of various components of an open rotor engine may be reduced, which may improve longevity, maintenance runtime, and/or operating performance of the open rotor engine.

In at least one example embodiment, an airfoil excitation phenomena may include aerodynamic phenomena attributable at least in part to an aerodynamic incidence vector of the respective airfoils and/or to one or more atmospheric conditions encountered by the respective airfoils. The aerodynamic incidence vector may depend on a pitch angle of the respective airfoils. Additionally, or in the alternative, the aerodynamic incidence vector may depend on a direction of airflow incident upon the respective airfoils. Additionally, or in the alternative, the aerodynamic incidence vector may depend at least in part on a flight path of an aircraft propelled by one or more open rotor engines, a flight trajectory or aerial maneuver of the aircraft, and/or operating conditions of the open rotor engine. For example, the aerodynamic incidence vector may depend at least in part on a pitch, roll, and/or yaw associated with a flight trajectory or aerial maneuver of the aircraft.

The one or more atmospheric conditions that may cause or contribute to an airfoil excitation phenomena may include variations in air speed, atmospheric pressure, temperature, humidity, turbulent air patterns, vortices, ground effects, and so forth. An airfoil excitation phenomena attributable to an aerodynamic incidence vector and/or to one or more other aerodynamic phenomenon may impart an excitation load that is asymmetric with respect to one or more airfoils of an open rotor engine, and/or with respect to one or more circumferential positions of the airfoils. For example, the aerodynamic incidence vector may differ as between respective circumferential positions of one or more airfoils, such as a rotational circumferential position in the case of a plurality of fan blades rotating about a longitudinal axis of the fan assembly and/or a fixed circumferential position in the case of a plurality of guide vanes circumferential spaced about the longitudinal axis in respectively fixed radial positions. The excitation load may depend at least in part on a circumferential position of the respective airfoils, for example, based at least in part on the aerodynamic incidence vector of the respective airfoils corresponding to a respective circumferential position. The aerodynamic incidence vector of a respective fan blade may change, for example, according to a sinusoidal function, as the respective fan blade rotates about the longitudinal axis of the fan assembly. At a given instant, the aerodynamic incidence vector of a plurality of circumferentially-spaced fan blades may depend at least in part on the circumferential positions of the respective fan blades, for example, according to a sinusoidal function.

By way of example, a downward moving fan blade may have a relatively higher aerodynamic incidence vector, attributable at least in part to a relatively higher angle of attack, as compared to an upward moving fan blade. Such a relatively higher angle of incidence vector of a downward moving fan blade may correspond to a relatively higher amount of airflow across the airfoil and a correspondingly higher amount of thrust, as compared to an upward moving fan blade. As a result, the respective fan blades may undergo cyclic loading as they rotate.

The aerodynamic incidence vector of a plurality of circumferentially-spaced guide vanes may depend at least in part on the fixed circumferential position of the respective guide vanes, for example, according to a sinusoidal function. Additionally, or in the alternative, a direction of airflow incident upon the respective airfoils may affect the aerodynamic incidence vector, such as which of the airfoils have a relatively higher and/or relatively lower aerodynamic incidence vector. Asymmetric loading, such as with respect to rotational or fixed circumferential position, may cause a pitch moment, a roll moment, and/or yaw moment, which may translate to other portions of the open rotor engine, such as to one or more bearing assemblies and/or one or more engine support structures. The aerodynamic incidence vector of a respective airfoil (e.g., a fan blade or a guide vane) may be augmented by changing a pitch angle of the respective airfoil. Such an airfoil excitation phenomena that imparts an excitation load that depends on a rotational or fixed circumferential position sometimes be referred to as a “cyclic excitation.”

In addition, or in the alternative to a cyclic excitation, In at least one example embodiment, an airfoil excitation phenomena may include autogenous excitation. As used herein, the term “autogenous excitation” refers to one or more airfoil excitation phenomenon that impart an autogenous load upon one or more airfoils of an open rotor engine, such as one or more fan blades and/or one or more guide vanes. As used herein, the term “autogenous load” refers to an excitation load that arises from or within one or more airfoils that is at least partially attributable to an airfoil excitation phenomenon. In at least one example embodiment, an autogenous excitation may include an aeroelastic excitation. In at least one example embodiment, an autogenous load may include an aeroelastic load, such as airfoil flutter (e.g., fan blade flutter and/or guide vane flutter). Airfoil flutter may sometimes be referred to as “whirl.” An aeroelastic load such as airfoil flutter or whirl may include vibrations that may translate to other portions of the open rotor engine and/or to an engine support structure. An autogenous excitation such as airfoil flutter, may be attributable at least in part to aerodynamic phenomenon such as aerodynamic incidence vector, uneven or variable airflow incident upon the one or more airfoils in relation to an axis of thrust of the open rotor engine, and/or other atmospheric conditions. An aeroelastic load such as airfoil flutter may have an increased incidence of occurrence in the event of high power operations, during landing, and at certain airfoil pitch angles. An aeroelastic load such as airfoil flutter may additionally or alternatively have an increased incidence of occurrence in the event of an aerodynamic incidence vector that includes a high angle of attack and/or a significant angle of sideslip, such as during high power operations, during landing, and at certain airfoil pitch angles. The vibrations associated with an aeroelastic load such as airfoil flutter may exhibit a relatively high amplitude and/or frequency, and/or a rapidly changing amplitude and/or frequency.

In addition, or in the alternative, to aeroelastic excitation, an autogenous excitation may include gyroscopic excitation. In at least one example embodiment, an autogenous load may include a gyroscopic load. A gyroscopic load may be attributable at least in part to an aerodynamic phenomenon that forces airfoils out of a normal plane of rotation, and/or as a result of rapid pitch and/or yaw changes, such as those associated with aerial maneuvers. A gyroscopic load upon the airfoils may translate to other portions of the open rotor engine and/or to an engine support structure. In at least one example embodiment, autogenous load such as airfoil flutter may be attributable at least in part to a gyroscopic load. For example, vibrations attributable to an autogenous load such as airfoil flutter may be amplified and/or induced by a gyroscopic load. Additionally, or in the alternative, a cyclic excitation may be amplified and/or induced at least in part by a gyroscopic load. An autogenous load from autogenous excitation such as aeroelastic excitation and/or gyroscopic excitation may translate to other portions of the open rotor engine, such as to one or more bearing assemblies of the open rotor engine, and/or to one or more engine support structures of the open rotor engine.

As used herein, the term “aerodynamic incidence vector” refers to a vector representing a direction at which a stream of airflow becomes incident upon an airfoil. An aerodynamic incidence vector may have X, Y, and Z dimensions in relation to a cartesian coordinate system, in which the X direction corresponds to a chord line of the airfoil representing a straight line joining the leading edge and trailing edge of the airfoil, the Y direction corresponds to a longitudinal axis of the airfoil, and the Z direction corresponds to a normal axis oriented normal to the X and Y direction. An aerodynamic incidence vector may include component vectors corresponding to an angle of attack and/or an angle of sideslip. The aerodynamic incidence vector may represent a resultant vector of the component vectors corresponding to an angle of attack and/or an angle of sideslip. As used herein, the term “angle of attack” refers to an angle between the chord line of the airfoil (X axis) and the projection of the aerodynamic incidence vector on the plane of symmetry defined by the chord line of the airfoil and the normal axis (X, Z plane). Angle of attack generally corresponds to oncoming airflow incident upon the airfoil, such as oncoming airflow associated with relative air speed. As used herein, the term “angle of sideslip” refers to an angle between the chord line of the airfoil (X axis) and the projection of the aerodynamic incidence vector on the plane of symmetry defined by the chord line of the airfoil and the longitudinal axis of the airfoil (X, Z plane). Angle of sideslip generally corresponds to crossways airflow incident upon the airfoil, such as crossways airflow associated with crosswind.

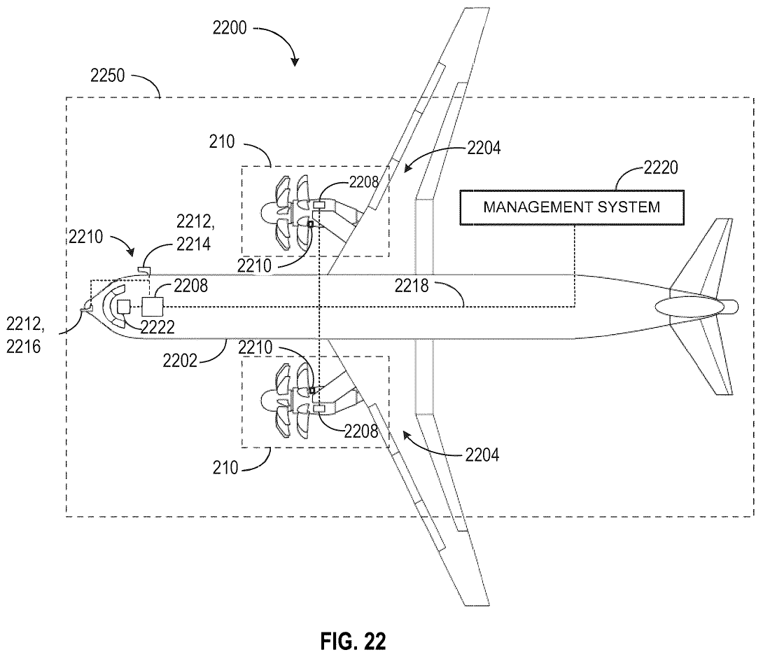

Referring to FIG. 22, an exemplary aircraft 2200 is described. It will be appreciated that the aircraft 2200 shown in FIG. 1 is provided by way of example and not to be limiting, and that presently disclosed subject matter may be incorporated into other embodiments of an aircraft without departing from the scope of the present disclosure. As shown, an aircraft 2200 may include a fuselage 2202 and a pair of wings 2204 extending laterally outward from the fuselage 2202. The aircraft 2200 may include one or more of the turbofan engines 210 that provide thrust for operating the aircraft 2200 such as during flight and/or taxiing. As shown, the one or more turbofan engines 210 may be similar or analogous to the turbofan engine 210, as described, for example, in FIG. 2. The aircraft 2200 may include any suitable number of turbofan engines 210, such as 1, 2, 4, 6, or 8 turbofan engines 210. As shown, a first turbofan engine 210 may be mounted to a first wing 2204, such as in an under-wing configuration, and a second turbofan engine 210 may be mounted to a second wing 2204, such as in an under-wing configuration. In at least one example embodiment, a plurality of turbofan engines 210 may be mounted to the first and second wings 2204, respectively. Additionally, or in the alternative, one or more turbofan engines 210 may be mounted to the aircraft 2200 in other suitable locations and/or configurations, such as to the fuselage 2202 aft of the wings 2204.

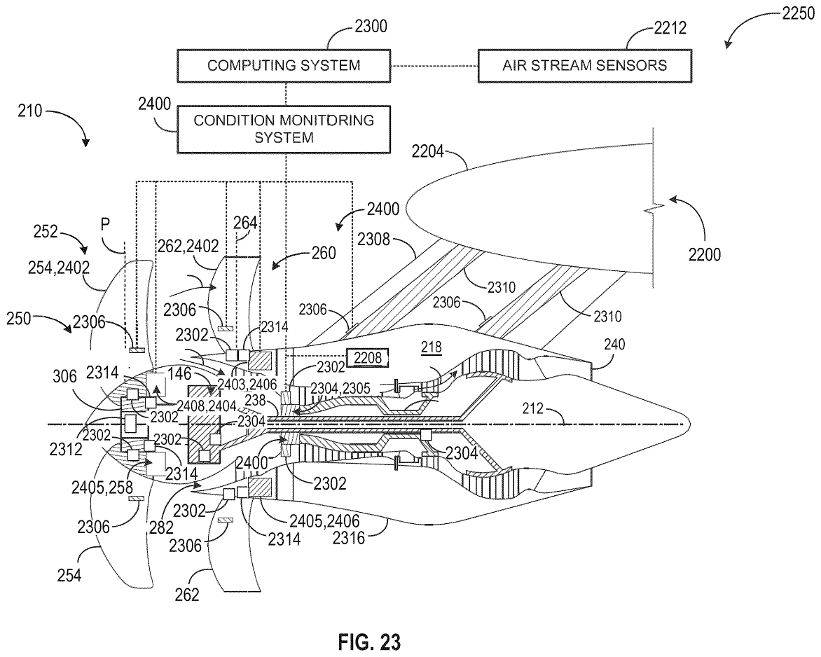

The aircraft 2200 may include a computing system 2300 (FIG. 23) that controls operations of the aircraft 2200 and the various systems thereof, including, for example, operations of the one or more turbofan engines 210. The computing system 2300 may include one or more electronic controllers 2208. The one or more electronic controllers 2208 may include one or more engine control units, electronic engine controllers, full-authority digital engine control (FADEC) device, or the like. The one or more electronic controllers 2208 may be located anywhere in the aircraft 2200. By way of example, a first electronic controller 2208, such as a FADEC device, may be located on or in proximity to a first turbofan engine 210, a second electronic controller 2208 may be located on or in proximity to a second turbofan engine 210, and/or a third electronic controller 2208 may be located within the fuselage 2202 of the aircraft 2200, such as in the cockpit.

The aircraft 2200 may include a plurality of sensors 2210, such as one or more sensors 2210 for sensing various operating conditions associated with the aircraft 2200, and/or one or more sensors 2210 for sensing various operating conditions associated with the one or more turbofan engines 210. As shown, the one or more sensors 2210 for sensing various operating conditions associated with the aircraft 2200 may include one or more aerodynamic incidence sensors 2212, such as one or more angle of attack sensors 2214 and/or one or more angle of sideslip sensors 2216. The one or more sensors 2210 for sensing various operating conditions associated with the aircraft 2200, may additionally include one or more airspeed sensors, temperature sensors, pressure sensors, sensors for recording ambient conditions, and the like. The plurality of sensors 2210 may be communicatively coupled with one or more of the electronic controllers 2208 of the computing system 2300, for example, via a wired or wireless communication network 2218. Sensor data from the respective sensors 2210, such as the one or more aerodynamic incidence sensors 2212, may be provided to the one or more electronic controllers 2208.

The computing system 2300 may also be communicatively coupled with a management system 2220 and/or a user interface 2222 via the wired or wireless communication network 2218. The management system 2220 and the computing system 2300 may interact with one another in connection with enterprise-level or fleet-level operations pertaining to the aircraft 2200 and/or the computing system 2300. Such enterprise level operations may include transmitting data from the management system 2220 to the computing system 2300 and/or transmitting data from the computing system 2300 to the management system 2220. The user interface 2222 may include one or more user input/output devices to allow a user to interact with the computing system 2300.

In accordance with the present disclosure, various aspects of the aircraft 2200, the one or more turbofan engines 210, and/or the computing system 2300, may define an excitation load control system 2250. The excitation load control system may be configured to augment and/or control an excitation load acting upon a turbofan engine 210 as described herein. The excitation load control system 2250 may include and/or may be integrated within any one or more of the aspects of the aircraft 2200, any one or more of the aspects of the one or more turbofan engines 210, and/or any one or more of the aspects of the computing system 2300, including any one or more of such aspects described herein.

longitudinal axis 212 longitudinal axis 212 longitudinal axis 212 one or more fuel valves 2758 Referring now to FIG. 23, aspects of the exemplary turbofan engine 210 are further described, including aspects associated with an excitation load control system 2250. As shown, The turbofan engine 210 may be communicatively coupled to the computing system 2300. The computing system 2300 may control operations of the turbofan engine 210 and the various systems thereof, including, for example, adjusting positions of the variable pitch fan blades 254 (e.g., rotating the respective fan blades 254 about the corresponding fan pitch axis P) and/or adjusting positions of the variable pitch guide vanes 262 (e.g., rotating the respective guide vanes 262 about the corresponding vane pitch axis 264). Generally, adjustments to the pitch of the fan blades 254 and/or the guide vanes 262 may be carried out at least in part two vary thrust and/or swirl effects under various operating conditions. For example, a magnitude and/or direction of thrust produced by the fan blades 254 may be adjusted by changing the pitch of the fan blades 254 and/or the guide vanes 262. Additionally, or in the alternative, the pitch of the fan blades 254 and/or the guide vanes 262 may be changed in response to an excitation load acting upon the turbofan engine 210, such as upon one or more airfoils (e.g., one or more fan blades 254 and/or one or more guide vanes 262), one or more bearing assemblies, and/or an engine support structure 2308 (e.g., one or more support arms 2310 that mount the turbofan engine 210 to the aircraft 2200). For example, the pitch of the fan blades 254 and/or the guide vanes 262 may be changed at least in part to augment and/or compensate for an excitation load, such as an asymmetric load. The excitation load may be determined based at least in part on an aerodynamic incidence vector of one or more of the airfoils (e.g., one or more fan blades 254 and/or one or more guide vanes 262). Additionally, or alternatively, the excitation load may depend at least in part on the aerodynamic incidence vector of one or more of the airfoils. The aerodynamic incidence vector may be determined based at least in part on sensor data corresponding to one or more sensors 2210 (e.g., FIG. 22).

The control operations of the turbofan engine 210 may be carried out based at least in part on sensor data corresponding to one or more sensors 2210 (e.g., FIG. 22) that sense various operating conditions associated with the turbofan engine 210 and/or the aircraft 2200. The control operations may be performed at least in part by one or more electronic controllers 2208, such as one or more engine control units, electronic engine controllers, full-authority digital engine control (FADEC) device, or the like.

As shown in FIG. 23, the turbofan engine 210 may include a condition monitoring system 2400. The condition monitoring system 2400 may monitor one or more conditions associated with the turbofan engine 210. The condition monitoring system 2400 may define a portion of the computing system 2300, or may be communicatively coupled with the computing system 2300. Additionally, or in the alternative, the condition monitoring system 2400 may define a portion of an electronic controller 2208, or may be communicatively coupled with an electronic controller 2208, such as an electronic controller 2208 located on, or in proximity to, the turbofan engine 210. The condition monitoring system 2400 may perform vibration-based condition monitoring of the turbofan engine 210. The vibration-based condition monitoring may include determining an excitation load acting upon the turbofan engine 210. The turbofan engine 210 may include one or more vibration sensors 2302 operably coupled thereto. The one or more vibration sensors 2302 may be utilized by the condition monitoring system 2400 to perform vibration-based condition monitoring of the turbofan engine 210. By way of example the one or more vibration sensors 2302 may include an accelerometer, a strain gauge, an eddy-current sensor, an acoustic sensor, an optical displacement sensor, or a gyroscope, as well as combinations of these. The one or more vibration sensors 2302 may measure one or more characteristics of vibration, such as frequency, amplitude, phase, or noise, as well as combinations of these.

The one or more vibration sensors 2302 may be located at any suitable position about the turbofan engine 210, such as at one or more locations about the engine core 218 and/or one or more locations about the fan assembly 250. By way of example, one or more vibration sensors 2302 may be positioned on, at, within, or in proximity to one or more bearing assemblies 2304 of the turbofan engine 210, such as on, at, within, or in proximity to one or more bearing assemblies of the HP shaft 238 and/or the LP shaft 238. In at least one example embodiment, one or more vibration sensors 2302 may be located at or in proximity to a forward axial bearing assembly 2305 supporting the LP shaft 238. The one or more vibration sensors 2302 located on, at, within, or in proximity to the one or more bearing assemblies 2304 may include an accelerometer or any other suitable vibration sensor 2302.

Additionally, or in the alternative, In at least one example embodiment, one or more vibration sensors 2302 may be located on, at, within, or in proximity to the fan assembly 250. For example, one or more vibration sensors 2302 may be coupled to and/or contained within respective ones of the plurality of fan blades 254. All or a portion of the plurality of fan blades 254 may include one or more vibration sensors 2302. The one or more vibration sensors 2302 coupled to and/or contained within a respective fan blade 254 may include a strain gauge or any other suitable vibration sensor 2302. Additionally, or in the alternative, one or more vibration sensors 2302 may be located on, at, within, or in proximity to the disk 306 and/or the power gearbox 146.

Additionally, or in the alternative, In at least one example embodiment, one or more vibration sensors 2302 may be disposed about an engine case 2316, for example, on, at, within, or in proximity to the fan guide vane array 260. For example, one or more vibration sensors 2302 may be coupled to and/or contained within respective ones of the plurality of guide vanes 262. All or a portion of the plurality of guide vanes 262 may include one or more vibration sensors 2302. The one or more vibration sensors 2302 coupled to and/or contained within a respective guide vanes 262 may include a strain gauge or any other suitable vibration sensor 2302.

In addition, or in the alternative, to sensor data from one or more vibration sensors 2302, the computing system 2300 and/or the condition monitoring system 2400 may determine an excitation load acting upon the turbofan engine 210 based at least in part on sensor data from one or more strain gauges 2306. As shown in FIG. 23, the turbofan engine 210 and/or the aircraft 2200 may include one or more strain gauges 2306 operably coupled thereto. By way of example, the one or more strain gauges 2306 may include a linear strain gauge, a rosette strain gauge, a quarter-bridge type strain gauge, a half-bridge type strain gauge, or a full-bridge type strain gauge, as well as combinations of these. The one or more vibration sensors 2302 may measure one or more characteristics of strain, such as axial strain, bending strain, shear strain, or torsion strain, as well as combinations of these.

The one or more strain gauges 2306 may be located at any suitable position about the turbofan engine 210 and/or the aircraft 2200, such as at one or more locations about the fan assembly 250 and/or one or more locations about the fan guide vane array 260. In at least one example embodiment, one or more strain gauges 2306 may be coupled to and/or contained within at least some of the plurality of airfoils 2402. For example, one or more strain gauges 2306 may be coupled to and/or contained within respective ones of the plurality of fan blades 254. All or a portion of the plurality of fan blades 254 may include one or more strain gauges 2306. Additionally, or in the alternative, one or more strain gauges 2306 may be coupled to and/or contained within respective ones of the plurality of guide vanes 262. All or a portion of the plurality of guide vanes 262 may include one or more strain gauges 2306. Additionally, or in the alternative, In at least one example embodiment, one or more strain gauges 2306 may be coupled to and/or contained within an engine support structure 2308. The engine support structure 2308 may include one or more support arms 2310 that mount the turbofan engine 210 to the aircraft 2200, and/or that support the turbofan engine 210 in a mounted position, such as from the wing, fuselage, or tail of an aircraft. For example, as shown in FIG. 23, the turbofan engine 210 may be mounted in a mounted in an under-wing configuration. The one or more support arms 2310 may include one or more pylons extending between the aircraft 2200 and the engine case 2316 of the turbofan engine 210. Additionally, or the alternative, the one or more support arms 2310 include one or more thrust mounts that transfer axially directed thrust loads from the engine case 2316 to the engine support structure 2308.

The one or more vibration sensors 2302 and/or the one or more strain gauges 2306 may provide sensor data to the computing system 2300 and/or the condition monitoring system 2400. The sensor data from the one or more vibration sensors 2302 and/or the one or more strain gauges 2306 may be utilized to determine an excitation load. The computing system 2300 and/or the condition monitoring system 2400 may provide control commands to one or more controllable components, for example, in response to an excitation load determined based at least in part on sensor data from the one or more vibration sensors 2302 and/or the one or more strain gauges 2306.

Still referring to FIG. 23, the turbofan engine 210 may include one or more position indicators 2312 that determine a circumferential position of at least one of the plurality of airfoils 2402. In at least one example embodiment, a position indicator 2312 may determine a circumferential position of the fan assembly 250 and/or a circumferential position of one or more fan blades 254 of the fan assembly 250. One or more position indicators 2312 may be situated at any suitable location of the turbofan engine 210. For example, a position indicator 2312 may be disposed about the disk 306, one or more fan blades 254, the power gearbox 146, and/or the LP shaft 238. Any suitable position indicator may be utilized, such as a proximity sensor or the like. Suitable proximity sensors may include electromagnetic proximity sensors, optical proximity sensors, ultrasonic proximity sensors, capacitive proximity sensors, photoelectric proximity sensors, inductive proximity sensors, and magnetic proximity sensors.

A position indicator 2312 may provide sensor data to the computing system 2300 and/or the condition monitoring system 2400 indicating a circumferential position of one or more fan blades 254. The circumferential position may be utilized to correlate or associate an excitation load to a circumferential position of one or more fan blades 254. Additionally, or in the alternative, the circumferential position may be utilized to determine an asymmetric load corresponding to a circumferential position of one or more of the fan blades 254 and/or one or more of the guide vanes 262. The computing system 2300 and/or the condition monitoring system 2400 may provide control commands to one or more controllable components, for example, based at least in part on an excitation load, such as an asymmetric load, corresponding to a circumferential position of one or more of the fan blades 254 and/or one or more of the guide vanes 262.

In at least one example embodiment, the turbofan engine 210 may include one or more pitch angle indicators 2314 that determine a pitch angle of one or more fan blades 254 and/or a pitch angle of one or more guide vanes 262. The one or more pitch angle indicators 2314 may be situated at any suitable location of the turbofan engine 210. For example, one or more pitch angle indicators 2314 may be disposed about a fan assembly 250. In at least one example embodiment, respective ones of the plurality of pitch angle indicators 2314 may determine a pitch angle of a corresponding one of the plurality of fan blades 254. Additionally, or the alternative, a pitch angle indicator 2314 may determine a pitch angle of respective ones of a plurality of fan blades 254. Additionally, or the alternative, one more pitch angle indicators 2314 may be disposed about a fan guide vane array 260. In at least one example embodiment, respective ones of the plurality of pitch angle indicators 2314 may determine a pitch angle of a corresponding one of the plurality of guide vanes 262. Additionally, or in the alternative, a pitch angle indicator 2314 may determine a pitch angle of respective ones of a plurality of guide vanes 262.

A pitch angle indicator 2314 may provide sensor data to the computing system 2300 and/or to the condition monitoring system 2400 indicating a pitch angle of one or more fan blades 254 and/or of one or more guide vanes 262. An excitation load, such as an asymmetric load, may be determined based at least in part on a corresponding pitch angle determined by a respective pitch angle indicator 2314. Additionally, or in the alternative, an excitation load, such as an asymmetric load, may be determined based at least in part on an angle of attack and/or an angle of sideslip, as determined, for example, based at least in part on data from an angle of attack sensor 2214 and/or an angle of sideslip sensor 2216. The computing system 2300 and/or the condition monitoring system 2400 may provide control commands to one more controllable components, for example, based at least in part on a pitch angle of the one or more fan blades 254 and/or a pitch angle of the one or more guide vanes 262.

As shown in FIG. 23, the one or more controllable components may include one or more fan actuation assemblies 2405. A fan actuation assembly 2405 may change a pitch angle of one or more airfoils 2402, such as a pitch angle of one or more fan blades 254 or a pitch angle of one or more guide vanes 262. The pitch angle of respective ones of a plurality of airfoils 2402 may be changed individually and/or collectively by a fan actuation assembly 2405. As shown in the example of FIG. 23, the airfoils 2402 are not enclosed within a casing, referred to as “unducted.” A fan actuation assembly 2405 that changes a pitch angle of one or more fan blades 254 may fan actuation system 258 include the fan actuation system 258 described herein. A fan actuation system 258 may individually and/or collectively change a pitch angle of respective ones of a plurality of fan blades 254. A fan actuation assembly 2405 that changes a pitch angle of one or more guide vanes 262 may sometimes be referred to as a guide vane-pitch change assembly 2406, and include the one or more actuators 266 described herein. A guide vane-pitch change assembly 2406 may individually and/or collectively change a pitch angle of respective ones of a plurality of guide vanes 262.

A fan actuation system 258 may change a pitch angle of one or more fan blades 254 by rotating the respective one or more fan blades 254 about a corresponding fan pitch axis P. The pitch angle of the one or more fan blades 254 may be adjusted by the fan actuation system 258 to augment and/or compensate for an excitation load acting upon one or more of the airfoils 2402. For example, the pitch angle of the one or more fan blades 254 may be adjusted by the fan actuation system 258 to augment and/or compensate for an excitation load acting upon one or more of the fan blades 254, and/or to augment and/or compensate for an excitation load acting upon one or more of the guide vanes 262. Additionally, or in the alternative, the pitch angle of the one or more fan blades 254 may be adjusted by the fan actuation system 258 to augment and/or compensate for an excitation load acting upon one more other portions of the turbofan engine 210, such as one or more bearing assemblies 2304 (e.g., a forward axial bearing assembly 2305), and/or such as an engine support structure 2308 (e.g., one or more support arms 2310).

A guide vane-pitch change assembly 2406 may change a pitch angle of one or more guide vanes 262 by rotating the respective one more guide vanes 262 about a corresponding vane pitch axis 264. The pitch angle of the one or more guide vanes 262 may be adjusted by the guide vane-pitch change assembly 2406 to augment and/or compensate for an excitation load acting upon one or more of the airfoils 2402. For example, the pitch angle of the one or more guide vanes 262 may be adjusted by the guide vane-pitch change assembly 2406 to augment and/or compensate for an excitation load acting upon one or more of the fan blades 254, and/or to augment and/or compensate for an excitation load acting upon one or more of the guide vanes 262. Additionally, or in the alternative, the pitch angle of the one or more guide vanes 262 may be adjusted by the guide vane-pitch change assembly 2406 to augment and/or compensate for an excitation load acting upon one more other portions of the turbofan engine 210, such as one or more bearing assemblies 2304 (e.g., a forward axial bearing assembly 2305), and/or such as an engine support structure 2308 (e.g., one or more support arms 2310).

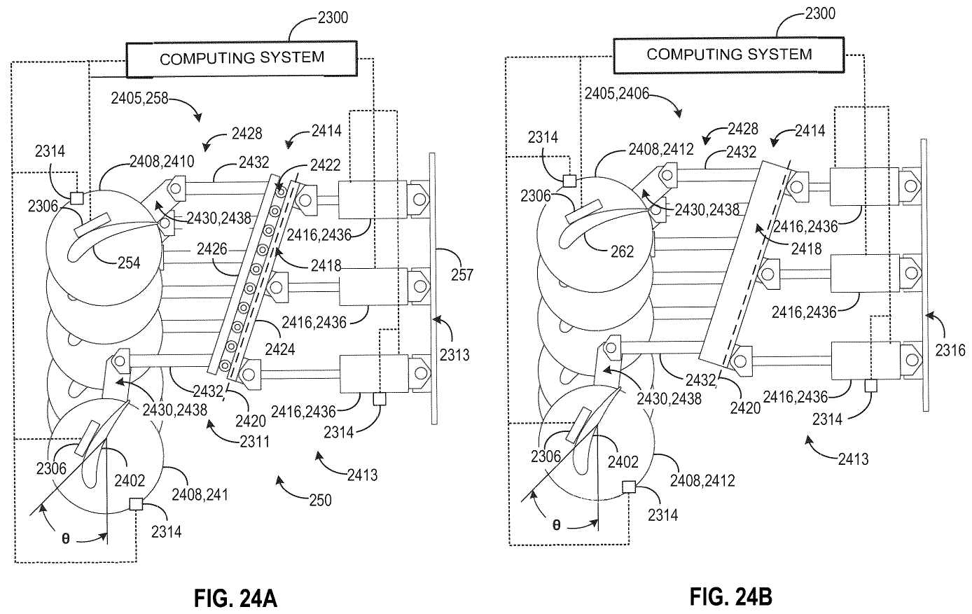

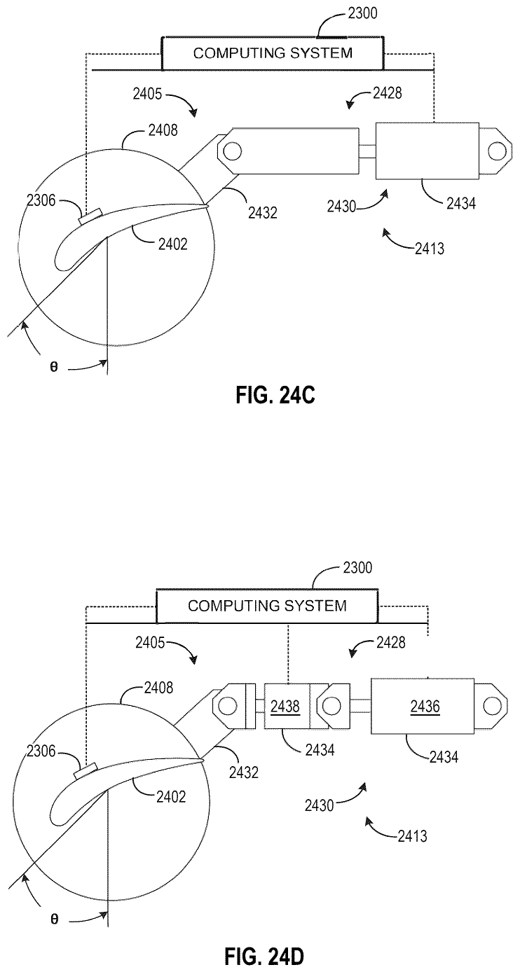

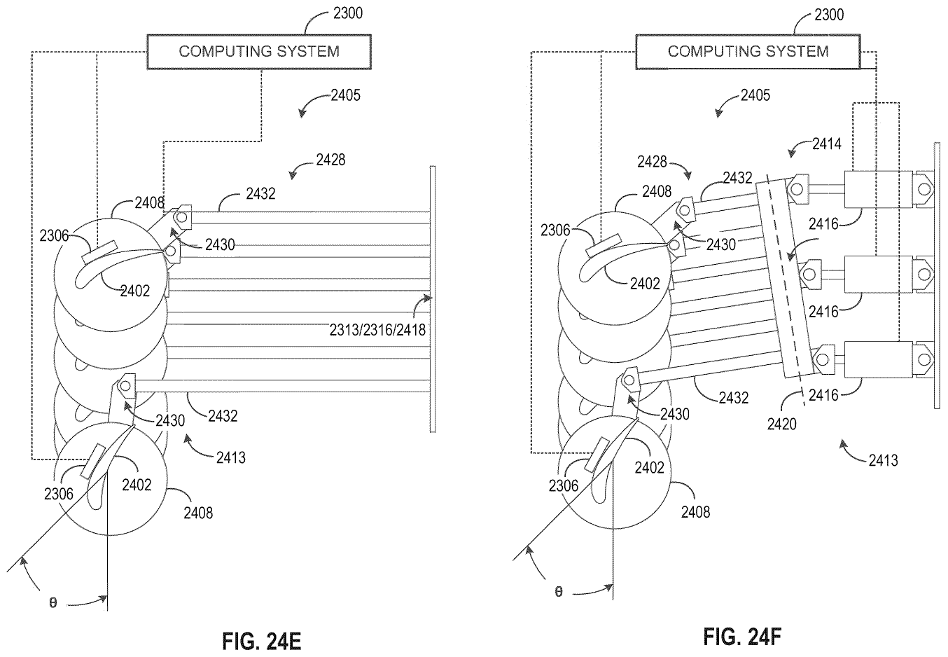

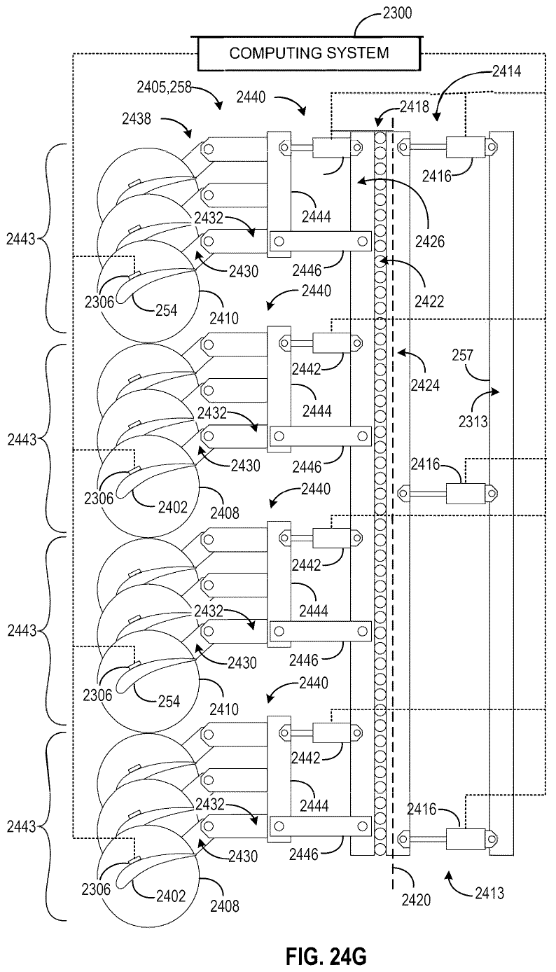

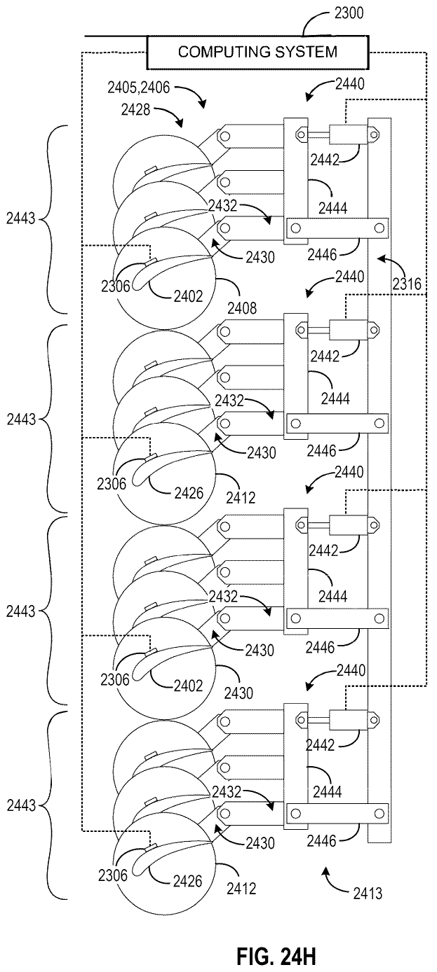

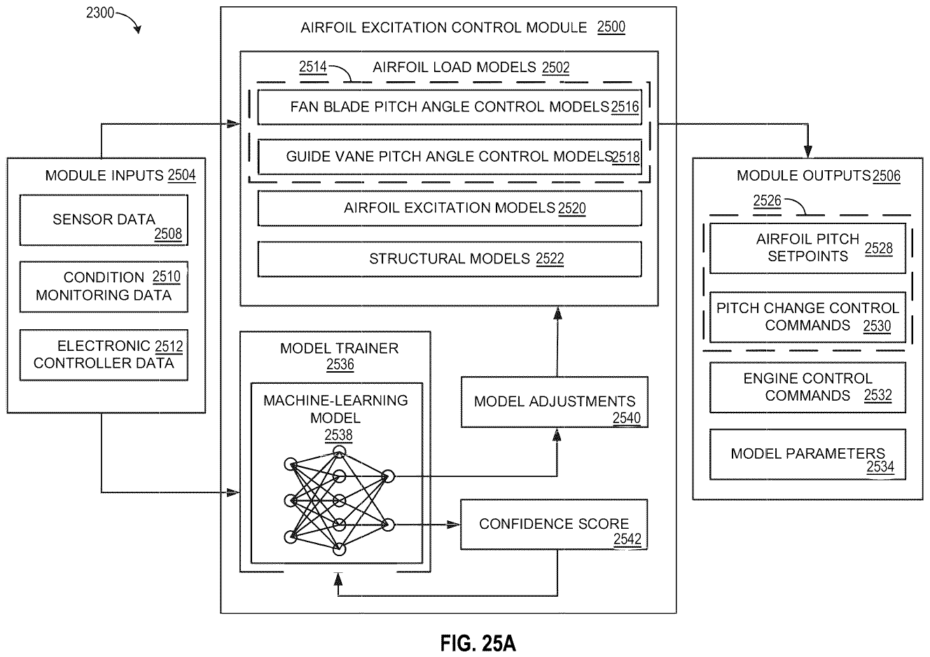

In at least one example embodiment, the pitch angle of the one or more fan blades 254 and/or the one or more guide vanes 262 may be adjusted at least in part to augment and/or to compensate for an excitation load, such as an asymmetric load, corresponding to one or more circumferential positions. An excitation load, such as an asymmetric load, may be determined based at least in part on sensor data from the one or more sensors 2210, such as from the one or more aerodynamic incidence sensors 2212, the one or more vibration sensors 2302, and/or the one or more strain gauges 2306. In at least one example embodiment, an asymmetric load may be determined based at least in part on such sensor data in combination with data from one or more position indicators 2312. Additionally, or in the alternative, an asymmetric load may be determined based at least in part on a correlation between the sensor data and circumferential position. In at least one example embodiment, one or more actuators 2413 (shown in FIGS. 24B-24H) may be actuated to a first position during a cruise flight condition. The first position may correspond to an excitation load, such as an asymmetric load, which may exist during at least some cruise flight conditions. Additionally, or in the alternative, the one or more actuators 2413 may be actuated to a second position during at least one of: a climbing flight condition, a descending flight condition, and a takeoff flight condition. The second position may correspond to an excitation load, such as an asymmetric load, which may exist during at least some climbing, descending, and/or takeoff flight conditions. It should be understood that the one or more actuators 2413 may include the one or more actuators 259, 266 described herein.

Referring now to FIGS. 24A-24H, exemplary fan actuation assemblies 2405 are further described. FIGS. 24A-24H show various embodiments and features of exemplary fan actuation assemblies 2405. It will be appreciated that the embodiments and features shown may be utilized interchangeably in various combinations. As shown, for example, in FIG. 24A, a fan actuation assembly 2405, such as a fan actuation system 258, may change a pitch angle (6) of one or more airfoils 2402, such as one or more fan blades 254. As shown, for example, in FIG. 24B, a fan actuation assembly 2405, such as a guide vane-pitch change assembly 2406, may change a pitch angle (6) of one or more airfoils 2402, such as one or more guide vanes 262.

As shown in FIGS. 24A-24H, the one or more airfoils 2402 may be respectively coupled to a corresponding airfoil retention mechanism 2408. An airfoil retention mechanism 2408 may have any suitable configuration that facilitates retaining the respective airfoil or airfoils 2402 while allowing the respective airfoil or airfoils 2402 to rotate about the respective fan pitch axis P or vane pitch axis 264 (FIG. 23), as applicable. For example, an airfoil retention mechanism 2408 may be configured as a trunnion, a cradle, a clevis, a bracket, or the like, as well as combinations of these. Such airfoil retention mechanism 2408 may include associated mounting hardware. An airfoil retention mechanism 2408 retains a fan blade 254 may sometimes be referred to as a fan blade-retention mechanism 2410. An airfoil retention mechanism 2408 that retains a guide vane 262 may sometimes be referred to as a guide vane-retention mechanism 2412.

As shown in FIGS. 24A-24H, a fan actuation assembly 2405 may include one or more actuators 2413 directly or indirectly coupled to one or more of the airfoil retention mechanisms 2408 and/or to one or more airfoils 2402. The one or more actuators 2413 may be actuatable to change the pitch angle (6) of the one or more airfoils 2402. Any suitable actuator may be included in a fan actuation assembly 2405, such as an actuator that provides linear and/or rotary movement. Exemplary actuators include linear actuators, rotary actuators, hydraulic actuators, pneumatic actuators, electric actuators, electric motors, stepper motors, servomotors, comb drives. The one or actuators 2413 may include associated mounting hardware, linkages, and so forth.

As shown, for example, in FIGS. 24A and 24B, a fan actuation assembly 2405 may include an ensemble actuator assembly 2414. An ensemble actuator assembly 2414 may include one or more ensemble actuators 2416 that collectively change a pitch angle of respective ones of the plurality of airfoils 2402. The one or more ensemble actuators 2416 may be communicatively coupled to the computing system 2300. The one or more ensemble actuators 2416 may collectively change a pitch angle of respective ones of the plurality of airfoils 2402 responsive to control commands from the computing system 2300. The control commands from the computing system 2300 may cause the one or more ensemble actuators 2416 to collectively change the pitch angle of respective ones of the plurality of airfoils 2402 to augment and/or compensate for an excitation load, such as an asymmetric load. For example, the one or more ensemble actuators 2416 may collectively change the pitch angle of respective ones of the plurality of airfoils 2402 according to a control command from the computing system 2300 configured at least in part to augment and/or to compensate for an asymmetric load, corresponding to a circumferential position of one or more of the fan blades 254 and/or one or more of the guide vanes 262.

In at least one example embodiment, an ensemble actuator assembly 2414 may include a unison ring 2418 that translates motion of the one or more ensemble actuators 2416, such as linear and/or rotary motion, collectively to respective ones of the plurality of airfoils 2402. The one or more ensemble actuators 2416 may be coupled directly or indirectly to the unison ring 2418. Additionally, or in the alternative, the plurality of airfoils 2402 may be coupled directly or indirectly to the unison ring 2418. The unison ring 2418 may be movable by the one or more ensemble actuators 2416 in one or more degrees of freedom, so as to collectively change the pitch angle of respective ones of the plurality of airfoils 2402. For example, the unison ring 2418 may be movable with respect to one or more degrees of freedom, such as forward-and-aftward movement, up-and-down movement, left-and-right movement, pitch, roll, or yaw, as well as combinations of these. As shown, for example, in FIGS. 24A and 24B, and ensemble actuator assembly 2414 may include a plurality of ensemble actuators 2416, such as three ensemble actuators 2416. It will be appreciated, however, that any number of ensemble actuators 2416 may be provided, including for example, one, two, three, or more ensemble actuators 2416.

The unison ring 2418 may define a pitch plane 2420, and movement of the one or more ensemble actuators 2416 may translate an orientation of the pitch plane 2420 with respect to one or more of such degrees of freedom. In at least one example embodiment, as shown, for example, in FIGS. 24A and 24B, one or more ensemble actuators 2416 may translate the unison ring 2418, for example, with respect to pitch and/or yaw of the unison ring 2418. Additionally, or in the alternative, one or more ensemble actuators 2416 may translate or rotate the unison ring 2418, with respect to a roll degree of freedom. Regardless of the particular degrees of freedom with respect to which the unison ring 2418 may be movable, movement of the unison ring 2418 may collectively change the pitch angle of respective ones of the plurality of airfoils 2402.

In at least one example embodiment, as shown in FIG. 24A, the fan assembly 250 may be rotatable with respect to the ensemble actuator assembly 2414. For example, as shown, the unison ring 2418 may include a fan bearing assembly 2422. The fan bearing assembly 2422 includes the one or more fan bearings 1500 described with respect to FIG. 15. The unison ring may include an inward unison ring 2424 and an outward unison ring 2426, and the fan bearing assembly 2422 may be disposed between the inward unison ring 2424 and the outward unison ring 2426. The fan bearing assembly 2422 may allow a rotor portion 2311 of the fan assembly 250 to rotate in relation to a stator portion 2313 of the fan assembly 250. The outward unison ring 2426 may rotate in relation to the inward unison ring 2424 by way of the fan bearing assembly 2422. The outward unison ring 2426 may define part of the rotor portion 2311 of the fan assembly 250. The inward unison ring 2424 may define part of the stator portion 2313 of the fan assembly 250. In at least one example embodiment, the unison ring 2418 may define a portion of the disk 306. For example, the outward unison ring 2426 may define a portion of the disk 306. Additionally, or in the alternative, the outward portion of the unison ring 2418 may be coupled to the disk 306.

As shown in FIG. 24A, for an ensemble actuator assembly 2414 that changes a pitch angle of a plurality of fan blades 254, the ensemble actuator assembly 2414 may be coupled directly or indirectly to the stator portion 2313 of a fan assembly 250, such as to the fan hub 257, for example, by the one or more ensemble actuators 2416. The fan actuation system 258 may include a pitch angle indicator 2314 that determines a pitch angle of the plurality of fan blades 254 associated with the ensemble actuator assembly 2414, such as a pitch angle corresponding to a change to the pitch angle of the plurality of fan blades 254 imparted by the ensemble actuator assembly 2414. As shown in FIG. 24B, for an ensemble actuator assembly 2414 that changes a pitch angle of a plurality of guide vanes 262, the ensemble actuator assembly 2414 may be coupled directly or indirectly to the engine core 218, such as to the engine case 2316, for example, by the one or more ensemble actuators 2416. The guide vane-pitch change assembly 2406 may include a pitch angle indicator 2314 that determines a pitch angle of the plurality of fan blades 254 associated with the ensemble actuator assembly 2414, such as a pitch angle corresponding to a change to the pitch angle of the plurality of guide vanes 262 imparted by the ensemble actuator assembly 2414.

Still referring to FIGS. 24A and 24B, In at least one example embodiment, a fan actuation assembly 2405 may include one or more unitary actuator assemblies 2428. A unitary actuator assembly 2428 may include a plurality of unitary actuators 2430. Respective ones of the plurality of unitary actuators 2430 may respectively change a pitch angle of a corresponding airfoil 2402. The plurality of unitary actuators 2430 may be communicatively coupled to the computing system 2300. The plurality of unitary actuators 2430 may respectively change a pitch angle of a corresponding airfoil 2402 responsive to control commands from the computing system 2300. The control commands from the computing system 2300 may cause a respective unitary actuator 2430 to change the pitch angle of a corresponding airfoil 2402 to augment and/or compensate for an excitation load, such as an asymmetric load, corresponding to a circumferential position of one or more of the fan blades 254 and/or one or more of the guide vanes 262. The unitary actuator assembly 2428 may include one or more pitch angle indicators 2314 that determine a pitch angle of a corresponding airfoil 2402 associated with a respective unitary actuator 2430, such as a pitch angle corresponding to a change to the pitch angle of the airfoil 2402 imparted by the unitary actuator assembly 2428.

A unitary actuator 2430 may be directly or indirectly coupled to a corresponding airfoil 2402 or airfoil retention mechanism 2408. Additionally, or in the alternative, a unitary actuator 2430 may be directly or indirectly coupled to a unison ring 2418, such as to an outward unison ring 2426. For example, a first end of a unitary actuator 2430 may be coupled to an airfoil 2402 or airfoil retention mechanism 2408, and a second end of the unitary actuator 2430 may be coupled to the unison ring 2418. In at least one example embodiment, as shown in FIG. 24A, a unitary actuator assembly 2428 may include a plurality of linkage arms 2432 respectively disposed between the unison ring 2418, such as the outward unison ring 2426, and a corresponding unitary actuator 2430. For example, a first end of a unitary actuator 2430 may be coupled to an airfoil 2402 or airfoil retention mechanism 2408, and a second end of the unitary actuator 2430 may be coupled to a corresponding linkage arm 2432. A first end of such linkage arm 2432 may be coupled to the second end of the unitary actuator 2430, and a second end of such linkage arm 2432 may be coupled to the unison ring 2418. Additionally, or in the alternative, a unitary actuator assembly 2428 may include a plurality of linkage arms 2432 respectively disposed between a corresponding unitary actuator 2430 and a corresponding airfoil 2402 or airfoil retention mechanism 2408. For example, a first end of the linkage arm 2432 may be coupled to an airfoil 2402 or airfoil retention mechanism 2408, and a second end of the linkage arm 2432 may be coupled to the first end of the unitary actuator 2430.

Now referring to FIGS. 24C and 24D, exemplary unitary actuator assemblies 2428 are further described. A unitary actuator assembly 2428 may include a plurality of unitary actuators 2430. FIGS. 24C and 24D respectively show an exemplary unitary actuator 2430. A unitary actuator 2430 may include one or more actuator mechanisms 2434. For example, FIG. 24C shows a unitary actuator 2430 that has one actuator mechanism 2434. As another example, FIG. 24D shows a unitary actuator that has a plurality of actuator mechanisms 2434, such as a first actuator mechanism 2436 and a second actuator mechanism 2438. In at least one example embodiment, a fan actuation assembly 2405 may include a unitary actuator assembly 2428 with a plurality of unitary actuators 2430 configured as shown in FIGS. 24C and/or 24D. For example, the fan actuation assembly 2405 shown in FIG. 24A and/or the fan actuation assembly 2405 shown in FIG. 24B may include a plurality of unitary actuators 2430 configured as shown in FIGS. 24C and/or 24D. Additionally, or in the alternative, a fan actuation assembly 2405 may include unitary actuator assembly 2428 with a plurality of unitary actuators 2430 configured as shown in FIGS. 24C and/or 24D, for example, without requiring an ensemble actuator assembly 2414.

In at least one example embodiment, the fan actuation assembly 2405 may include a unitary actuator assembly 2428 with a plurality of unitary actuators 2430 configured as shown in FIG. 24D, for example, with respective ones of the plurality of unitary actuators 2430 corresponding to respective ones of the plurality of airfoils 2402. The plurality of unitary actuators 2430 may respectively change a pitch angle of a corresponding airfoil 2402 responsive to control commands from the computing system 2300. In at least one example embodiment, the control commands from the computing system 2300 may cause the plurality of unitary actuators 2430 to collectively change the pitch angle of respective ones of the plurality of airfoils 2402. For example, the control commands may cause a plurality of course actuator mechanisms 2434 (e.g., a plurality of first actuator mechanisms 2436) corresponding to respective ones of the plurality of unitary actuators 2430 to collectively change the pitch angle of respective ones of the plurality of airfoils 2402. For example, the plurality of course actuator mechanisms 2434 may adjust the pitch angle according to a course range of motion, such as up to a full range of motion, of the corresponding airfoil 2402 with respect to the pitch axis thereof (e.g., the fan pitch axis P or the vane pitch axis 264, as applicable). Additionally, or in the alternative, the control commands may cause one or more of the plurality of fine actuator mechanisms 2434 (e.g., one or more of the second actuator mechanisms 2438) corresponding to a respective unitary actuator 2430 to change the pitch angle of a corresponding airfoil 2402. For example, the plurality of fine actuator mechanisms 2434 may adjust the pitch angle according to a fine range of motion, such as within a partial range of motion, of the corresponding airfoil 2402 with respect to the pitch axis thereof (e.g., the fan pitch axis P or the vane pitch axis 264, as applicable).

Referring, by way of example, to FIGS. 24A, 24B, and 24D, In at least one example embodiment, a first actuator mechanism 2436 may provide course adjustments to the pitch angle of a corresponding airfoil 2402. Additionally, or in the alternative, a second actuator mechanism 2438 may provide fine adjustments to the pitch angle of the corresponding airfoil 2402. An actuator mechanism 2434 that provides course adjustments to the pitch angle of a corresponding airfoil 2402 may sometimes be referred to as a course actuator mechanism 2434. An actuator mechanism 2434 that provides fine adjustments to the pitch angle of a corresponding airfoil 2402 may sometimes be referred to as a fine actuator mechanism 2434.

By way of example, a course actuator mechanism 2434 (e.g., the first actuator mechanism 2436 shown in FIG. 24D) may have a stroke length corresponding to a coarse range of motion, such as a full range of motion, of the airfoil 2402 with respect to the corresponding pitch axis (e.g., the fan pitch axis P or the vane pitch axis 264, as applicable). Additionally, or in the alternative, a course actuator mechanism 2434 may have a stroke length corresponding to from about 10% to about 100% of the range of motion of the airfoil 2402 with respect to such pitch axis, such as from about 10% to about 100%, such as from about 25% to about 100%, or such as from about 60% to about 100%.

By way of further example, a fine actuator mechanism 2434 (e.g., the second actuator mechanism 2438 shown in FIG. 24D) may have a stroke length corresponding to a fine range of motion, such as a partial range of motion of the airfoil 2402 with respect to the corresponding pitch axis (e.g., the fan pitch axis P or the vane pitch axis 264, as applicable). For example, a fine actuator mechanism 2434 may have a stroke length corresponding to from about 1% to about 40% of the range of motion of the airfoil 2402 with respect to such pitch axis, such as from about 1% to about 10%, such as from about 1% to about 25%, or such as from about 25% to about 40%. In at least one example embodiment, the stroke length of a course actuator mechanism 2434 and the stroke length of a fine actuator mechanism 2434 may collectively correspond to a full range of motion of the airfoil 2402 with respect to the corresponding pitch axis.

Referring now to FIGS. 24E and 24F, a fan actuation assembly 2405 may include one or more actuators 2413 configured to change a pitch angle of respective ones of the plurality of airfoils 2402, and a plurality of linkage arms 2432 that are respectively movable by actuation of at least one of the one or more actuators 2413. Respective ones of the plurality of linkage arms 2432 may be directly or indirectly coupled to a corresponding one of the plurality of airfoils 2402. Respective ones of the plurality of linkage arms 2432 may have a length that differs from at least another one of the plurality of linkage arms 2432 respectively corresponding to another one of the plurality of airfoils 2402. The respective length of the respective ones of the plurality of linkage arms 2432 may be selected at least in part to orient a displacement or a range of motion of the corresponding linkage arm 2432 to a desired envelope of rotation of the corresponding airfoil 2402 about the pitch axis of the airfoil 2402 (e.g., the fan pitch axis P or the vane pitch axis 264, as applicable). The desired envelope of rotation of the corresponding airfoil 2402 may differs from the envelope of rotation of at least another one of the plurality of airfoils 2402. The desired envelope of rotation may include a pitch angle range, a maximum pitch angle, and/or a desired minimum pitch angle. Additionally, or in the alternative, the desired envelope of rotation may include a rate of rotation about the pitch axis of the airfoil 2402 as a function of a displacement of the respective linkage arm 2432 and/or as a function of a displacement of a corresponding one or more actuators 2413 directly or indirectly coupled to the respective linkage arm 2432. In at least one example embodiment, the length of the corresponding linkage arm 2432 may provide a respectively different envelope of rotation, for example, while maintaining a common pitch angle range as between at least some of the plurality of airfoils 2402. Additionally, or in the alternative, the length of the corresponding linkage arm 2432 may provide a respectively different pitch angle range as between at least some of the plurality of airfoils 2402.

In at least one example embodiment, the plurality of airfoils 2402 shown in FIGS. 24E and 24F may include fan blades 254. In at least one example embodiment, the plurality of airfoils 2402 shown in FIGS. 24E and 24F may include guide vanes 262. In at least one example embodiment, a plurality of airfoils 2402 may have a uniform pitch angle as between respective ones of the plurality of airfoils 2402 at a first position of the one or more actuators 2413, and a non-unform pitch angle as between respective ones of the plurality of airfoils 2402 at a second position of the one or more actuators 2413. Additionally, or in the alternative, a plurality of airfoils 2402 may have a first non-uniform pitch angle as between respective ones of the plurality of airfoils 2402 at a first position of the one or more actuators 2413, and a second non-uniform pitch angle as between respective ones of the plurality of airfoils 2402 at a second position of the one or more actuators 2413.

In at least one example embodiment, one or more unitary actuators 2430 may provide a respectively different envelope of rotation for respective ones of a plurality of airfoils 2402, depending, for example, on the length of the linkage arm 2432 coupled directly or indirectly to a corresponding airfoil 2402. For example, the respectively different envelope of rotation of the plurality of airfoils 2402 may be realized by a corresponding plurality of unitary actuators 2430 that have a common stroke length. Additionally, or in the alternative, In at least one example embodiment, one or more ensemble actuators 2416 may provide a respectively different envelope of rotation for respective ones of a plurality of airfoils 2402, depending, for example, on the length of the linkage arm 2432 coupled directly or indirectly to a corresponding airfoil 2402. In at least one example embodiment, a fan actuation assembly 2405 may include a unitary actuator assembly 2428 that has a plurality of linkage arms 2432 of differing lengths relative to one another. At least some of the plurality of linkage arms 2432 may have a length that differs from at least another one of the plurality of linkage arms 2432. The one or more actuators 2413 may respectively include a unitary actuator 2430 directly or indirectly coupled to a corresponding one of the plurality of airfoils 2402.

In at least one example embodiment, the one or more actuators 2413 may be actuated responsive to an excitation load acting upon the turbofan engine 210. The excitation load may include an asymmetric load corresponding to one or more circumferential positions of respective ones of the plurality of airfoils 2402, and the envelope of rotation of the corresponding ones of the plurality of airfoils 2402 may be selected at least in part to offset the asymmetric load at least partially. Additionally, or in the alternative, In at least one example embodiment, the one or more actuators 2413 may be actuated to a first position during a cruise flight condition. The first position may correspond to an excitation load, such as an asymmetric load, which may exist during at least some cruise flight conditions. Additionally, or in the alternative, the one or more actuators 2413 may be actuated to a second position during at least one of: a climbing flight condition, a descending flight condition, and a takeoff flight condition. The second position may correspond to an excitation load, such as an asymmetric load, which may exist during at least some climbing, descending, and/or takeoff flight conditions. The envelope of rotation of the corresponding ones of the plurality of airfoils 2402 may be selected at least in part to allow the one or more actuators 2413 to be actuated to the first position during the cruise flight condition and/or to the second position during the climbing flight condition, the descending flight condition, and/or the takeoff flight condition.

In at least one example embodiment, the fan actuation assembly 2405 may include an ensemble actuator assembly 2414, a unitary actuator assembly 2428, and a plurality of linkage arms 2432 of differing lengths relative to one another. The plurality of linkage arms 2432 of differing lengths may be respectively coupled to a corresponding one of the plurality of unitary actuators 2430. In at least one example embodiment, a fan actuation assembly 2405 may include an ensemble actuator assembly 2414 and a plurality of linkage arms 2432 of different lengths relative to one another coupled to corresponding ones of the plurality of airfoils 2402 and/or to a corresponding airfoil retention mechanism 2408. For example, a fan actuation assembly 2405 may include a plurality of linkage arms 2432 of different lengths relative to one another, instead of, or without having, a unitary actuator assembly 2428. The ensemble actuator assembly may include a unison ring 2418 and the plurality of linkage arms 2432 may extend between the unison ring 2418 and the corresponding one of the plurality of airfoils 2402.

In at least one example embodiment, a plurality of linkage arms 2432 respectively corresponding to inversely disposed airfoils 2402 may have respective length that differs from one another. For example, a first linkage arm 2432 corresponding to a first airfoil 2402 at a circumferential position that has a horizontally leftward orientation (e.g., at a nine o'clock position) may have a first length that differs from a second length of a second linkage arm 2432 corresponding to a second airfoil 2402 at a circumferential position that has a horizontally rightward orientation (e.g., at a three o'clock position). In at least one example embodiment, a fan actuation assembly 2405 that has such a plurality of linkage arms 2432 of respectively differing lengths may be otherwise configured according to any one or more of the embodiments of a fan actuation assembly described herein, including those described with reference to FIGS. 24A-24D, 24G and 24H. Additionally, or in the alternative, In at least one example embodiment, inversely disposed guide vanes 262 may have respectively different geometry configured, for example to at least partially offset or compensate for an asymmetric load. Such respectively different geometry may include respectively different shapes, sizes, contours, chord lengths, camber lines, pitch angles (e.g., fixed or nominal pitch angles), and the like. For example, a first guide vane 262 that has a horizontally leftward orientation (e.g., a nine o'clock position) and a second guide vane 262 that has a horizontally rightward orientation (e.g., a three o'clock position) may have respectively different geometry configured to at least partially offset or compensate for an asymmetric load.

Referring now to FIGS. 24G and 24H, exemplary fan actuation assemblies 2405 are further described. As shown in FIGS. 24G and 24H, a fan actuation assembly 2405 may include a plurality of subgroup actuator assemblies 2440. Respective ones of the plurality of subgroup actuator assemblies 2440 may include a subgroup actuator 2442 that changes a pitch angle of a plurality of airfoils 2402 corresponding to an airfoil subgroup 2443. The respective pitch angles of the airfoils 2402 in the airfoil subgroup 2443 may be changed collectively, or as a group, by actuating the subgroup actuator 2442. A fan actuation assembly 2405 that includes a plurality of subgroup actuator assemblies 2440 may be otherwise configured according to any one or more of the embodiments of a fan actuation assembly described herein, including those described with reference to FIGS. 24A-24F.

The subgroup actuator 2442 corresponding to a respective subgroup actuator assembly 2440 may change the respective pitch angles of the airfoils 2402 and the corresponding subgroup responsive to control commands from the computing system 2300. The control commands from the computing system 2300 may cause the one or more subgroup actuators 2442 to change such pitch angles to augment and/or compensate for an excitation load acting upon the turbofan engine 210, such as an asymmetric load corresponding to a circumferential position of one or more of the fan blades 254 and/or one or more of the guide vanes 262.

A subgroup actuator 2442 may be directly or indirectly coupled to a plurality of airfoils 2402 or corresponding airfoil retention mechanisms 2408. The plurality of airfoils 2402 actable by a subgroup actuator 2442 coupled directly or indirectly thereto may define an airfoil subgroup 2443. In at least one example embodiment, a subgroup actuator assembly 2440 may include a subgroup coupling arm 2444 disposed between the subgroup actuator 2442 and the plurality of airfoils 2402 in the respective airfoil subgroup 2443. A subgroup coupling arm 2444 may be configured at least in part to directly or indirectly couple the airfoils 2402 in the respective airfoil subgroup 2443 to a corresponding subgroup actuator 2442. For example, the subgroup actuator 2442 may be coupled to the subgroup coupling arm 2444, and the subgroup coupling arm may be coupled directly or indirectly to the airfoils 2402 in the respective airfoil subgroup 2443. Additionally, or in the alternative, the subgroup actuator 2442, and/or the subgroup coupling arm 2444, may be coupled to a plurality of unitary actuators 2430 corresponding to respective ones of the plurality of airfoils 2402 in the subgroup. For example, a first end of respective ones of the plurality of unitary actuators 2430 may be respectively coupled to a corresponding airfoil 2402 or airfoil retention mechanism 2408, and a second end of the respective ones of the plurality of unitary actuators 2430 may be coupled to the corresponding subgroup coupling arm 2444. In at least one example embodiment, as shown, a plurality of linkage arms 2432 may be respectively disposed between the subgroup coupling arm 2444 and the corresponding unitary actuators 2430. For example, a first end of such linkage arms 2432 may be respectively coupled to a corresponding unitary actuator 2430, and a second end of such linkage arms 2432 may be coupled to the subgroup coupling arm 2444.

In at least one example embodiment, such as shown in FIG. 24G, respective ones of the plurality of subgroup actuators 2442 may be directly or indirectly coupled to a unison ring 2418, such as to an outward unison ring 2426. For example, a first end of a subgroup actuator 2442 may be coupled to a corresponding subgroup coupling arm 2444, and a second end of the subgroup actuator 2442 may be coupled to the unison ring 2418. In at least one example embodiment, such as depicted in FIG. 24H, for a plurality of subgroup actuator assemblies 2440 that change a pitch angle of a plurality of guide vanes 262 corresponding to the respective subgroup, the plurality of subgroup actuators 2442 may be directly or indirectly coupled to the engine core 218, such as to the engine case 2316.

Still referring to FIGS. 24G and 24H, In at least one example embodiment, a subgroup actuator assembly 2440 may include a subgroup linkage arm 2446. As shown in FIG. 4G, the subgroup linkage arm 2446 may be disposed between the subgroup coupling arm 2444 and the unison ring 2418. For example, a first end of the subgroup linkage arm 2446 may be coupled to the subgroup coupling arm 2444, and a second end of the subgroup linkage 2446 may be coupled to the unison ring 2418, such as to an outward unison ring 2426. As shown in FIG. 24H, the subgroup linkage arm 2446 may be disposed between the subgroup coupling arm 2444 and the engine core 218. For example, a first end of the subgroup linkage arm 2446 may be coupled to the subgroup coupling arm 2444, and a second end of the subgroup linkage 2446 may be coupled to the engine core 218, such as the engine case 2316.

It will be appreciated that the fan actuation assemblies shown in FIGS. 24A-24H schematically depict exemplary embodiments by way of example and are not to be limiting. In fact, various aspects of the present disclosure may be practiced with other suitable fan actuation assemblies. For example, In at least one example embodiment, a fan actuation assembly may include a swashplate mechanism. A swashplate mechanism may control cyclic rotation of a fan assembly 250 and/or pitch angles of the plurality of fan blades 254.

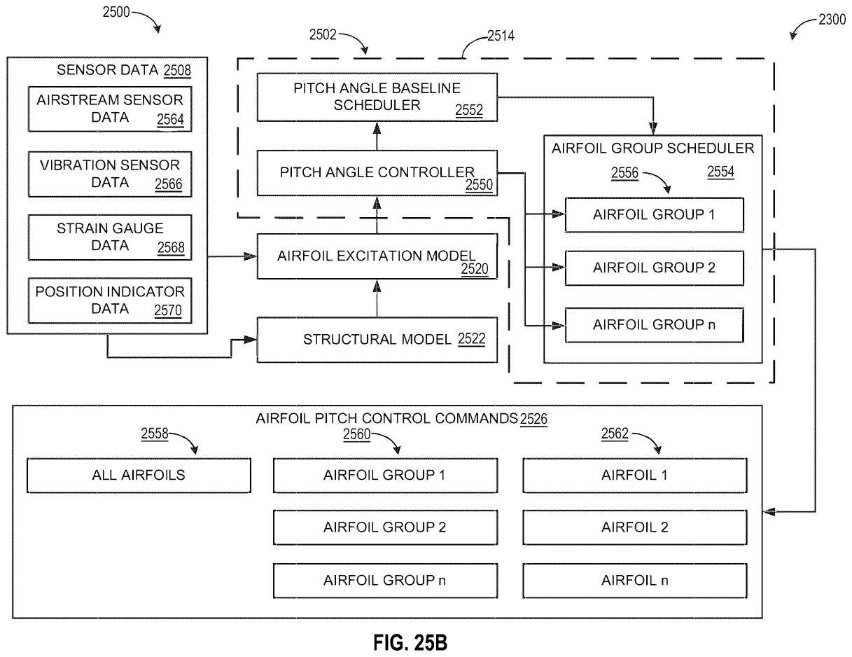

Referring now to FIGS. 25A and 25B, exemplary airfoil excitation control modules 2500 will be described. As shown in FIGS. 25A and 25B, an airfoil excitation control module 2500 may include one or more airfoil load models 2502. The airfoil excitation control module 2500 may receive one or more module inputs 2504. The one or more module inputs 2504 may be utilized by the one or more airfoil load models 2502 to provide one or more module outputs 2506. An airfoil excitation control module 2500 may determine an excitation load acting upon one or more airfoils 2402, such as one or more fan blades 254 and/or one or more of the guide vanes 262. Additionally, or in the alternative, an airfoil excitation control module 2500 may determine an excitation load acting upon one or more other portions of the turbofan engine 210, such as upon one or more bearing assemblies 2304 and/or upon an engine support structure 2308. The excitation load may include an asymmetric load.

The airfoil excitation control module 2500 may determine an excitation load based at least in part on the one or more module inputs 2504. For example, one more module inputs 2504 may be utilized by the one or more airfoil load models 2502 to determine the excitation load acting upon the one or more airfoils 2402. The airfoil excitation control module 2500 may provide module outputs 2506, for example, based at least in part on an excitation load determined by the one or more airfoil load models 2502. The module outputs 2506 may include control commands to one or more controllable components, such as control commands configured to change a pitch angle of one or more airfoils 2402, such as a pitch angle of one or more fan blades 254 and/or a pitch angle of one or more guide vanes 262. Such control commands may augment and/or compensate for an excitation load acting upon the turbofan engine 210, such as upon one or more airfoils 2402 (e.g., upon the one or more of the fan blades 254 and/or upon one or more of the guide vanes 262). Additionally, or in the alternative, such control commands may augment and/or compensate for an excitation load acting upon other portions of the turbofan engine 210, such as upon one or more bearing assemblies 2304 and/or upon an engine support structure 2308.

Exemplary module inputs 2504 that may be utilized by the one or more airfoil load models 2502 include sensor data 2508 generated or otherwise provided by one or more sensors 2210 associated with the aircraft 2200 and/or the one or more turbofan engines 210, condition monitoring data 2510 generated or otherwise provided by the condition monitoring system 2400, and/or electronic controller data 2512 generated or otherwise provided by one or more electronic controllers 2208 associated with the aircraft 2200 and/or the one or more turbofan engines 210, such as an electronic engine controller, a full-authority digital engine control (FADEC) device, or the like. The sensor data 2508 may be generated or otherwise provided by one or more sensors 2210, such as one or more aerodynamic incidence sensors 2212, one or more vibration sensors 2302, one or more strain gauges 2306, one or more position indicators 2312, and/or one or more pitch angle indicators 2314. The condition monitoring data 2510 may include vibration-based condition monitoring data associated with one or more of the turbofan engines 210. The condition monitoring data and/or the vibration-based condition monitoring data may include or may be determined based at least in part on sensor data 2508, such as data from one or more sensors 2210, such as one or more aerodynamic incidence sensors 2212, one or more vibration sensors 2302, one or more strain gauges 2306, one or more position indicators 2312, and/or one or more pitch angle indicators 2314. The electronic controller data 2512 may include data associated with one or more operating conditions of the aircraft 2200 and/or the one or more turbofan engines 210. The electronic controller data 2512 may include or may be determined based at least in part on sensor data 2508, such as data from one or more sensors 2210, such as one or more aerodynamic incidence sensors 2212, one or more vibration sensors 2302, one or more strain gauges 2306, one or more position indicators 2312, and/or one or more pitch angle indicators 2314. The sensor data 2508, the condition monitoring data 2510, and/or the electronic controller data 2512 may correspond to a current or previous operating period of the aircraft 2200 and/or the one or more turbofan engines 210, such as a current flight or a portion thereof, and/or one or more previous flights and/or a portion thereof.

In at least one example embodiment, the one or more airfoil load models 2502 may include one or more airfoil pitch angle control models 2514. An airfoil pitch angle control models 2514 may include one or more models, controllers, algorithms, lookup tables, or the like, configured to determine an excitation load acting upon one or more airfoils 2402, for example, based at least in part on the one or more module inputs 2504. Additionally, or in the alternative, an airfoil pitch angle control model 2514 may include one or more models, controllers, algorithms, lookup tables, or the like, configured to determine an excitation load translated from one or more airfoils 2402 to one or more other portions of the turbofan engine 210, such as to one or more bearing assemblies 2304 and/or to an engine support structure 2308. Additionally, or in the alternative, an airfoil pitch angle control model 2514 may include one or more models, controllers, algorithms, lookup tables, or the like, configured to determine one or more module outputs 2506, for example, based at least in part on an excitation load determined by an airfoil pitch angle control model 2514. One or more module outputs 2506 determined by an airfoil pitch angle control model 2514 may include control commands configured to augment and/or compensate for an excitation load.

In at least one example embodiment, the one or more airfoil pitch angle control models 2514 may include one or more fan blade pitch angle control models 2516. A fan blade pitch angle control model 2516 may include one or more models, controllers, algorithms, lookup tables, or the like, configured to determine an excitation load acting upon one or more of the fan blades 254, for example, based at least in part on the one or more module inputs 2504. Additionally, or in the alternative, the fan blade pitch angle control model 2516 may determine one or more module outputs 2506, for example, based at least in part on an excitation load acting upon the one or more fan blades 254. One or more module outputs determined by the fan blade pitch angle control model 2516 may include control commands configured to augment and/or compensate for an excitation load acting upon one or more of the fan blades 254. For example, as will be discussed in more detail below, in response to an excitation load in excess of a predetermined threshold on eth fan blades 254, the outlet guide vanes 262, or both, the fan blade pitch angle control model 2516 may provide airfoil pitch setpoints 2528, pitch change control commands 2530, or both to relieve the excitation loads.

In at least one example embodiment, the one or more airfoil pitch angle control models 2514 may include one or more guide vane pitch angle control models 2518. A guide vane pitch angle control model 2518 may include one or more models, controllers, algorithms, lookup tables, or the like, configured to determine an excitation load acting upon one or more of the guide vanes 262, for example, based at least in part on the one or more module inputs 2504. Additionally, or in the alternative, the guide vane pitch angle control model 2518 may determine one or more module outputs 2506, for example, based at least in part on an excitation load acting upon the one or more guide vanes 262. One or more module outputs determined by the guide vane pitch angle control model 2518 may include control commands configured to augment and/or compensate for an excitation load acting upon one or more of the guide vanes 262.

In at least one example embodiment, the one or more airfoil load models 2502 may include one or more airfoil excitation models 2520. An airfoil excitation model 2520 may include one or more models, controllers, algorithms, lookup tables, or the like, configured to determine one or more airfoil excitation phenomenon, and/or an excitation load corresponding to such airfoil excitation phenomenon. In at least one example embodiment, an airfoil excitation model 2520 may determine one or more airfoil excitation phenomenon, and/or an excitation load corresponding to such airfoil excitation phenomenon, based at least in part on sensor data generated by one or more aerodynamic incidence sensors 2212, such as one or more angle of attack sensors 2214 and/or one or more angle of sideslip sensors 2216. Additionally, or in the alternative, an airfoil excitation phenomenon and/or a corresponding excitation load may be determined based at least in part on sensor data generated by one or more vibration sensors 2302 and/or one or more strain gauges 2306. The airfoil excitation model 2520 may be, e.g., as noted above, a lookup table or set of lookup tables for various operating conditions that provides a certain output in response to the model inputs 504.

In at least one example embodiment, an airfoil excitation model 2520 may include one or more models, controllers, algorithms, lookup tables, or the like, configured to determine one or more aerostatic parameters, such as pitch stiffness, pitch moment, yaw moment, roll moment, lift, and the like. Pitch stiffness may be determined from a derivative of the ratio of the pitch moment to the aerodynamic incidence vector.

In at least one example embodiment, an airfoil excitation model 2520 may be utilized by one or more airfoil pitch angle control models 2514, such as the one or more fan blade pitch angle control models 2516 and/or by the one or more guide vane pitch angle control models 2518. For example, an excitation load acting upon one or more fan blades 254 may be determined by the fan blade pitch angle control model 2516 based at least in part on an airfoil excitation model 2520. Additionally, or in the alternative, an excitation load acting upon one or more guide vanes 262 may be determined by the guide vane pitch angle control model 2518 based at least in part on an airfoil excitation model 2520. Additionally, or in the alternative, the fan blade pitch angle control model 2516 and/or the guide vane pitch angle control model 2518 may determine one or more module outputs 2506 based at least in part on an airfoil excitation model 2520.

In at least one example embodiment, the airfoil excitation model 2520 may be configured to determine an asymmetric load. The asymmetric load may correspond to one or more circumferential positions of the one or more airfoils 2402. The asymmetric load may be determined based at least in part on sensor data generated by one or more aerodynamic incidence sensors 2212, such as one or more angle of attack sensors 2214 and/or one or more angle of sideslip sensors 2216, sensor data generated by one or more vibration sensors 2302, and/or sensor data generated by one or more strain gauges 2306. Such sensor data may be correlated to a circumferential position of the one or more airfoils 2402. For example, the circumferential position of the one or more airfoils 2402 may be determined based at least in part on sensor data from one or more position indicator 2312 that determine a circumferential position of the fan assembly 250 and/or a circumferential position of one or more fan blades 254 of the fan assembly 250. Additionally, or in the alternative the circumferential position of respective guide vanes 262 may be pre-associated with corresponding sensors 2210.

In at least one example embodiment, the one or more airfoil load models 2502 may include one or more structural models 2522. A structural model 2522 may determine one or more structural parameters associated with a plurality of airfoils 2402, such as one or more structural parameters of the fan blades 254 and/or the guide vanes 262. The structural parameters may include parameters associated with one or more material properties of one or more materials from which the plurality of airfoils 2402 are formed. Additionally, or in the alternative, the structural parameters may include parameters associated with the structural configuration of the plurality of airfoils 2402. The structural parameters may include parameters associated with a behavior of the plurality of airfoils 2402 in response to an excitation load, such as stress, strain, deflection, elasticity, stiffness, or the like. In at least one example embodiment, a structural model 2522, and/or one or more structural parameters determined by a structural model 2522, may be utilized by one or more of the other airfoil load models 2502, such as the one or more airfoil pitch angle control models 2514.

An airfoil excitation control module 2500 may provide module outputs 2506, for example, based at least in part on one or more of the airfoil load models 2502. The module outputs 2506 may be determined based at least in part on at least one of: a fan blade pitch angle control model 2516, a guide vane pitch angle control model 2518, and an airfoil excitation model 2520, and a structural model 2522. The module outputs 2506 may include setpoints, control commands, model parameters, or the like configured to control one or more controllable components of a turbofan engine 210 based at least in part on one or more module inputs 2504 and/or one or more airfoil load models 2502. The module outputs 2506 may include control commands configured to augment and/or compensate for airfoil excitation phenomenon, and/or excitation loads associated therewith. The airfoil excitation phenomenon may include autogenous excitations and/or cyclic excitations. The excitation loads associated with such airfoil excitation phenomenon may include an asymmetric load acting upon one or more airfoils 2402, upon one or more bearing assemblies 2304, and/or upon an engine support structure 2308.

In at least one example embodiment, the module outputs 2506 may include airfoil pitch control commands 2526. The airfoil pitch control commands 2526 may control a pitch angle of one or more airfoils 2402, such as a pitch angle of one or more fan blades 254 and/or a pitch angle of one or more guide vanes 262. The airfoil pitch control commands 2526 may include airfoil pitch setpoints 2528. The airfoil pitch setpoints 2528 may include setpoints for a pitch angle of one or more airfoils 2402, such as setpoints for a pitch angle of one or more fan blades 254 and/or setpoints for a pitch angle of one or more guide vanes 262. The setpoints for the pitch angle of the one or more airfoils 2402 may include setpoints for a position of one or more ensemble actuators 2416, setpoints for a position of one or more unitary actuators 2430, and/or setpoints for a position of one or more subgroup actuators 2442. The airfoil pitch setpoints 2528 may be determined based at least in part on the one or more airfoil load models 2502.

Additionally, or in the alternative, In at least one example embodiment, the airfoil pitch control commands 2526 may include pitch change control commands 2530. The pitch change control commands 2530 may include control commands configured to change a pitch angle of one or more airfoils 2402, such as a pitch angle of one or more fan blades 254 and/or a pitch angle of one or more guide vanes 262. The pitch change control commands 2530 may include control commands configured to change a position of one or more ensemble actuators 2416, a position of one or more unitary actuators 2430, and/or a position of one or more subgroup actuators 2442. The pitch change control commands 2530 may be determined based at least in part on the one or more airfoil load models 2502.

In at least one example embodiment, an airfoil load models 2502 may be configured to determine an asymmetric load, such as a cyclic load, acting upon the one or more airfoils 2402. The cyclic load may include an nP load, such as a 1P load. The module outputs 2506 may include control commands configured to augment and/or compensate for such asymmetric and/or cyclic load. The control commands may reduce the asymmetric load and/or offset the asymmetric load. For example, an asymmetric and/or cyclic load acting upon one or more fan blades 254 may be at least partially offset by changing the pitch angle of one or more guide vanes 262. For example, an nP load, such as a 1P load, acting upon one or more fan blades 254 may be at least partially offset by changing a pitch angle of one or more guide vanes 262. In at least one example embodiment, an nP load, such as a 1P load, acting upon one or more fan blades 254 at a circumferential position may be at least partially offset by changing a pitch angle of one or more guide vanes 262 at the circumferential position corresponding to the one or more fan blades 254. For example, an nP load, such as a 1P load, acting upon a fan blade 254 at circumferential position corresponding to a horizontally leftward orientation (e.g., at a nine o'clock position) may be at least partially offset by changing a pitch angle of a guide vane 262 at circumferential position that has a corresponding horizontally leftward orientation (e.g., at a nine o'clock position). Additionally, or in the alternative, an nP load, such as a 1P load, acting upon a fan blade 254 at circumferential position corresponding to a horizontally rightward orientation (e.g., at a three o'clock position) may be at least partially offset by changing a pitch angle of a guide vane 262 at circumferential position that has a corresponding horizontally rightward orientation (e.g., at a three o'clock position).

Additionally, or in the alternative, an asymmetric and/or cyclic load acting upon one or more airfoils 2402 may be at least partially augmented and/or compensated for by changing a pitch angle of one or more respectively inversely disposed airfoils 2402, such as one or more inversely disposed fan blades 254 and/or one or more inversely disposed guide vane 262. For example, a first airfoil 2402 and a second airfoil 2402 may be inversely disposed, and an asymmetric and/or cyclic load acting upon the first airfoil 2402 and/or the second airfoil 2402 may be augmented and/or compensated for by changing the pitch angle of the first airfoil 2402 and/or the second airfoil 2402. For example, an asymmetric load as between the first airfoil 2402 and/or the second airfoil 2402 may be at least partially offset by changing the pitch angle of the first airfoil 2402 and/or the second airfoil 2402. In at least one example embodiment, an nP load, such as a 1P load, acting upon one or more fan blades 254 may be at least partially offset by changing a pitch angle of one or more fan blades 254 and/or one or more guide vanes 262, that have an inversely disposed circumferential position. For example, an nP load, such as a 1P load, acting upon a fan blade 254 at circumferential position corresponding to a horizontally leftward orientation (e.g., at a nine o'clock position) may be at least partially offset by changing a pitch angle of another fan blade 254 and/or by changing a pitch angle of a guide vane 262 at circumferential position that has a horizontally rightward orientation (e.g., at a three o'clock position). Additionally, or in the alternative, an nP load, such as a 1P load, acting upon a fan blade 254 at circumferential position corresponding to a horizontally rightward orientation (e.g., at a three o'clock position) may be at least partially offset by changing a pitch angle of another fan blade 254 and/or by changing a pitch angle of a guide vane 262 at circumferential position that has a horizontally leftward orientation (e.g., at a nine o'clock position).

In at least one example embodiment, an airfoil load models 2502 may be configured to determine an autogenous load, such as an aeroelastic load and/or a gyroscopic load. The module outputs 2506 may include control commands configured to augment and/or compensate for such autogenous excitation. For example, an autogenous load acting upon one or more airfoils 2402 (e.g., one or more fan blades 254 and/or one or more guide vanes 262) may be at least partially reduced and/or offset for by changing the pitch angle of one or more of the airfoils 2402. Additionally, or in the alternative, the module outputs 2506 may include engine control commands 2532. The engine control commands 2532 may include control commands configured to change one or more operating parameters of a turbofan engine 210, based at least in part on the module outputs 2506 from the airfoil excitation control module 2500. The engine control commands 2532 may include control commands configured to change a fuel flow setting and/or a power output setting for a turbofan engine 210. In at least one example embodiment, one or more engine control commands 2532 may cause a turbofan engine 210 to recover from an airfoil excitation phenomena and/or an excitation load associated therewith. The engine control commands 2532 may be determined based at least in part on the one or more airfoil load models 2502. In at least one example embodiment, the engine control commands 2532 may include control commands, such as a reduced fuel flow setting and/or a reduced power output setting for an turbofan engine 210 providing propulsion for the aircraft 2200, configured to allow the aircraft 2200 and/or the turbofan engine 210 to recover from an autogenous load, such as an aeroelastic load and/or a gyroscopic load.

In at least one example embodiment, the module outputs 2506 may include model parameters 2534. For example, an airfoil excitation model 2520, and/or a structural model 2522, may provide one or more model parameters 2534 utilized by the fan blade pitch angle control model 2516 and/or by a guide vane pitch angle control model 2518. In at least one example embodiment, an airfoil excitation control module 2500, and/or one or more airfoil load models 2502, module inputs 2504, and/or module outputs 2506 corresponding to an airfoil excitation control module 2500, may be generated and/or updated, modified, adjusted, or the like from time to time, including, for example, periodically, in connection with a model development or training sequence, and/or in real-time.

In at least one example embodiment, an airfoil excitation control module 2500 may include a model trainer 2536. The model trainer 2536 may generate, update, modify, and/or adjust, one or more airfoil load models 2502, such as a fan blade pitch angle control model 2516, a guide vane pitch angle control model 2518, an airfoil excitation model 2520, and/or a structural model 2522. An exemplary model trainer 2536 may use any one or more various training or learning techniques such as backwards propagation of errors, which may include performing truncated backpropagation through time. In at least one example embodiment, supervised training techniques may be used on a set of labeled training data. The model trainer 2536 may perform a number of generalization techniques (e.g., weight decays, dropouts, etc.) to improve the generalization capability of the airfoil excitation control module 2500 being trained.

An exemplary model trainer 2536 may include a machine-learning model 2538. The model trainer 2536 may utilize one or more module inputs 2504 as inputs, including, for example, as inputs to a machine-learning model 2538. The model trainer 2536 may output one or more model adjustments 2540. The model adjustments 2540 may include a new airfoil load model 2502 and/or updates or adjustments to an airfoil load model 2502, such as updates to settings, values, and/or schedules already included in the airfoil load model 2502. Additionally, or in the alternative, the model adjustments 2540 may include new settings, values, and/or schedules to be included with or substituted for those already included in the airfoil load model 2502.

A machine-learning model 2538 may use any suitable machine learning technique, operating regime, or algorithm. A machine-learning model 2538 may use pattern recognition, computational learning, artificial intelligence, or the like to derive algorithms that allow the machine-learning model 2538 to generate and/or update one or more airfoil load models 2502. A machine-learning model 2538 may include an unsupervised or a supervised learning regime, including a semi-supervised learning regime, an active learning regime, a reinforcement learning regime, and/or a representation learning regime. A machine-learning model 2538 may utilize neural networks, decision trees, association rules, inductive logic algorithms, cluster analysis algorithms, and the like.

By way of example, the machine-learning model 2538 shown in FIG. 25A may include a neural network. However, an exemplary machine-learning model 2538 may include any other suitable model, including a linear discriminant analysis model, a partial least squares discriminant analysis model, a support vector machine model, a random tree model, a logistic regression model, a naïve Bayes model, a K-nearest neighbor model, a quadratic discriminant analysis model, an anomaly detection model, a boosted and bagged decision tree model, an artificial neural network model, a C4.5 model, a k-means model, and combinations thereof. Even further additional suitable types of machine or statistical learning models are also contemplated. It will also be appreciated that a machine-learning model 2538 can use certain mathematical methods alone or in combination with one or more machine or statistical learning models.

In addition to outputting a model adjustment 2540, in some embodiments a machine-learning model 2538 may output a confidence score 2542, which may provide an indication as to a level of confidence attributable to one or more outputs of the machine-learning model 2538. The confidence score 2542 may be used, for example, to set a margin of error to be used by the airfoil excitation control module 2500 in determining a model adjustment 2540. For example, in the event of a low confidence score 2542 the airfoil excitation control module 2500 may account for a more conservative or wide margin for error when determining a model adjustment 2540, whereas in the event of a high confidence score 2542 the airfoil excitation control module 2500 may allow for a more aggressive or narrow margin for error when determining a model adjustment 2540.

Referring now to FIG. 25B, exemplary airfoil excitation control modules 2500 are further described. The airfoil excitation control module 2500 shown in FIG. 25B may represent an exemplary embodiment encompassed by the subject matter described with reference to FIG. 25A. Additionally, or in the alternative, the airfoil excitation control module 2500 shown in FIG. 25B may include any one or more of the features described with reference to FIG. 25A. An airfoil excitation control module 2500 may include one or more airfoil load models 2502 configured to provide airfoil pitch control commands 2526 to one or more airfoils 2402, such as airfoil pitch setpoints 2528 and/or pitch change control commands 2530, as described, for example with reference to FIG. 25A. As shown, the one or more airfoil load models 2502 may include an airfoil pitch angle control model 2514. The airfoil pitch angle control model 2514 may include a fan blade pitch angle control model 2516 and/or a guide vane pitch angle control model 2518 (FIG. 25A). The airfoil pitch angle control model 2514 may provide airfoil pitch control commands 2526 to one or more airfoils 2402, such as one or more fan blades 254 and/or one or more guide vanes 262.

As shown in FIG. 25B, In at least one example embodiment, the airfoil pitch angle control model 2514 may include a pitch angle controller 2550. The pitch angle controller 2550 may determine pitch angle setpoints for the one or more airfoils and/or to provide control commands configured to control the pitch angle of the one or more airfoils 2402, for example, based at least in part on the pitch angle setpoints. For example, the pitch angle controller 2550 may determine airfoil pitch control commands 2526 for respective ones of the plurality of airfoils 2402. The pitch angle of the one or more airfoils 2402 may be controlled by the pitch angle controller 2550 based at least in part on sensor data 2508. Additionally, or in the alternative, the pitch angle controller 2550 may control the pitch angle of the one or more airfoils 2402 based at least in part on an input from an airfoil excitation model 2520 and/or an input from a structural model 2522. The airfoil excitation model 2520 and/or the structural model 2522 may provide input to the airfoil pitch angle control model 2514, such as to the pitch angle controller 2550, based at least in part on sensor data 2508.

In at least one example embodiment, the airfoil pitch angle control model 2514 may include a pitch angle baseline scheduler 2552. The pitch angle baseline scheduler 2552 may determine a baseline schedule for the pitch angle of the one or more airfoils 2402 and/or to provide control commands configured control the pitch angle of the one or more airfoils 2402. The baseline schedule may include a nominal schedule of pitch angles for the one or more airfoils 2402. In at least one example embodiment, the baseline schedule may include pitch angle setpoints and/or control commands configured to change a pitch angle of the one or more airfoils 2402, such as all of the airfoils 2402 and/or a subset or group of the airfoils 2402, based at least in part on such a nominal schedule. In at least one example embodiment, a baseline schedule may be predetermined. Additionally, or in the alternative, the pitch angle baseline scheduler 2552 may determine a baseline schedule based at least in part on sensor data 2508, and/or based at least in part on an input from an airfoil excitation model 2520 and/or an input from a structural model 2522. Such an input from the airfoil excitation model 2520 and/or the structural model 2522 may be determined based at least in part on the sensor data 2508. In at least one example embodiment, the airfoil pitch control commands 2526 determined by the pitch angle controller 2550 may include changes to a baseline schedule determined by the pitch angle baseline scheduler 2552. The changes to the baseline schedule may be determined for one or more of the plurality of airfoils 2402.

In at least one example embodiment, the airfoil pitch angle control model 2514 may include an airfoil group scheduler 2554. The airfoil group scheduler 2554 may determine a plurality of airfoil groups 2556 and/or to associate respective ones of the plurality of airfoils 2402 to a respective one of the plurality of airfoil groups 2556. The respective airfoil groups 2556 may include one or more airfoils 2402, such as a plurality of airfoils 2402. A respective airfoil group 2556 may include one or more fan blades 254 and/or one or more guide vanes 262. In at least one example embodiment, a pitch angle baseline scheduler 2552 may determine a baseline schedule for one or more airfoil groups 2556. Additionally, or in the alternative, the airfoil group scheduler 2554 may associate a baseline schedule with one or more airfoil groups 2556. In at least one example embodiment, a pitch angle controller 2550 may provide airfoil pitch control commands 2526 to the one or more airfoil groups 2556. Additionally, or in the alternative, the airfoil group scheduler 2554 may associate airfoil pitch control commands 2526 with one or more airfoil groups 2556. Additionally, or in the alternative, In at least one example embodiment, the airfoil pitch control commands 2526 may be determined based at least in part on the airfoil group scheduler 2554, such as a respective one of the plurality of airfoil groups 2556 to which respective ones of the plurality of airfoils 2402 may be allocated. For example, the airfoil pitch control commands 2526 may include airfoil pitch setpoints 2528 and/or pitch change control commands 2530 determined based at least in part on respective ones of the plurality of airfoil groups 2556 determined by the airfoil group scheduler 2554.

The plurality of airfoils 2402 in a respective airfoil group 2556 may include circumferentially adjacent airfoils 2402. Additionally, or in the alternative, plurality of airfoils 2402 in a respective airfoil group 2556 may include airfoils 2402 located at an inversely disposed circumferential position, such as a circumferentially opposite position and/or an approximately circumferentially opposite position. Such inversely disposed circumferential positions may include positions circumferentially-spaced from one another by about π-radians, such as by π-radians+/−(1/2)-π-radians, such as by π-radians+/−(1/3)-π-radians, such as by π-radians+/−(1/4)-π-radians, or such as by π-radians+/−(1/6)-π-radians.

In at least one example embodiment, the airfoil group scheduler 2554 may augment an allocation of airfoils 2402 among respective ones of the plurality of airfoil groups 2556. For example, the airfoil group scheduler 2554 may change (e.g., increase and/or decrease) a number of airfoils 2402 allocated to a respective airfoil group 2556, and/or to allocate airfoils 2402 to a different airfoil group 2556. Additionally, or alternatively, the airfoil group scheduler 2554 may change (e.g., increase and/or decrease) a number of airfoil groups 2556. In at least one example embodiment, the airfoil group scheduler 2554 may associate respective ones of the plurality of fan blades 254 with respective ones of the plurality of guide vanes 262, for example, based at least in part on a circumferential position. A respective fan blade 254 may be associated with respectively different ones of the plurality of guide vanes 262 as the respective fan blade 254 rotate about the longitudinal axis 212 of the fan assembly 250.

Referring still to FIG. 25B, the airfoil pitch control commands 2526 may include collective control commands 2558 provided to all airfoils 2402, such as all fan blades 254 and/or all guide vanes 262. Additionally, or in the alternative, the airfoil pitch control commands 2526 may include group control commands 2560 provided to a group of airfoils 2402, such as a group of fan blades 254, a group of guide vanes 262, or a group of fan blades 254 and guide vanes 262. The group control commands 2560 may be provided to respective ones of the plurality of airfoil groups 2556. Additionally, or in the alternative, the airfoil pitch control commands 2526 may include singular control commands 2562 provided to an individual airfoil 2402, such as a fan blades 254 or a guide vane 262. The singular control commands 2562 may be provided to respective ones of the plurality of airfoils 2402.

In at least one example embodiment, the collective control commands 2558 may be configured to actuate one or more course actuator mechanism 2434 (e.g., the first actuator mechanism 2436 shown in FIG. 24D). Additionally, or in the alternative, the group control commands 2560 may be configured to actuate one or more course actuator mechanism 2434. Additionally, or in the alternative, the singular control commands 2562 may be configured to actuate one or more fine actuator mechanism 2434 (e.g., the second actuator mechanism 2438 shown in FIG. 24D).

The sensor data 2508 utilized by the airfoil excitation control module 2500 may include airstream sensor data 2564. The airstream sensor data 2564 may include data from one or more aerodynamic incidence sensors 2212. Additionally, or in the alternative, the sensor data 2508 may include vibration sensor data 2566. The vibration sensor data 2566 may include data from one or more vibration sensors 2302. Additionally, or in the alternative, the sensor data 2508 may include strain gauge data 2568. The strain gauge data 2568 may include data from one or more strain gauges 2306. Additionally, or in the alternative, the sensor data 2508 may include position indicator data 2570. The position indicator data 2570 may include data from one or more position indicators 2312. The sensor data 2508, such as the airstream sensor data 2564, the vibration sensor data 2566, the strain gauge data 2568, and/or the position indicator data 2570, may be utilized by the airfoil excitation control module 2500 to provide airfoil pitch control commands 2526 as described herein.

In at least one example embodiment, airfoil pitch control commands 2526 determined, for example, by the pitch angle baseline scheduler 2552 and/or the pitch angle controller 2550, may corresponding to one or more circumferential positions about the longitudinal axis 212 of the fan assembly 250. For example, the airfoil pitch control commands 2526 for a plurality of fan blades 254 may include airfoil pitch setpoints 2528 and/or pitch change control commands 2530 (FIG. 25A) configured to augment the pitch angle of the plurality of fan blades 254 with respect to circumferential position as the respective fan blades 254 rotate about the longitudinal axis 212 of the fan assembly 250. The pitch angle of the plurality of fan blades 254 may be augmented with respect to circumferential position according to a baseline schedule determined by the pitch angle baseline scheduler 2552 and/or according to changes to the baseline schedule determined by the pitch angle controller 2550. Additionally, or in the alternative, the pitch angle of the plurality of fan blades 254 may be augmented according to pitch angle setpoints and/or control commands without reference to a baseline schedule.

As another example, the airfoil pitch control commands 2526 for a plurality of guide vanes 262 may include airfoil pitch setpoints 2528 and/or pitch change control commands 2530 (FIG. 25A) configured to provide differing pitch angles for respectively different circumferential position of the plurality of guide vanes 262 in relation to the longitudinal axis 212 of the fan assembly 250. The differing pitch angles of the plurality of guide vanes 262 with respect to circumferential position may be provided according to a baseline schedule determined by the pitch angle baseline scheduler 2552 and/or according to changes to the baseline schedule determined by the pitch angle controller 2550. Additionally, or in the alternative, the differing pitch angles of the plurality of guide vanes 262 may be provided according to pitch angle setpoints and/or control commands without reference to a baseline schedule.

In at least one example embodiment, the airfoil pitch control commands 2526 for the plurality of airfoils 2402 (e.g., the plurality of fan blades 254 and/or the plurality of guide vanes 262) may provide for a respectively different pitch angle as between inversely disposed circumferential positions, such as circumferentially opposite positions and/or approximately circumferentially opposite positions. Such inversely disposed circumferential positions may include positions circumferentially-spaced from one another by about π-radians, such as by π-radians+/−(1/2)-π-radians, such as by π-radians+/−(1/3)-π-radians, such as by π-radians+/−(1/4)-π-radians, or such as by π-radians+/−(1/6)-π-radians. For example, a first airfoil 2402 (e.g., a first fan blade 254 or a first guide vane 262) may have a larger pitch angle than the pitch angle of a second airfoil 2402 (e.g., a second fan blade 254 or a second guide vane 262) inversely disposed from such first airfoil 2402. The first airfoil 2402 may have a larger pitch angle than the second airfoil 2402, for example, with respect to one or more first circumferential positions. Additionally, or in the alternative, the first airfoil 2402 may have a smaller pitch angle than the pitch angle of the second airfoil 2402, for example, with respect to one or more second circumferential positions.

By way of example, the first airfoil 2402 may have a circumferential position corresponding to about a horizontally leftward orientation (e.g., a nine o'clock position) and second airfoil 2402 may have a circumferential position corresponding to about a horizontally rightward orientation (e.g., a three o'clock position). The horizontally leftward orientation may be from about a seven o'clock position to about an eleven o'clock position, such as from about an eight o'clock position to about a ten o'clock position. The horizontally rightward orientation may be from about a one o'clock position to about a five o'clock position, such as from about a two o'clock position to about a four o'clock position. As another example, the first airfoil 2402 may have a circumferential position corresponding to about a vertically upward orientation (e.g., a twelve o'clock position) and second airfoil 2402 may have a circumferential position corresponding to about a vertically downward orientation (e.g., a six o'clock position). The vertically upward orientation may be from about a ten o'clock position to about a two o'clock position, such as from about an eleven o'clock position to about a one o'clock position. The vertically downward position may be from about a four o'clock position to about an eight o'clock position, such as from about a five o'clock position to about a seven o'clock position. With respect to a plurality of fan blades 254, the first fan blade 254 and/or the second fan blade 254 may respectively exhibit such a circumferential position at a corresponding point in time as the plurality of fan blades 254 rotate about the longitudinal axis of the fan assembly 250. With respect to a plurality of guide vanes 262, the first guide vane 262 and/or the second guide vane 262 may be fixed at respective circumferential positions about the longitudinal axis of the fan assembly 250. Notably, the phrase “from an X o'clock position to a Y o'clock position” includes “between X o‘clock and Y o’clock.”

In at least one example embodiment, by way of illustration, for a fan assembly 250 rotating counterclockwise (as viewed from an afterward reference point), the airfoil pitch control commands 2526 may provide for respective ones of a plurality of fan blades 254 to exhibit a relatively smaller pitch angle at a circumferential position corresponding to about a horizontally leftward orientation (e.g., a 9 o'clock position), as compared to an inversely disposed one of the plurality of fan blades 254. The airfoil pitch control commands 2526 may provide for respective ones of the plurality of fan blades 254 to exhibit a relatively larger pitch angle at a circumferential position corresponding to about a horizontally rightward orientation (e.g., a 3 o'clock position), as compared to an inversely disposed one of the plurality of fan blades 254.

Additionally, or in the alternative, the airfoil pitch control commands 2526 may provide for respective ones of the plurality of airfoils 2402 to exhibit a relatively smaller pitch angle, as compared to an inversely disposed one of the plurality of fan blades 254, at a circumferential position corresponding to from about an upward vertical orientation (e.g., a 12 o'clock position) to about a downward vertical position (e.g., a 6 o'clock position), for example, when rotating from about the upward vertical orientation to about the downward vertical position. The airfoil pitch control commands 2526 may provide for respective ones of the plurality of fan blades 254 to exhibit a relatively larger pitch angle, as compared to an inversely disposed one of the plurality of fan blades 254, when the respective fan blade 254 has a circumferential position of from about a downward vertical position (e.g., a 6 o'clock position) to about an upward vertical orientation (e.g., a 12 o'clock position), for example, when rotating from about the downward vertical position to about the upward vertical orientation.

Additionally, or in the alternative, the airfoil pitch control commands 2526 may provide for the pitch angle of respective ones of a plurality of fan blades 254 to increase when rotating from a circumferential position corresponding to about a horizontally leftward orientation (e.g., a 9 o'clock position) to a circumferential position corresponding to about, as compared to an inversely disposed one of the plurality of fan blades 254. The airfoil pitch control commands 2526 may provide for respective ones of the plurality of fan blades 254 to a horizontally rightward orientation (e.g., a 3 o'clock position). The airfoil pitch control commands 2526 may provide for the pitch angle of respective ones of a plurality of fan blades 254 to decrease when rotating from a circumferential position corresponding to about a horizontally rightward orientation (e.g., a 3 o'clock position) to a circumferential position corresponding to about a horizontally leftward orientation (e.g., a 9 o'clock position).

In at least one example embodiment, the airfoil pitch control commands 2526 for a plurality of airfoils 2402 (e.g., a plurality of fan blades 254 and/or a plurality of guide vanes 262) may include pitch angle setpoints and/or control commands configured to augment and/or compensate for an airfoil excitation phenomena and/or an excitation load associated therewith, such as an asymmetric load corresponding to one or more circumferential positions of the respective airfoils 2402. For example, the airfoil pitch control commands 2526 may compensate for different excitation loads as between one or more circumferential positions of the respective airfoils 2402. In at least one example embodiment, the airfoil pitch control commands 2526 for the plurality of airfoils 2402 (e.g., the plurality of fan blades 254 and/or the plurality of guide vanes 262) may provide for a respectively different pitch angle as between inversely disposed circumferential positions, such as circumferentially opposite positions and/or approximately circumferentially opposite positions, and the respectively different pitch angles may be determined at least in part to augment and/or compensate for respective excitation loads as between such inversely disposed circumferential positions.

In at least one example embodiment, airfoil pitch control commands 2526 for a plurality of guide vanes 262 may augment and/or compensate for an excitation load acting upon one or more of the plurality of fan blades 254. In at least one example embodiment, the airfoil pitch control commands 2526 may include pitch angle setpoints and/or control commands for one or more of the plurality of guide vanes 262 determined based at least in part on an excitation load acting upon a corresponding one or more of the plurality of fan blades 254. The corresponding one or more of the plurality of fan blades 254 may be located at a circumferential position corresponding to the respective one of the plurality of guide vanes 262. Additionally, or in the alternative, the corresponding one of the plurality of fan blades 254 may be located at an inversely disposed circumferential position, such as a circumferentially opposite position and/or an approximately circumferentially opposite position. For example, the pitch angle of respective guide vane 262 may at least partially compensate for and/or offset an excitation load acting upon a fan blade located at an inversely disposed circumferential positions relative to the respective guide vane 262. Such inversely disposed circumferential positions may include positions circumferentially-spaced from one another by about π-radians, such as by π-radians+/−(1/2)-π-radians, such as by π-radians+/−(1/3)-π-radians, such as by π-radians+/−(1/4)-π-radians, or such as by π-radians+/−(1/6)-π-radians.

For example, the airfoil pitch control commands 2526 may include pitch angle setpoints and/or control commands for a first guide vane 262 located at a circumferential position corresponding to about a horizontally leftward orientation (e.g., a nine o'clock position), and the pitch angle setpoints and/or control commands may be determined based at least in part on an excitation load acting upon a first fan blade 254 located at a circumferential position corresponding to about a horizontally rightward orientation (e.g., a three o'clock position). The pitch angle setpoints and/or control commands for the first guide vane 262 may be determined at least in part to compensate and/or offset the load acting upon the first fan blade 254. The airfoil pitch control commands 2526 may include pitch angle setpoints and/or control commands for a second guide vane 262 located at a circumferential position corresponding to about a horizontally rightward orientation (e.g., a three o'clock position), and the pitch angle setpoints and/or control commands may be determined based at least in part on an excitation load acting upon a second fan blade 254 located at a circumferential position corresponding to about a horizontally leftward orientation (e.g., a nine o'clock position). The pitch angle setpoints and/or control commands for the second guide vane 262 may be determined at least in part to compensate and/or offset the load acting upon the second fan blade 254. The horizontally leftward orientation may be from about a seven o'clock position to about an eleven o'clock position, such as from about an eight o'clock position to about a ten o'clock position. The horizontally rightward orientation may be from about a one o'clock position to about a five o'clock position, such as from about a two o'clock position to about a four o'clock position.

As another example, the airfoil pitch control commands 2526 may include pitch angle setpoints and/or control commands for a third guide vane 262 located at a circumferential position corresponding to about a vertically upward orientation (e.g., a twelve o'clock position), and the pitch angle setpoints and/or control commands may be determined based at least in part on an excitation load acting upon a third fan blade 254 located a circumferential position corresponding to about a vertically downward orientation (e.g., a six o'clock position). The pitch angle setpoints and/or control commands for the third guide vane 262 may be determined at least in part to compensate and/or offset the load acting upon the third fan blade 254. The airfoil pitch control commands 2526 may include pitch angle setpoints and/or control commands for a fourth guide vane 262 located at a circumferential position corresponding to about a vertically downward orientation (e.g., a six o'clock position), and the pitch angle setpoints and/or control commands may be determined based at least in part on an excitation load acting upon a fourth fan blade 254 located a circumferential position corresponding to about a vertically upward orientation (e.g., a twelve o'clock position). The pitch angle setpoints and/or control commands for the fourth guide vane 262 may be determined at least in part to compensate and/or offset the load acting upon the fourth fan blade 254. The vertically upward orientation may be from about a ten o'clock position to about a two o'clock position, such as from about an eleven o'clock position to about a one o'clock position. The vertically downward position may be from about a four o'clock position to about an eight o'clock position, such as from about a five o'clock position to about a seven o'clock position. The respective fan blades 254 may exhibit such a circumferential position at a corresponding point in time as the plurality of fan blades 254 rotate about the longitudinal axis of the fan assembly 250. The respective guide vanes 262 may be fixed at respective circumferential positions about the longitudinal axis of the fan assembly 250. One or more examples are described below with respect to FIG. 25B.

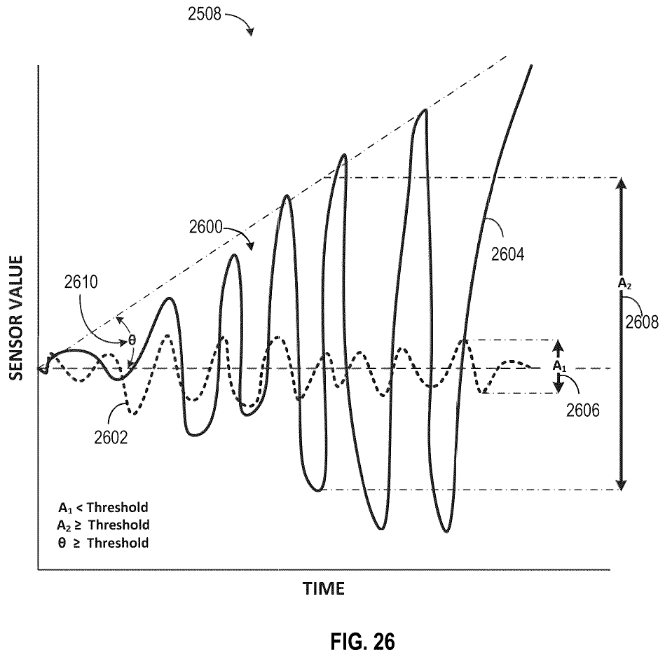

Referring now to FIG. 26, exemplary sensor data 2508 will be described. FIG. 62 shows sensor values 2600 for sensor data 2508 as a function of time. The sensor data 2508 shown in FIG. 26 may correspond to any of the one or more sensors 2210. In at least one example embodiment, the sensor data 2508 shown in FIG. 26 may include vibration sensor data 2566 from one or more vibration sensors 2302. Additionally, or in the alternative, the sensor data 2508 shown in FIG. 26 may include strain gauge data 2568 from one or more strain gauges 2306. As shown in FIG. 26, the sensor data 2508 may exhibit a variation in sensor values 2600 as a function of time. The variation in sensor values 2600 may be indicative of an airfoil excitation phenomena, such as an autogenous excitation (e.g., an aeroelastic excitation and/or a gyroscopic excitation). For example, the variation in sensor values 2600 may be indicative of airfoil flutter attributable to the fan assembly 250. Additionally, or in the alternative, the sensor data 2508 may exhibit sensor values 2600 indicative of nominal operating conditions. An airfoil excitation phenomena, such as an autogenous excitation, may be distinguished from nominal operating conditions based at least in part on an amplitude and/or a change in amplitude of the sensor values 2600 over a frame of reference, such as a time interval. Additionally, or in the alternative, an airfoil excitation phenomena may be distinguished from nominal operating conditions based at least in part on a frequency and/or a change in frequency of the sensor values 2600 over a frame of reference, such as a time interval.

For example, FIG. 26 shows first sensor data values 2602 and second sensor data values 2604. As shown, the first sensor data values 2602 may have a first amplitude 2606 that is less than a threshold value. The first amplitude 2606 being less than the threshold value may indicate that the first sensor data values correspond to nominal operating conditions. Also as shown, the second sensor data values 2604 may have a second amplitude 2608 that is greater than a threshold value. The second amplitude 2608 being greater than the threshold value may indicate that the second sensor data values 2604 correspond to an airfoil excitation phenomena, such as an autogenous excitation (e.g., an aeroelastic excitation and/or a gyroscopic excitation). Additionally, or in the alternative, an airfoil excitation phenomena may be distinguished from nominal operating conditions based at least in part on a slope of the sensor values 2600 over a frame of reference, such as a time interval. For example, the second sensor data values 2604 shown in FIG. 26 exhibit a slope (θ) 2610 that exceeds a threshold value. The slope (θ) 2610 of the second sensor data values 2604 being greater than the threshold value may indicate that the second sensor data values 2604 correspond to an airfoil excitation phenomena, such as an autogenous excitation (e.g., an aeroelastic excitation and/or a gyroscopic excitation).

In at least one example embodiment, an airfoil load model 2502, such as an airfoil excitation model 2520 (FIGS. 25A and 25B), may determine an airfoil excitation phenomena based at least in part on an amplitude (e.g., the second amplitude 2608) and/or a slope (θ) 2610 of the sensor values 2600, as shown, for example in FIG. 26. The airfoil load model 2502 may provide one or more model outputs 2506 based at least in part on an airfoil excitation phenomena, such as determined based at least in part on an amplitude (e.g., the second amplitude 2608) and/or a slope (θ) 2610 of the sensor values 2600. For example, the model outputs may include airfoil pitch control commands 2526 and/or engine control commands 2532. In at least one example embodiment, the airfoil pitch control commands 2526 may reduce, offset, compensate for, and/or remediate the airfoil excitation phenomenon. For example, In at least one example embodiment, a change in pitch angle to one or more airfoils 2402 may reduce, offset, compensate for, and/or remediate such an airfoil excitation phenomena. Additionally, or alternatively, an airfoil excitation phenomena may be reduced, offset, compensated for, and/or remediated at least in part by one or more engine control commands 2532. For example, the one or more engine control commands 2532 may change one or more operating parameters of the turbofan engine 210, such as a fuel flow setting and/or a power output setting. The change to the one or more operating parameters of the turbofan engine 210 may reduce, offset, compensate for, and/or remediate the airfoil excitation phenomenon at least in part by providing separation from a natural resonant frequency of the fan assembly 250 (e.g., the plurality of fan blades 254) and/or the fan guide vane array 260 (e.g., the plurality of guide vanes 262). Additionally, or in the alternative, the change to the one or more operating parameters of the turbofan engine 210 may reduce, offset, compensate for, and/or remediate the airfoil excitation phenomenon at least in part by offsetting and/or compensating for an asymmetric load with respect to the fan assembly 250 (e.g., the plurality of fan blades 254) and/or the fan guide vane array 260 (e.g., the plurality of guide vanes 262).

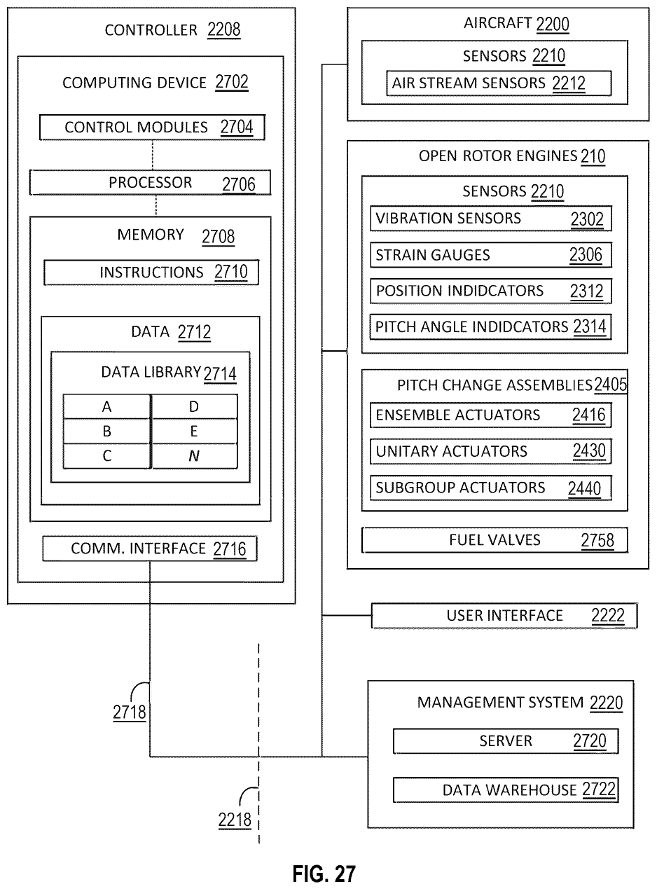

Referring now to FIG. 27, exemplary computing systems 2300 are further described. An exemplary computing system 2300 may be utilized to monitor and/or control various features of an aircraft 2200, such as various features of a turbofan engine 210, as described herein. The computing system 2300 may perform any desired control operations in accordance with the present disclosure, such as those described with reference to FIGS. 25A and 25B.

As shown in FIG. 27, an exemplary computing system 2300 may include an electronic controller 2208, such as an electronic engine controller, a full-authority digital engine control (FADEC) device, or the like. The electronic controller 2208 may include one or more computing devices 2702 configured to perform specified control operations. The one or more computing devices 2702 may be located locally or remotely relative to the one or more turbofan engines 210. The control operations may include determining, generating, transmitting, and/or receiving module inputs 2504. For example, the control operations may include determining, generating, transmitting, and/or receiving sensor data 2508 from one or more sensors 2210. Additionally, or in the alternative, the control operations may include determining, generating, transmitting, and/or receiving module outputs 2506. For example, the control operations may include determining, generating, transmitting, and/or receiving airfoil pitch control commands 2526, for example, based at least in part on the module inputs 2504, such as the sensor data 2508. The module outputs 2506 and/or the airfoil pitch control commands 2526 may be transmitted to one or more controllable components, such as one or more fan actuation assemblies 2405 (e.g., a fan actuation system 258 and/or a guide vane-fan actuation assembly 2406).

The computing device 2702 may be communicatively coupled with the one or more sensors 2210 and/or with the one or more controllable components, such as the one or more fan actuation assemblies 2405. The computing device 2702 may include one or more control modules 2704 configured to cause the electronic controller 2208 to perform the one or more control operations, for example, based at least in part on one or more models, lookup tables, or the like.

The one or more computing devices 2702 may include one or more processors 2706 and one or more memory devices 2708. The one or more processors 2706 may include any suitable processing device, such as a microprocessor, microcontroller, integrated circuit, logic device, and/or other suitable processing device. The one or more memory devices 2708 may include one or more computer-readable media, including but not limited to non-transitory computer-readable media, RAM, ROM, hard drives, flash drives, and/or other memory devices 2708. The one or more control modules 2704 may be implemented at least in part by the one or more processors 2706 and/or the one or more memory devices 2708.

As used herein, the terms “processor” and “computer” and related terms, such as “processing device” and “computing device”, are not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. A memory device 708 may include, but is not limited to, a non-transitory computer-readable medium, such as a random-access memory (RAM), and computer-readable nonvolatile media, such as hard drives, flash memory, and other memory devices. Alternatively, a floppy disk, a compact disc-read only memory (CD-ROM), a magneto-optical disk (MOD), and/or a digital versatile disc (DVD) may also be used.

As used herein, the term “non-transitory computer-readable medium” is intended to be representative of any tangible computer-based device implemented in any method or technology for short-term and long-term storage of information, such as, computer-readable instructions, data structures, program modules and sub-modules, or other data in any device. The methods described herein may be encoded as executable instructions embodied in a tangible, non-transitory, computer readable media, including, without limitation, a storage device, and/or a memory device. Such instructions, when executed by a processor, cause the processor to perform at least a portion of the methods described herein. Moreover, as used herein, the term “non-transitory computer-readable medium” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The one or more memory devices 2708 may store information accessible by the one or more processors 2706, including computer-executable instructions 2710 that can be executed by the one or more processors 2706. The instructions 2710 may include any set of instructions which when executed by the one or more processors 2706 cause the one or more processors 2706 to perform operations, including control operations. The one or more memory devices 2708 may store data 2712 accessible by the one or more processors 2706, such as data associated with the aircraft 2200, the one or more turbofan engines 210, and/or the one or more electronic controllers 2208 associated therewith. The data 2712 may include the sensor data 2508. The data 2712 may include current or real-time data 2712, past data 2712, or a combination thereof. The data 2712 may be stored in a data library 2714. The data 2712 may also include other data sets, parameters, outputs, information, associated with the aircraft 2200, the one or more turbofan engine 210, and/or the one or more electronic controllers 2208 associated therewith.

The one or more computing devices 2702 may also include a communication interface 2716 configured to communicate with various nodes on a communication network 2218 via wired or wireless communication lines 2718. The communication interface 2716 may include any suitable components for interfacing with one or more network(s), including for example, transmitters, receivers, ports, controllers, antennas, and/or other suitable components. The communication network 2218 may include, for example, a local area network (LAN), a wide area network (WAN), SATCOM network, VHF network, a HF network, a Wi-Fi network, a WiMAX network, a gatelink network, and/or any other suitable communication network 2218 for transmitting messages to and/or from the computing device 2702 across the communication lines 2718. The communication lines 2718 of communication network 2218 may include a data bus or a combination of wired and/or wireless communication links.

The one or more electronic controllers 2208 may be communicatively coupled, for example, by way of the communication network 2218, with one or more components of the aircraft 2200 and/or with one or more components of the one or more turbofan engines 210 with respect to which the one or more electronic controllers 2208 may communicate. For example, the one or more electronic controllers 2208 may be communicatively coupled with one or more sensors, 2210, such as one or more aerodynamic incidence sensors 2212. Additionally, or in the alternative, the one or more electronic controllers 2208 may be communicatively coupled with one or more vibration sensors 2302, one or more strain gauges 2306, one or more position indicators 2312, and/or one or more pitch angle indicators 2314. Additionally, or in the alternative, the one or more electronic controllers 2208 may be communicatively coupled with one or more controllable components, such as one or more actuators associated with a fan actuation assembly. For example, the one or more electronic controllers 2208 may be communicatively coupled with one or more ensemble actuators 2416, one or more unitary actuators 2430, and/or one or more subgroup actuators 2442. Additionally, or in the alternative, the one or more electronic controllers 2208 may be communicatively coupled with one or more fuel valves 2758.

The computing system 2300 may include a management system 2220 located locally or remotely relative to the aircraft 2200 and/or the one or more turbofan engines 210. The management system 2220 may include a server 2720 and/or a data warehouse 2722. As an example, at least a portion of the data 2712 may be stored in the data warehouse 2722, and the server 2720 may transmit data 2712 from the data warehouse 2722 to the one or more computing device 2702, and/or to receive data 2712 from the one or more computing devices 2702 and to store the received data 2712 in the data warehouse 2722 for further purposes. The server 2720 and/or the data warehouse 2722 may be implemented as part of the one or more computing devices 2702 and/or as part of the management system 2220. The computing system 2300 may also include a user interface 2222 configured to allow a user to interact with the various features of the computing system 2300, for example, by way of the communication interface 2716. The communication interface 2716 may allow the one or more computing devices 2702 to communicate with various nodes associated with the aircraft 2200, the one or more turbofan engine 210, the management system 2220, and/or the user interface 2222.

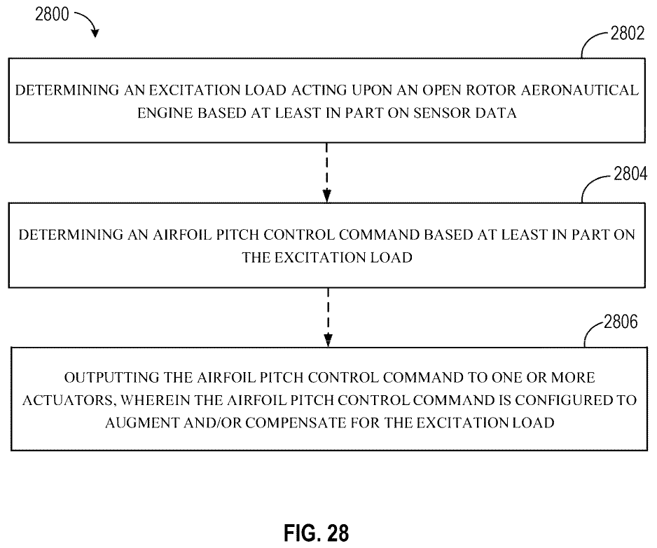

Referring now to FIG. 28, exemplary methods 2800 of operating a turbofan engine 210 are described. In addition, or in the alternative, to operating an turbofan engine 210, the exemplary methods 2800 described with reference to FIG. 28 may be utilized to operate a fan actuation assembly 2405 (e.g., a fan actuation system 258 and/or a guide vane-pitch change assembly 2406), such as those described with reference to FIGS. 24A-24H. Additionally, or in the alternative, the exemplary methods 2800 described with reference to FIG. 28 may be utilized to operate an airfoil excitation control module 2500 and/or one or more airfoil load models 2502 thereof, such as those described with reference to FIGS. 25A-25B. Additionally, or in the alternative, the exemplary methods 2800 described with reference to FIG. 28 may be utilized to operate a computing system 2300 and/or one or more electronic controllers 2208, such as those described with reference to FIG. 27.

As shown in FIG. 28, an exemplary method 2800 may include, at block 2802, determining an excitation load acting upon an open rotor aeronautical engine based at least in part on the sensor data. At block 2804, an exemplary method 2800 may include, determining an airfoil pitch control command based at least in part on the excitation load. The airfoil pitch control command may be configured to cause an actuator to change a pitch angle of at least one of a plurality of unducted airfoils of the open rotor aeronautical engine. At block 2806, an exemplary method 2800 may include outputting the airfoil pitch control command to one or more actuators. The one or more actuators may be actuatable to change the pitch angle of at least one of the plurality of unducted airfoils The airfoil pitch control command may be configured to augment and/or compensate for the excitation load acting upon the open rotor aeronautical engine.

In one or more of these embodiments, a threshold power or disk loading for a fan (e.g., an unducted single rotor or primary forward fan) may range from 25 horsepower per square foot (hp/ft²) or greater at cruise altitude during a cruise flight condition. In particular embodiments of the engine, structures and methods provided herein generate power loading between 80 hp/ft² and 160 hp/ft² or higher at cruise altitude during a cruise flight condition.

In various embodiments, an engine of the present disclosure is applied to a vehicle with a cruise altitude up to approximately 65,000 ft. In certain embodiments, cruise altitude is between approximately 28,000 ft and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 psia and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

As such, it will be appreciated that an engine of such a configuration may generate at least about 25,000 pounds and less than about 80,000 of thrust during operation at a rated speed, such as between about 25,000 and 50,000 pounds of thrust during operation at a rated speed, such as between about 25,000 and 40,000 pounds of thrust during operation at a rated speed.

In various exemplary embodiments, the fan may include twelve (12) fan blades. From a loading standpoint, such a blade count may allow a span of each blade to be reduced such that the overall diameter of the primary fan may also be reduced (e.g., to about twelve feet in one exemplary embodiment). That said, in other embodiments, the fan may have any suitable blade count and any suitable diameter. In certain suitable embodiments, the fan includes at least eight (8) blades. In another suitable embodiment, the fan may have at least twelve (12) blades. In yet another suitable embodiment, the fan may have at least fifteen (15) blades. In yet another suitable embodiment, the fan may have at least eighteen (18) blades. In one or more of these embodiments, the fan includes twenty-six (26) or fewer blades, such as twenty (20) or fewer blades.

Further, in certain exemplary embodiments, the rotor assembly may define a rotor diameter (or fan diameter) of at least 10 feet, such as at least 11 feet, such as at least 12 feet, such as at least 13 feet, such as at least 15 feet, such as at least 17 feet, such as up to 28 feet, such as up to 26 feet, such as up to 24 feet, such as up to 18 feet.

In various embodiments, it will be appreciated that the engine includes a ratio of a quantity of vanes to a quantity of blades that could be less than, equal to, or greater than 1:1. For example, in particular embodiments, the engine includes twelve (12) fan blades and ten (10) vanes. In other embodiments, the vane assembly includes a greater quantity of vanes to fan blades. For example, in particular embodiments, the engine includes ten (10) fan blades and twenty-three (23) vanes. For example, in certain embodiments, the engine may include a ratio of a quantity of vanes to a quantity of blades between 1:2 and 5:2. The ratio may be tuned based on a variety of factors including a size of the vanes to ensure a desired amount of swirl is removed for an airflow from the primary fan.

Additionally, in certain exemplary embodiments, where the engine includes the third stream and a mid-fan (a ducted fan aft of the primary, forward fan), a ratio R1/R2 may be between about 1 and 10, or 2 and 7, or at least about 3.3, at least about 3.5, at least about 4 and less than or equal to about 7, where R1 is the radius of the primary fan and R2 is the radius of the mid-fan.

It should be appreciated that various embodiments of the engine, such as the single unducted rotor engine depicted and described herein, may allow for normal subsonic aircraft cruise altitude operation at or above Mach 0.5. In certain embodiments, the engine allows for normal aircraft operation between Mach 0.55 and Mach 0.85 at cruise altitude. In still particular embodiments, the engine allows for normal aircraft operation between Mach 0.75 and Mach 0.85. In certain embodiments, the engine allows for rotor blade tip speeds at or less than 750 feet per second (fps). In other embodiments, the rotor blade tip speed at a cruise flight condition can be 650 to 900 fps, or 700 to 800 fps.

A fan pressure ratio (FPR) for the fan of the fan assembly can be 1.04 to 1.20, or in some embodiments 1.05 to 1.1, or in some embodiments less than 1.08, as measured across the fan blades at a cruise flight condition.

In order for the gas turbine engine to operate with a fan having the above characteristics to define the above FPR, a gear assembly may be provided to reduce a rotational speed of the fan assembly relative to a driving shaft (such as a low pressure shaft coupled to a low pressure turbine). In at least one example embodiment, a gear ratio of the input rotational speed to the output rotational speed is greater than 4.1. For example, in particular embodiments, the gear ratio is within a range of 4.1 to 14.0, within a range of 4.5 to 14.0, or within a range of 6.0 to 14.0. In certain embodiments, the gear ratio is within a range of 4.5 to 12 or within a range of 6.0 to 11.0. As such, In at least one example embodiment, the fan may rotate at a rotational speed of 700 to 1500 rpm at a cruise flight condition, while the power turbine (e.g., the low-pressure turbine) may rotate at a rotational speed of 2,500 to 15,000 rpm at a cruise flight condition. In particular embodiments, the fan can rotate at a rotational speed of 850 to 1,350 rpm at a cruise flight condition, while the power turbine may rotate at a rotational speed of 5,000 to 10,000 rpm at a cruise flight condition.

With respect to a turbomachine of the gas turbine engine, the compressors and/or turbines can include various stage counts. As disclosed herein, the stage count includes the number of rotors or blade stages in a particular component (e.g., a compressor or turbine). For example, In at least one example embodiment, a low pressure compressor may include 1 to 8 stages, a high-pressure compressor may include 8 to 15 stages, a high-pressure turbine may include 1 to 2 stages, and/or a low pressure turbine (LPT) may include 3 to 7 stages. In particular, the LPT may have 4 stages, or between 4 and 7 stages. For example, in certain embodiments, an engine may include a one stage low pressure compressor, an 11 stage high pressure compressor, a two stage high pressure turbine, and 4 stages, or between 4 and 7 stages for the LPT. As another example, an engine can include a three stage low-pressure compressor, a 10 stage high pressure compressor, a two stage high pressure turbine, and a 7 stage low pressure turbine.

A core engine is generally encased in an outer casing defining one half of a core diameter (Dcore), which may be thought of as the maximum extent from a centerline axis (datum for R). In certain embodiments, the engine includes a length (L) from a longitudinally (or axial) forward end to a longitudinally aft end. In various embodiments, the engine defines a ratio of L/Dcore that provides for reduced installed drag. In one embodiment, L/Dcore is at least 2. In another embodiment, L/Dcore is at least 2.5. In at least one example embodiment, the L/Dcore is less than 5, less than 4, and less than 3. In various embodiments, it should be appreciated that the L/Dcore is for a single unducted rotor engine.

The reduced installed drag may further provide for improved efficiency, such as improved specific fuel consumption. Additionally, or alternatively, the reduced drag may provide for cruise altitude engine and aircraft operation at the above describe Mach numbers at cruise altitude. Still particular embodiments may provide such benefits with reduced interaction noise between the blade assembly and the vane assembly and/or decreased overall noise generated by the engine by virtue of structures located in an annular duct of the engine.

Although depicted as an unshrouded or open rotor engine in the embodiments depicted in FIGS. 22-23 above, it should be appreciated that aspects of the disclosure provided herein may be applied to shrouded or ducted engines, partially ducted engines, aft-fan engines, or other gas turbine engine configurations, including those for marine, industrial, or aero-propulsion systems. Certain aspects of the disclosure may be applicable to turbofan, turboprop, or turboshaft engines. However, it should be appreciated that certain aspects of the disclosure may address issues that may be particular to unshrouded or open rotor engines, such as, but not limited to, issues related to gear ratios, fan diameter, fan speed, length (L) of the engine, maximum diameter of the core engine (Dcore) of the engine, L/Dcore of the engine, desired cruise altitude, and/or desired operating cruise speed, or combinations thereof.

Further aspects of the disclosure are provided by the subject matter of the following clauses:

Further aspects are provided by the subject matter of the following clauses.

A turbofan engine for an aircraft, the turbofan engine comprising a fan having a plurality of fan blades, each of the plurality of fan blades being rotatable about a pitch axis, and a fan actuation system including one or more actuators for rotating the plurality of fan blades about the pitch axis and one or more radial thrust bearings, wherein the fan actuation system is characterized by a fan actuation system envelope in a range from 300 to 1860, the fan actuation system envelope being given by:

$$\frac{{N}_{FB} \times {D}_{FT} \times {M}_{cruise}}{( \frac{{R}_{TB}}{{N}_{FB}} )}$$

wherein N_{FB} is a number of the plurality of fan blades, D_{FT} is a fan tip diameter of the plurality of fan blades, M_{cruise} is a Mach number of the aircraft at cruise operating conditions, and R_{TB} is a thrust bearing radius of the one or more radial thrust bearings.

A turbofan engine for an aircraft, the turbofan engine comprising a fan having a plurality of fan blades, each of the plurality of fan blades being rotatable about a pitch axis, a nacelle that circumferentially surrounds the fan, and a fan actuation system including one or more actuators for rotating the plurality of fan blades about the pitch axis and one or more radial thrust bearings, wherein the fan actuation system is characterized by a fan actuation system envelope in a range from 300 to 660, the fan actuation system envelope being given by:

$$\frac{{N}_{FB} \times {D}_{FT} \times {M}_{cruise}}{( \frac{{R}_{TB}}{{N}_{FB}} )}$$

wherein N_{FB} is a number of the plurality of fan blades, D_{FT} is a fan tip diameter of the plurality of fan blades, Mcruise is a Mach number of the aircraft at cruise operating conditions, and R_{TB} is a thrust bearing radius of the one or more thrust bearings.

A turbofan engine for an aircraft, the turbofan engine comprising a fan having a plurality of fan blades, the fan being an open fan, and each of the plurality of fan blades being rotatable about a pitch axis, and a fan actuation system including one or more actuators for rotating the plurality of fan blades about the pitch axis and one or more radial thrust bearings, wherein the fan actuation system is characterized by a fan actuation system envelope in a range from 660 to 1860, the fan actuation system envelope being given by:

$$\frac{{N}_{FB} \times {D}_{FT} \times {M}_{cruise}}{( \frac{{R}_{TB}}{{N}_{FB}} )}$$

wherein N_{FB} is a number of the plurality of fan blades, D_{FT} is a fan tip diameter of the plurality of fan blades, Mcruise is a Mach number of the aircraft at cruise operating conditions, and R_{TB} is a thrust bearing radius of the one or more radial thrust bearings.

The turbofan engine of any preceding clause, wherein the fan actuation system includes a hydraulic system that supplies hydraulic fluid for rotating the plurality of fan blades about the pitch axis.

The turbofan engine of any preceding clause, wherein the cruise operating conditions occur at a mid-level power range of the turbofan engine.

The turbofan engine of the preceding clause, wherein the mid-level power range is 30% to 85% of a sea level static maximum engine rated thrust for the turbofan engine.

The turbofan engine of any preceding clause, wherein the turbofan engine is rated for use on a regional aircraft having a maximum takeoff thrust of 10,000 lbf to 20,000 lbf.

The turbofan engine of any preceding clause, wherein the turbofan engine is rated for use on a narrow body aircraft having a maximum takeoff thrust of 15,000 lbf to 30,000 lbf.

The turbofan engine of any preceding clause, wherein the turbofan engine is rated for use on a wide body aircraft having a maximum takeoff thrust of 40,000 lbf to 110,000 lbf.

The turbofan engine of any preceding clause, wherein N_{FB} is in a range from ten to eighteen.

The turbofan engine of any preceding clause, wherein N_{FB} is in a range from ten to fourteen.

The turbofan engine of any preceding clause, wherein D_{FT} is in a range from 84.0 inches to 180.0 inches.

The turbofan engine of any preceding clause, wherein D_{FT} is in a range from 84.0 inches to 120.0 inches.

The turbofan engine of any preceding clause, wherein D_{FT} is in a range from 120.0 inches to 168.0 inches.

The turbofan engine of any preceding clause, wherein R_{TB} is in a range from 14 inches to 27 inches.

The turbofan engine of any preceding clause, wherein R_{TB} is in a range from 14 inches to 19 inches.

The turbofan engine of any preceding clause, wherein R_{TB} is in a range from 19 inches to 27 inches.

The turbofan engine of any preceding clause, wherein M_{cruise} is in a range from 0.7 to 0.92.

The turbofan engine of any preceding clause, wherein M_{cruise} is in a range from 0.75 to 0.9.

The turbofan engine of any preceding clause, wherein M_{cruise} is in a range from 0.8 to 0.88.

The turbofan engine of any preceding clause, wherein the fan actuation system includes a pressurized pneumatic chamber that is filled with a pressurized gas that biases the plurality of fan blades to a feather position.

The turbofan engine of any preceding clause, wherein the fan actuation system is devoid of counterweights for reducing inertial loading associated with rotation of fan blades.

The turbofan engine of any preceding clause, further comprising core cowl, wherein the turbofan engine has a longitudinal centerline axis, and the core cowl is annular about the longitudinal centerline axis.

The turbofan engine of the preceding clause, further comprising a core inlet that is annular about the longitudinal centerline axis.

The turbofan engine of any preceding clause, further comprising a gearbox assembly, wherein the turbine section includes a low-pressure shaft, and the fan has a fan shaft that is coupled to the low-pressure shaft through the gearbox assembly.

The turbofan engine of the preceding clause, wherein the gearbox assembly has a gear ratio in a range 3.5:1 to 5:1 for a ducted engine.

The turbofan engine of any preceding clause, wherein the gearbox assembly has a gear ratio in a range from 4:1 and 10:1 for an unducted fan engine.

The turbofan engine of any preceding clause, wherein the low-pressure shaft, the gearbox assembly, and the fan shaft are coaxial along the longitudinal centerline axis.

The turbofan engine of any preceding clause, wherein the fan actuation system envelope is in a range from 660 to 1020.

The turbofan engine of any preceding clause, the fan actuation system envelope being in a range from 300 to 660.

The turbofan engine of any preceding clause, the fan actuation system envelope being in a range from 660 to 1860.

The turbofan engine of any preceding clause, the fan actuation system envelope being in a range from 660 to 1020.

The turbofan engine of any preceding clause, further comprising a nacelle that circumferentially surrounds the fan.

The turbofan engine of any preceding clause, wherein the turbofan engine is an open fan engine.

The turbofan engine of any preceding clause, further comprising a fan hub, the plurality of fan blades extending radially from the fan hub.

The turbofan engine of any preceding clause, the fan actuation system being disposed within the fan hub.

The turbofan engine of any preceding clause, further comprising a compressor section, a combustor, and a turbine section.

The turbofan engine of any preceding clause, the compressor section including a low-pressure compressor and a high-pressure compressor, and the turbine section including a high-pressure turbine and a low-pressure turbine.

The turbofan engine of any preceding clause, further comprising a high-pressure shaft that couples the high-pressure compressor and the high-pressure turbine.

The turbofan engine of any preceding clause, further comprising a low-pressure shaft that couples the low-pressure compressor and the low-pressure turbine.

The turbofan engine of any preceding clause, the low-pressure shaft being disposed through the high-pressure shaft.

The turbofan engine of any preceding clause, the gearbox assembly comprising a gear assembly comprising a plurality of gears.

The turbofan engine of any preceding clause, the gearbox assembly including one or more gear bearings.

The turbofan engine of any preceding clause, each of the plurality of fan blades extending from a fan root to a fan tip.

The turbofan engine of any preceding clause, the fan tip diameter DFT being defined from the longitudinal centerline axis to the fan tip of each of the plurality of fan blades.

The turbofan engine of any preceding clause, the fan actuation system including a trunnion mechanism that includes a plurality of trunnions, each fan blade being disposed in a respective trunnion.

The turbofan engine of any preceding clause, the fan blades extending from a disk.

The turbofan engine of any preceding clause, the disk including a plurality of disk segments.

The turbofan engine of any preceding clause, each fan blade being coupled to a respective disk segment at the trunnion mechanism.

The turbofan engine of any preceding clause, the plurality of trunnions being rotatable to rotate the plurality of fan blades about the pitch axis.

The turbofan engine of any preceding clause, the fan actuation system including one or more actuators coupled to the plurality of trunnions.

The turbofan engine of any preceding clause, the fan actuation system including a plurality of trunnion links and a unison ring, the plurality of trunnion links being coupled to the plurality of trunnions and to the unison ring.

The turbofan engine of any preceding clause, the plurality of trunnion links including a plurality of forward trunnion links and a plurality of aft trunnion links.

The turbofan engine of any preceding clause, the unison ring including a plurality of unison rings including a forward unison ring that is positioned forward of the plurality of trunnions and an aft unison ring that is disposed aft of the plurality of trunnions.

The turbofan engine of any preceding clause, the plurality of forward trunnion links being coupled to the forward unison ring.

The turbofan engine of any preceding clause, the plurality of aft trunnion links being coupled to the aft unison ring.

The turbofan engine of any preceding clause, further comprising a plurality of pins that couple the plurality of trunnion links to the unison ring.

The turbofan engine of any preceding clause, the plurality of forward trunnion links being coupled to the forward unison ring by a plurality of forward pins.

The turbofan engine of any preceding clause, the plurality of aft trunnion links being coupled to the aft unison ring by a plurality of aft pins.

The turbofan engine of any preceding clause, the one or more actuators including a hydraulic cylinder and a piston disposed within the hydraulic cylinder.

The turbofan engine of the preceding clause, the hydraulic cylinder and the piston being movable along an axial direction.

The turbofan engine of any preceding clause, the forward unison ring being coupled to the hydraulic cylinder such that the forward unison ring moves when the hydraulic cylinder moves.

The turbofan engine of any preceding clause, the aft unison ring being coupled to the piston such that the aft unison ring moves as the piston moves.

The turbofan engine of any preceding clause, the fan actuation system rotating the plurality of fan blades between a first end position and a second end position.

The turbofan engine of any preceding clause, the first end position being a feather position in which the plurality of fan blades is substantially aligned with a flow of a volume of air across the plurality of fan blades.

The turbofan engine of the preceding clause, the fan actuation system rotating the plurality of fan blades to any position between the first end position and the second end position.

The turbofan engine of any preceding clause, the second end positioned being a reverse position in which the plurality of fan blades exceeds a plane that is transverse to the longitudinal centerline axis by at least 300 to assist with braking the aircraft.

The turbofan engine of any preceding clause, the fan actuation system moving the hydraulic cylinder in a first direction and moving the piston in a second direction.

The turbofan engine of any preceding clause, movement of the hydraulic cylinder and the piston causing the plurality of fan blades to rotate about the pitch axis.

The turbofan engine of any preceding clause, the one or more actuators including a piston retainer.

The turbofan engine of the preceding clause, the piston retainer being coupled to the fan shaft such that the piston retainer rotates with the fan shaft.

The turbofan engine of any preceding clause, the piston being coupled to the piston retainer such that the piston rotates with the piston retainer.

The turbofan engine of any preceding clause, the hydraulic cylinder being axially slidable with respect to the piston and the piston retainer.

The turbofan engine of any preceding clause, the piston retainer comprising a first portion, a second portion that extends radially outward from the first portion, and a third portion that extends axially from the second portion.

The turbofan engine of any preceding clause, the third portion of the piston retainer being coupled to the fan shaft.

The turbofan engine of any preceding clause, the piston being coupled to, and extending forward from, the first portion of the piston retainer.

The turbofan engine of any preceding clause, the hydraulic cylinder being disposed radially outward of the piston retainer and the piston.

The turbofan engine of any preceding clause, the hydraulic cylinder being coupled to the unison ring at a joint such that movement of the hydraulic cylinder in the axial direction causes the plurality of fan blades to pitch about the pitch axis.

The turbofan engine of any preceding clause, the hydraulic cylinder having a first portion, a second portion, a third portion, and a fourth portion.

The turbofan engine of the preceding clause, the first portion of the hydraulic cylinder extending generally in the axial direction and being coupled to the unison ring at the joint.

The turbofan engine of any preceding clause, the second portion of the hydraulic cylinder being disposed radially inward of the first portion and being coupled to the first portion and to the unison ring at the joint.

The turbofan engine of any preceding clause, the third portion of the hydraulic cylinder extending forward from the joint.

The turbofan engine of any preceding clause, the fourth portion of the hydraulic cylinder being coupled to, and extending axially within, the third portion of the hydraulic cylinder.

The turbofan engine of any preceding clause, the first portion of the hydraulic cylinder being sealingly engaged with the third portion of the piston retainer.

The turbofan engine of any preceding clause, the second portion of the piston retainer being sealingly engaged with the first portion of the hydraulic cylinder.

The turbofan engine of any preceding clause, the piston being sealingly engaged with the second portion and the fourth portion of the hydraulic cylinder.

The turbofan engine of any preceding clause, the fan actuation system including one or more hydraulic chambers defined between the hydraulic cylinder, the piston, and the piston retainer.

The turbofan engine of the preceding clause, the one or more hydraulic chambers including a first hydraulic chamber, a second hydraulic chamber, and a third hydraulic chamber.

The turbofan engine of any preceding clause, the first hydraulic chamber being defined between first portion of the hydraulic cylinder, the second portion of the piston retainer, and the third portion of the piston retainer.

The turbofan engine of any preceding clause, the second hydraulic chamber being defined between the first portion of the hydraulic cylinder, the second portion of the hydraulic cylinder, the first portion of the piston retainer, and the second portion of the piston retainer.

The turbofan engine of any preceding clause, the third hydraulic chamber being defined between the second portion of the hydraulic cylinder, an aft end of the piston, and the first portion of the piston retainer,

The turbofan engine of any preceding clause, the first hydraulic chamber and the third hydraulic chamber being supplied with a hydraulic fluid at a first pressure, and the second hydraulic chamber being supplied with the hydraulic fluid at a second pressure.

The turbofan engine of any preceding clause, the first pressure and the second pressure being increased or decreased to cause the hydraulic cylinder to move axially forward or axially rearward to rotate the plurality of fan blades about the pitch axis.

The turbofan engine of any preceding clause, the fan actuation system comprising a hydraulic system that supplies the hydraulic fluid to the one or more hydraulic chambers.

The turbofan engine of any preceding clause, the hydraulic system including a pump to supply the hydraulic fluid to the one or more hydraulic chambers.

The turbofan engine of the preceding clause, the hydraulic system comprising an oil transfer bearing including a fixed portion with a plurality of fluid lines coupled to the pump.

The turbofan engine of the preceding clause, the oil transfer bearing including a sleeve that is rotatable about the fixed portion.

The turbofan engine of any preceding clause, the plurality of fluid lines including a first fluid line in fluid communication with the first hydraulic chamber, a second fluid line in fluid communication with the second hydraulic chamber, and a third fluid line in fluid communication the third hydraulic chamber.

The turbofan engine of any preceding clause, the plurality of fluid lines being coupled to the sleeve.

The turbofan engine of any preceding clause, the first hydraulic chamber and the third hydraulic chamber being provided with the hydraulic fluid at the same first pressure.

The turbofan engine of any preceding clause, the pump supplying the hydraulic fluid to the first hydraulic chamber and the third hydraulic chamber to increase the first pressure P1 and supplying the hydraulic fluid to the second hydraulic chamber to decrease the second pressure P2, to move the hydraulic cylinder in the rearward direction to rotate the plurality of fan blades towards the reverse position.

The turbofan engine of any preceding clause, the pump supplying the hydraulic fluid to the second hydraulic chamber to increase the second pressure P2 and supplying the hydraulic fluid to the first hydraulic chamber and the third hydraulic chamber to decrease the first pressure P1, to move the hydraulic cylinder in the forward direction to rotate the plurality of fan blades towards the feather position.

The turbofan engine of any preceding clause, the one or more actuators further comprising a pressurized pneumatic chamber filled with a pressurized gas to bias the hydraulic cylinder to move the plurality of fan blades to the feather position.

The turbofan engine of any preceding clause, a pressure of the pressurized gas in the pressurized pneumatic chamber being in a range from 720 psi to 920 psi.

The turbofan engine of any preceding clause, the pressurized gas in the pressurized pneumatic chamber causing the hydraulic cylinder to move rearward when the hydraulic system or the turbofan engine fails or is shut down.

The turbofan engine of any preceding clause, the fan actuation system not including a pitch lock device.

The turbofan engine of any preceding clause, the one or more radial thrust bearings being disposed between the plurality of trunnions and the disk such that the plurality of trunnions rotates with respect to the disk to rotate the plurality of fan blades about the pitch axis.

The turbofan engine of any preceding clause, the one or more radial thrust bearings transmitting a load from the plurality of fan blades to a static structure of the turbofan engine.

A turbofan engine for an aircraft, the turbofan engine including a fan having a plurality of fan blades coupled to a fan shaft having one or more fan bearings, each of the plurality of fan blades being rotatable about a pitch axis and extending from a fan hub, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 24, the fan actuation system length envelope being given by

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

The turbofan engine of the preceding clause, wherein the fan actuation system includes a pressurized pneumatic chamber that is filled with a pressurized gas that biases the plurality of fan blades to a feather position.

The turbofan engine of any preceding clause, wherein the fan actuation system includes one or more counterweights for reducing inertial loading associated with rotation of the plurality of fan blades.

The turbofan engine of any preceding clause, further comprising a core cowl, wherein the turbofan engine has a longitudinal centerline axis, and the core cowl is annular about the longitudinal centerline axis wherein the core cowl includes a core inlet that is annular about the longitudinal centerline axis.

The turbofan engine of any preceding clause, wherein the fan actuation system includes a hydraulic system that supplies hydraulic fluid for rotating the plurality of fan blades about the pitch axis.

The turbofan engine of any preceding clause, wherein N_{FB} is in a range from ten to eighteen.

The turbofan engine of any preceding clause, wherein N_{FB} is in a range from ten to fourteen.

The turbofan engine of any preceding clause, wherein D_{FT} is in a range from 84.0 inches to 180.0 inches.

The turbofan engine of any preceding clause, wherein D_{FT} is in a range from 84.0 inches to 120.0 inches.

The turbofan engine of any preceding clause, wherein D_{FT} is in a range from 120.0 inches to 180.0 inches.

The turbofan engine of any preceding clause, wherein R_{TB} is in a range from 12 inches to 27 inches.

The turbofan engine of any preceding clause, wherein R_{TB} is in a range from 12 inches to 19 inches.

The turbofan engine of any preceding clause, wherein R_{TB} is in a range from 19 inches to 27 inches.

The turbofan engine of any preceding clause, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings.

The turbofan engine of any preceding clause, wherein A_{FH} is in a range from 25 inches to 75 inches.

The turbofan engine of any preceding clause, wherein A_{FB} is in a range from 16 inches to 23 inches.

The turbofan engine of any preceding clause, wherein the fan actuation system has a fan actuation system axial length (A_{FAS}) defined from an axially forward-most surface of the fan actuation system to the pitch axis of the plurality of fan blades, A_{FAS} being a maximum of 80% A_{FH}.

A turbofan engine for an aircraft, the turbofan engine including a fan having a plurality of fan blades coupled to a fan shaft having one or more fan bearings, each of the plurality of fan blades being rotatable about a pitch axis and extending from a fan hub, a nacelle that circumferentially surrounds the fan, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 13, the fan actuation system length envelope being given by

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{F}H is in a range from 25 inches to 40 inches, and A_{FB} is in a range from 17 inches to 20 inches.

A turbofan engine for an aircraft, the turbofan engine including a fan having a plurality of fan blades coupled to a fan shaft having one or more fan bearings, the fan being an open fan, and each of the plurality of fan blades being rotatable about a pitch axis and extending from a fan hub, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 24, the fan actuation system length envelope being given by

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{F}H is in a range from 25 inches to 75 inches, and A_{FB} is in a range from 16 inches to 23 inches, and D_{FT} is in a range from 120.0 inches to 180.0 inches.

The turbofan engine of the preceding clause, wherein R_{TB} is in a range from 12 inches to 27 inches.

A turbofan engine for an aircraft, the turbofan engine including a fan having a plurality of fan blades coupled to a fan disk that is drivingly coupled to a fan shaft, the fan disk defining a disk bore, a fan hub that directs an airflow through the plurality of fan blades, each of the plurality of fan blades being rotatable about a pitch axis and extending from the fan hub, one or more fan bearings that support rotation of the fan shaft, the one or more fan bearings being positioned radially outward of the disk bore, wherein a fan bearing radius ratio is in a range from 1.0 to 2.75, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

The turbofan engine of the preceding clause, wherein the turbofan engine has a fan hub radius ratio in a range from 0.1 to 0.4.

The turbofan engine of any preceding clause, wherein the one or more radial thrust bearings are tapered roller bearings.

The turbofan engine of any preceding clause, wherein the one or more fan bearings are positioned axially aft of the fan disk.

The turbofan engine of any preceding clause, wherein the fan disk extends between an inner surface and an outer surface, the one or more fan bearings being positioned radially outward of the outer surface.

The turbofan engine of any preceding clause, wherein the one or more fan bearings include at least one of roller bearings or ball bearings.

The turbofan engine of any preceding clause, wherein the ball bearings include four-point contact ball bearings.

The turbofan engine of any preceding clause, further comprising a compressor section, a combustion section, and a turbine section downstream of the fan, the turbine section having an input shaft that couples the compressor section to the turbine section, and a gearbox assembly, the fan shaft being drivingly coupled to the input shaft through the gearbox assembly.

The turbofan engine of any preceding clause, wherein the one or more fan bearings are positioned axially between the fan disk and the gearbox assembly.

The turbofan engine of any preceding clause, wherein the one or more fan bearings are positioned radially outward of the gearbox assembly.

A turbofan engine for an aircraft, the turbofan engine including a fan having a plurality of fan blades coupled to a fan disk that is drivingly coupled to a fan shaft, the fan disk defining a disk bore, and the fan being an open fan, a fan hub that directs an airflow through the plurality of fan blades, each of the plurality of fan blades being rotatable about a pitch axis and extending from the fan hub, one or more fan bearings that support rotation of the fan shaft, the one or more fan bearings being positioned radially outward of the disk bore, wherein a fan bearing radius ratio is in a range from 1.0 to 2.75, and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{F}H is in a range of 25 inches to 85 inches, and A_{FB} is in a range of 10 inches to 23 inches, and D_{FT} is in a range of 120.0 inches to 192.0 inches.

The turbofan engine of the preceding clause, wherein the turbofan engine has a fan hub radius ratio in a range from 0.1 to 0.4.

The turbofan engine of any preceding clause, wherein the one or more radial thrust bearings are tapered roller bearings.

The turbofan engine of any preceding clause, wherein the one or more fan bearings are positioned axially aft of the fan disk.

The turbofan engine of any preceding clause, wherein the fan disk extends between an inner surface and an outer surface, the one or more fan bearings being positioned radially outward of the outer surface.

The turbofan engine of any preceding clause, wherein the one or more fan bearings include at least one of roller bearings or ball bearings.

The turbofan engine of any preceding clause, wherein the ball bearings include four-point contact ball bearings.

The turbofan engine of any preceding clause, further comprising a compressor section, a combustion section, and a turbine section downstream of the fan, the turbine section having an input shaft that couples the compressor section to the turbine section, and a gearbox assembly, the fan shaft being drivingly coupled to the input shaft through the gearbox assembly.

The turbofan engine of any preceding clause, wherein the one or more fan bearings are positioned axially between the fan disk and the gearbox assembly.

The turbofan engine of any preceding clause, wherein the one or more fan bearings are positioned radially outward of the gearbox assembly.

A pitch change assembly for an aeronautical gas turbine engine having a plurality of airfoils, the pitch change assembly comprising: an ensemble actuator assembly comprising one or more ensemble actuators and a unison ring, the unison ring movable by actuation of the one or more ensemble actuators to collectively change a pitch angle of respective ones of the plurality of airfoils; and a unitary actuator assembly comprising a plurality of unitary actuators respectively coupled to a corresponding one of the plurality of airfoils, the plurality of unitary actuators respectively movable to change the pitch angle of the corresponding one of the plurality of airfoils.

The pitch change assembly of any preceding clause, wherein the pitch change assembly comprises a guide vane-pitch change assembly and wherein the plurality of airfoils comprise guide vanes, or wherein the pitch change assembly comprises a fan blade-pitch change assembly, and wherein the plurality of airfoils comprise fan blades.

The pitch change assembly any preceding clause, wherein the unison ring comprises: an outward unison ring; an inward unison ring; and a bearing assembly disposed between the inward unison ring and the outward unison ring.

The pitch change assembly any preceding clause, wherein the unison ring translates, collectively to respective ones of the plurality of airfoils, at least one of a linear motion and a rotary motion.

The pitch change assembly any preceding clause, wherein the ensemble actuator assembly comprises three ensemble actuators.

The pitch change assembly any preceding clause, wherein the aeronautical gas turbine engine comprises an open rotor aeronautical gas turbine engine.

A pitch change assembly for an aeronautical gas turbine engine having a plurality of guide vanes, the pitch change assembly comprising: one or more actuators configured to change a pitch angle of respective ones of the plurality of guide vanes; and a plurality of linkage arms that are respectively movable by actuation of at least one of the one or more actuators, wherein respective ones of the plurality of linkage arms are directly or indirectly coupled to a corresponding one of the plurality of guide vanes; wherein respective ones of the plurality of linkage arms have a length that differs from at least another one of the plurality of linkage arms respectively corresponding to another one of the plurality of guide vanes, wherein the length of a respective one of the plurality of linkage arms orients a displacement and/or a range of motion of the respective one of the plurality of linkage arms to an envelope of rotation of the corresponding one of the plurality of guide vanes about a guide vane axis, wherein the envelope of rotation of the corresponding one of the plurality of guide vanes differs from the envelope of rotation of at least another one of the plurality of guide vanes.

An open rotor aeronautical engine, comprising: a core engine; a plurality of unducted airfoils; and a pitch change assembly, comprising: an ensemble actuator assembly comprising one or more ensemble actuators and a unison ring, the unison ring movable by actuation of the one or more ensemble actuators to collectively change a pitch angle of respective ones of the plurality of unducted airfoils; and a unitary actuator assembly comprising a plurality of unitary actuators respectively coupled to a corresponding one of the plurality of unducted airfoils, the plurality of unitary actuators respectively movable to change the pitch angle of the corresponding one of the plurality of unducted airfoils.

The open rotor aeronautical engine any preceding clause, wherein the unison ring translates, collectively to respective ones of the plurality of unducted airfoils, at least one of a linear motion and a rotary motion.

The open rotor aeronautical engine any preceding clause, wherein the ensemble actuator assembly comprises three ensemble actuators.

The open rotor aeronautical engine any preceding clause, wherein the pitch change assembly comprises a guide vane-pitch change assembly, and wherein the plurality of unducted airfoils comprise guide vanes.

The open rotor aeronautical engine any preceding clause, wherein the pitch change assembly comprises a fan blade-pitch change assembly, and wherein the plurality of unducted airfoils comprise fan blades.

The open rotor aeronautical engine of any preceding clause, wherein the unison ring comprises: an outward unison ring; an inward unison ring; and a fan bearing assembly disposed between the inward unison ring and the outward unison ring.

The open rotor aeronautical engine of any preceding clause, wherein the outward unison ring defines part of a rotor portion of an unducted fan assembly, and the inward unison ring defines part of a stator portion of the unducted fan assembly.

The open rotor aeronautical engine any preceding clause, wherein the plurality of unitary actuators are respectively coupled to the unison ring.

The open rotor aeronautical engine of any preceding clause, wherein the unitary actuator assembly comprises a plurality of linkage arms, wherein respective ones of the plurality of linkage arms are respectively disposed between one of: the unison ring and a corresponding one of the plurality of unitary actuators, or the corresponding one of the plurality of unducted airfoils and the corresponding one of the plurality of unitary actuators.

The open rotor aeronautical engine of any preceding clause, wherein at least some of the plurality of linkage arms have a length that differs from at least another one of the plurality of linkage arms.

The open rotor aeronautical engine any preceding clause, wherein respective ones of the plurality of unitary actuators comprise: a first actuator mechanism that provides course adjustments to the pitch angle of the corresponding one of the plurality of unducted airfoils; and a second actuator mechanism that provides fine adjustments to the pitch angle of the corresponding one of the plurality of unducted airfoils.

The open rotor aeronautical engine any preceding clause, wherein the first actuator mechanism has a first stroke length corresponding to from 10% to 100% of a range of motion about a pitch axis of the corresponding one of the plurality of unducted airfoils, and wherein the second actuator mechanism has a second stroke length corresponding to from 1% to 40% of the range of motion of the pitch axis of the corresponding one of the plurality of unducted airfoils.

The open rotor aeronautical engine any preceding clause, wherein the pitch change assembly comprises: a plurality of subgroup actuator assemblies respectively comprising a subgroup actuator configured to change a pitch angle with respect to an airfoil subgroup corresponding to a respective subgroup actuator assembly from among the plurality of subgroup actuator assemblies, wherein the airfoil subgroup comprises a portion of the plurality of unducted airfoils.

The open rotor aeronautical engine any preceding clause, wherein the plurality of unducted airfoils comprise guide vanes, or wherein the plurality of unducted airfoils comprise fan blades; wherein the fan blades are located upstream from the guide vanes.

An open rotor aeronautical engine, comprising: a core engine; an unducted fan assembly comprising a plurality of fan blades; a guide vane assembly comprising a plurality of guide vanes extending outwardly from the core engine; a fan blade-pitch change assembly, comprising at least one of: an ensemble actuator assembly comprising one or more ensemble actuators and a unison ring, the unison ring movable by actuation of the one or more ensemble actuators to collectively change a pitch angle of respective ones of the plurality of fan blades; and a unitary actuator assembly comprising a plurality of unitary actuators respectively coupled to a corresponding one of the plurality of fan blades, the plurality of unitary actuators respectively movable to change the pitch angle of the corresponding one of the plurality of fan blades.

An open rotor aeronautical engine, comprising: a core engine; an unducted fan assembly comprising a plurality of fan blades; a guide vane assembly comprising a plurality of guide vanes extending outwardly from the core engine; a guide vane-pitch change assembly, comprising at least one of: an ensemble actuator assembly comprising one or more ensemble actuators and a unison ring, the unison ring movable by actuation of the one or more ensemble actuators to collectively change a pitch angle of respective ones of the plurality of guide vanes; and a unitary actuator assembly comprising a plurality of unitary actuators respectively coupled to a corresponding one of the plurality of guide vanes, the plurality of unitary actuators respectively movable to change the pitch angle of the corresponding one of the plurality of guide vanes.

An aeronautical gas turbine engine, comprising: a core engine; one or more sensors configured to provide sensor data indicative of an excitation load acting upon the aeronautical gas turbine engine; a plurality of airfoils; and a pitch change assembly comprising one or more actuators actuatable to individually and/or collectively change a pitch angle of respective ones of the plurality of airfoils; and an electronic controller configured to perform a method comprising: determining the excitation load acting upon the aeronautical gas turbine engine based at least in part on the sensor data; determining an airfoil pitch control command based at least in part on the excitation load; and outputting the airfoil pitch control command to the one or more actuators, wherein the airfoil pitch control command is configured to augment and/or compensate for the excitation load.

An open rotor aeronautical engine, comprising: a core engine; a plurality of guide vanes positioned within or extending from the core engine; and a pitch change assembly operably coupled to the plurality of guide vanes, the pitch change assembly comprising: one or more actuators configured to change a pitch angle of respective ones of the plurality of guide vanes; and a plurality of linkage arms that are respectively movable by actuation of at least one of the one or more actuators, wherein respective ones of the plurality of linkage arms are directly or indirectly coupled to a corresponding one of the plurality of guide vanes; wherein respective ones of the plurality of linkage arms have a length that differs from at least another one of the plurality of linkage arms respectively corresponding to another one of the plurality of guide vanes, wherein the length of a respective one of the plurality of linkage arms orients a displacement and/or a range of motion of the respective one of the plurality of linkage arms to an envelope of rotation of the corresponding one of the plurality of guide vanes about a guide vane axis, wherein the envelope of rotation of the corresponding one of the plurality of guide vanes differs from the envelope of rotation of at least another one of the plurality of guide vanes.

The open rotor aeronautical engine any preceding clause, wherein at a first position of the one or more actuators, the plurality of guide vanes have a uniform pitch angle as between respective ones of the plurality of guide vanes, and wherein at a second position of the one or more actuators, the plurality of guide vanes have a non-uniform pitch angle as between respective ones of the plurality of guide vanes.

The open rotor aeronautical engine any preceding clause, wherein at a first position of the one or more actuators, the plurality of guide vanes have a first non-uniform pitch angle as between respective ones of the plurality of guide vanes, and wherein at a second position of the one or more actuators, the plurality of guide vanes have a second non-uniform pitch angle as between respective ones of the plurality of guide vanes.

The open rotor aeronautical engine any preceding clause, wherein the pitch change assembly comprises: a unitary actuator assembly, wherein the one or more actuators respectively comprise a unitary actuator directly or indirectly coupled to a corresponding one of the plurality of guide vanes, the unitary actuator being movable to change the pitch angle of the corresponding one of the plurality of guide vanes.

The open rotor aeronautical engine any preceding clause, wherein the pitch change assembly comprises: an ensemble actuator assembly comprising the one or more actuators and a unison ring, wherein the unison ring is movable by actuating the one or more actuators to collectively change the pitch angle of respective ones of the plurality of guide vanes; wherein the plurality of linkage arms extend between the unison ring and the corresponding one of the plurality of guide vanes.

The open rotor aeronautical engine of any preceding clause, wherein the pitch change assembly comprises: a plurality of unitary actuators, wherein respective ones of the plurality of unitary actuators are disposed between a corresponding one of the plurality of linkage arms and a corresponding one of the plurality of guide vanes.

The open rotor aeronautical engine any preceding clause, wherein the plurality of guide vanes comprises a first guide vane and a second guide vane, wherein the first guide vane and the second guide vane are located at inversely disposed circumferential positions.

The open rotor aeronautical engine of any preceding clause, wherein the first guide vane has a first circumferential position corresponding to a horizontally leftward orientation, and wherein the second guide vane has a second circumferential position corresponding to a horizontally rightward orientation.

The open rotor aeronautical engine of any preceding clause, wherein the first circumferential position is from a seven o'clock position to an eleven o'clock position; and/or wherein the second circumferential position is from a one o'clock position to a five o'clock position.

The open rotor aeronautical engine of any preceding clause, wherein the first circumferential position is a nine o'clock position; and/or wherein the second circumferential position is a three o'clock position.

The open rotor aeronautical engine of any preceding clause, wherein the first guide vane has a first circumferential position and the second guide vane has a second circumferential position, and wherein the first circumferential position differs from the second circumferential position by π-radians+/−(1/3)-π-radians.

The open rotor aeronautical engine of any preceding clause, wherein the first circumferential position differs from the second circumferential position by π-radians+/−(1/6)-π-radians.

The open rotor aeronautical engine of any preceding clause, wherein the first circumferential position corresponds to a horizontally leftward orientation and the second circumferential position corresponds to a horizontally rightward orientation; or wherein the first circumferential position corresponds to a vertically upward orientation and the second circumferential position corresponds to a vertically downward orientation.

The open rotor aeronautical engine any preceding clause, comprising: an electronic controller, wherein the electronic controller is configured to actuate the one or more actuators to a first position during a cruise flight condition and to actuate the one or more actuators to a second position during at least one of: a climbing flight condition, a descending flight condition, and a takeoff flight condition.

The open rotor aeronautical engine any preceding clause, comprising: an electronic controller, wherein the electronic controller is configured to actuate the one or more actuators responsive to an excitation load acting upon the open rotor aeronautical engine.

The open rotor aeronautical engine any preceding clause, wherein the excitation load comprises an asymmetric load corresponding to one or more circumferential positions of respective ones of the plurality of guide vanes, and wherein the envelope of rotation of the respective ones of the plurality of guide vanes are selected at least in part to offset the asymmetric load at least partially.

The open rotor aeronautical engine any preceding clause, wherein the guide vanes comprise outlet guide vanes.

The open rotor aeronautical engine any preceding clause, wherein the guide vanes comprise inlet guide vanes.

The open rotor aeronautical engine any preceding clause, comprising: an unducted fan assembly rotatably driven by the core engine.

The open rotor aeronautical engine of any preceding clause, comprising: the pitch change assembly of any preceding clause.

A non-transitory computer-readable medium comprising computer-executable instructions, which when executed by a processor associated with an electronic controller for an aeronautical gas turbine engine, cause the electronic controller to perform a method of controlling the aeronautical gas turbine engine, the method comprising: determining, with the electronic controller, an airfoil pitch control command for at least one of a plurality of airfoils of the aeronautical gas turbine engine based at least in part on an excitation load acting upon the aeronautical gas turbine engine; and outputting, with the electronic controller, the airfoil pitch control command to one or more actuators actuatable to change a pitch angle of the at least one of the plurality of airfoils, wherein the airfoil pitch control command is configured to augment and/or compensate for the excitation load acting upon the aeronautical gas turbine engine.

The non-transitory computer-readable medium any preceding clause, wherein the plurality of airfoils comprises a plurality of fan blades, and wherein the airfoil pitch control command is configured to change a pitch angle of at least one of the plurality of fan blades; and/or wherein the plurality of airfoils comprises a plurality of guide vanes, and wherein the airfoil pitch control command is configured to change a pitch angle of at least one of the plurality of guide vanes.

The non-transitory computer-readable medium any preceding clause, wherein the excitation load comprises an asymmetric load.

The non-transitory computer-readable medium of any preceding clause, wherein the asymmetric load corresponds to a circumferential position of one or more of the unducted airfoils.

The non-transitory computer-readable medium of any preceding clause, wherein the asymmetric load comprises a cyclic load.

The non-transitory computer-readable medium of any preceding clause, wherein the cyclic load comprises a 1P load.

The non-transitory computer-readable medium any preceding clause, wherein the excitation load comprises an autogenous load.

The non-transitory computer-readable medium of any preceding clause, wherein the autogenous load comprises at least one of: an aeroelastic load and a gyroscopic load.

The non-transitory computer-readable medium of any preceding clause, wherein the excitation load acting upon the aeronautical gas turbine engine comprises an excitation load acting upon one or more of the plurality of fan blades.

The non-transitory computer-readable medium of any preceding clause, wherein the excitation load acting upon the aeronautical gas turbine engine comprises an excitation load acting upon one or more of the plurality of guide vanes.

The non-transitory computer-readable medium any preceding clause, wherein the plurality of airfoils comprises a plurality of fan blades and a plurality of guide vanes, and wherein the excitation load acting upon the aeronautical gas turbine engine comprises an excitation load acting upon one or more of the plurality of fan blades, and wherein the airfoil pitch control command is configured to change a pitch angle of at least one of the plurality of guide vanes.

The non-transitory computer-readable medium any preceding clause, wherein the excitation load comprises an asymmetric load corresponding to one or more circumferential positions of respective ones of the plurality of airfoils, and wherein the airfoil pitch control command is configured to at least partially offset the asymmetric load.

The non-transitory computer-readable medium any preceding clause, wherein the airfoil pitch control command for the at least one of the plurality of airfoils comprises one or more airfoil pitch control commands configured to change a first pitch angle of a first one of the plurality of airfoils and a second pitch angle of a second one of the plurality of airfoils; and wherein the first one of the plurality of airfoils and the second one of the plurality of airfoils are located at inversely disposed circumferential positions.

The non-transitory computer-readable medium of any preceding clause, wherein the one or more airfoil pitch control commands comprises: a first airfoil pitch control command configured to change the first pitch angle of the first one of the plurality of airfoils; and a second airfoil pitch control command configured to change the second pitch angle of the second one of the plurality of airfoils.

The non-transitory computer-readable medium of any preceding clause, wherein the one or more airfoil pitch control commands are configured to change at least one of: the first pitch angle of the first one of the plurality of airfoils at a circumferential position corresponding to a horizontally leftward orientation, and the second pitch angle of the second one of the plurality of airfoils at a circumferential position corresponding to a horizontally rightward orientation.

The non-transitory computer-readable medium of any preceding clause, wherein the circumferential position corresponding to the horizontally leftward orientation is from a seven o'clock position to an eleven o'clock position; and/or wherein the circumferential position corresponding to the horizontally rightward orientation is from a one o'clock position to a five o'clock position.

The non-transitory computer-readable medium any preceding clause, comprising further computer-executable instructions, which when executed by the processor, cause the electronic controller to further perform the method of controlling the aeronautical gas turbine engine, including: determining, with the electronic controller, the excitation load acting upon the aeronautical gas turbine engine, wherein the excitation load is determined based at least in part on sensor data from one or more sensors.

The non-transitory computer-readable medium of any preceding clause, wherein the excitation load acts upon the aeronautical gas turbine engine as a result of, or in relation to, one or more airfoil excitation phenomenon, the one or more airfoil excitation phenomenon comprising at least one of: a cyclic excitation and an autogenous excitation.

The non-transitory computer-readable medium of any preceding clause, wherein determining the excitation load comprises determining a variation in sensor values indicative of an autogenous excitation.

The non-transitory computer-readable medium of any preceding clause, wherein the autogenous excitation comprises at least one of: an aeroelastic excitation and a gyroscopic excitation.

The non-transitory computer-readable medium of any preceding clause, wherein determining the excitation load comprises at least one of: determining an amplitude of the sensor values and/or a slope of the amplitude of the sensor values; and/or determining a frequency of the sensor values and/or a slope of the frequency of the sensor values.

The non-transitory computer-readable medium of any preceding clause, wherein the method comprises: determining an aeroelastic load based at least in part on the amplitude of the sensor values and/or the frequency of the sensor values being greater than a threshold value.

The non-transitory computer-readable medium of any preceding clause, wherein the method comprises: determining a nominal operating condition based at least in part on the amplitude of the sensor values and/or the frequency of the sensor values being less than the threshold value.

The non-transitory computer-readable medium of any preceding clause, wherein the method comprises: determining an aeroelastic load based at least in part on the slope of the amplitude of the sensor values and/or the slope of the frequency of the sensor values being greater than a threshold slope.

The non-transitory computer-readable medium of any preceding clause, wherein the method comprises: determining a nominal operating condition based at least in part on the slope of the amplitude of the sensor values and/or the slope of the frequency of the sensor values being less than the threshold slope.

The non-transitory computer-readable medium any preceding clause, wherein determining the airfoil pitch control command comprises: determining a baseline schedule for the pitch angle of respective ones of the plurality of airfoils; and determining one or more changes to the baseline schedule, the one or more changes to the baseline schedule configured to change the pitch angle of one or more of the plurality of airfoils.

The non-transitory computer-readable medium any preceding clause, wherein determining the airfoil pitch control command comprises: determining a first airfoil pitch control command configured to actuate an ensemble actuator to collectively change the pitch angle of respective ones of the plurality of airfoils; and determining a second airfoil pitch control command configured to actuate one or more unitary actuators respectively configured to individually change the pitch angle of a respective one of the plurality of airfoils.

An excitation load control system for an aeronautical gas turbine engine, the excitation load control system comprising: one or more sensors configured to provide sensor data indicative of an excitation load acting upon the aeronautical gas turbine engine; a pitch change assembly comprising one or more actuators actuatable to individually and/or collectively change a pitch angle of respective ones of a plurality of airfoils of the aeronautical gas turbine engine; and an electronic controller configured to perform a method comprising: determining the excitation load acting upon the aeronautical gas turbine engine based at least in part on the sensor data; determining an airfoil pitch control command based at least in part on the excitation load; and outputting the airfoil pitch control command to the one or more actuators, wherein the airfoil pitch control command is configured to augment and/or compensate for the excitation load.

The excitation load control system of any preceding clause, wherein the one or more sensors comprise at least one of: one or more aerodynamic incidence sensors; one or more vibration sensors configured to perform vibration-based condition monitoring; and one or more strain gauges.

The excitation load control system of any preceding clause, wherein the one or more sensors comprises the one or more aerodynamic incidence sensors, wherein the one or more aerodynamic incidence sensors comprises at least one of: an angle of attack sensor and an angle of sideslip sensor.

The excitation load control system of any preceding clause, wherein the one or more sensors comprises the one or more vibration sensors, wherein the one or more vibration sensors comprises at least one of: an accelerometer, a strain gauge, an eddy-current sensor, an acoustic sensor, an optical displacement sensor, and a gyroscope.

The excitation load control system of any preceding clause, wherein the one or more sensors comprises the one or more vibration sensors, wherein the one or more vibration sensors are located on, at, within, or in proximity to at least one of: one or more bearing assemblies of the aeronautical gas turbine engine; a fan assembly of the aeronautical gas turbine engine; and a guide vane assembly of the aeronautical gas turbine engine.

The excitation load control system of any preceding clause, wherein the one or more sensors comprises the one or more strain gauges, wherein the one or more strain gauges are coupled to and/or contained within respective ones of the plurality of airfoils.

The excitation load control system of any preceding clause, wherein the one or more sensors comprises the one or more strain gauges, wherein the one or more strain gauges are coupled to and/or contained within an engine support structure of the aeronautical gas turbine engine.

The excitation load control system of any preceding clause, comprising: one or more position indicators configured to determine a circumferential position at least one of the plurality of airfoils, and/or one or more pitch angle indicators respectively configured to determine a pitch angle of at least one of the plurality of airfoils.

The excitation load control system of any preceding clause, wherein the plurality of airfoils comprises at least one of: a plurality of fan blades, and a plurality of guide vanes.

The excitation load control of any preceding clause, wherein the aeronautical gas turbine engine comprises an open rotor aeronautical gas turbine engine.

A method of controlling an aeronautical gas turbine engine, the method comprising: determining, with an electronic controller, an airfoil pitch control command for at least one of a plurality of airfoils of the aeronautical gas turbine engine based at least in part on an excitation load acting upon the aeronautical gas turbine engine; and outputting, with the electronic controller, the airfoil pitch control command to one or more actuators actuatable to change a pitch angle of the at least one of the plurality of airfoils, wherein the airfoil pitch control command is configured to augment and/or compensate for the excitation load acting upon the aeronautical gas turbine engine.

The method of any preceding clause, wherein the method is performed using the open rotor gas turbine engine of any preceding clause.

The method of any preceding clause, wherein the method is performed using the excitation load control system of any preceding clause.

The method of any preceding clause, wherein the method is performed using the non-transitory computer-readable medium of any preceding clause.

A controller configured to perform one or more of the steps of a method of any preceding clause.

A gas turbine engine comprising a means for performing one or more of the steps of a method of any preceding clause.

A turbofan engine for an aircraft, the turbofan engine comprising: a fan having a plurality of fan blades coupled to a fan shaft having one or more fan bearings, each of the plurality of fan blades being rotatable about a pitch axis and extending from a fan hub; one or more sensors configured to provide sensor data indicative of an excitation load acting upon the turbofan engine; a fan actuation system disposed within the fan hub and including one or more actuators for rotating the plurality of fan blades about the pitch axis and one or more radial thrust bearings; and an electronic controller configured to perform a method comprising: determining the excitation load acting upon the turbofan engine based at least partially on the sensor data, determining an airfoil pitch control command based at least partially on the excitation load, and outputting the airfoil pitch control command to the fan actuation system, wherein the airfoil pitch control command is configured to augment or compensate for the excitation load; wherein the fan actuation system is characterized by a fan actuation system length envelope in a range of 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )} ;$$

and wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

The turbofan engine of any preceding clause, wherein: the airfoil pitch control command includes instructions to actuate an ensemble actuator assembly including one or more ensemble actuators mounted to a fan case, one or more unitary actuators, each of the one or more unitary actuators connected to one of the plurality of fan blades, and a unison ring operably connecting the one or more ensemble actuators to the one or more unitary actuators; and the airfoil pitch control command includes instructions to actuate the one or more ensemble actuators to translate the unison ring to change the respective pitch angle of respective ones of the plurality of fan blades.

The turbofan engine of any preceding clause, wherein the airfoil pitch control command is configured to change a pitch angle of at least one of the plurality of fan blades; and/or wherein the turbofan engine further comprises a plurality of guide vanes, and wherein the airfoil pitch control command is configured to change a pitch angle of at least one of the plurality of guide vanes.

The turbofan engine of any preceding clause, further comprising a plurality of guide vanes, and wherein the excitation load acting upon the turbofan engine comprises an excitation load acting upon one or more of the plurality of fan blades, and wherein the airfoil pitch control command is configured to change a pitch angle of at least one of the plurality of guide vanes.

The turbofan engine of any preceding clause, wherein the excitation load comprises an asymmetric load corresponding to one or more circumferential positions of respective ones of the plurality of fan blades, and wherein the airfoil pitch control command is configured to at least partially offset the asymmetric load.

The turbofan engine of any preceding clause, wherein the airfoil pitch control command for the at least one of the plurality of fan blades comprises one or more airfoil pitch control commands configured to change a first pitch angle of a first one of the plurality of fan blades and a second pitch angle of a second one of the plurality of fan blades; and wherein the first one of the plurality of fan blades and the second one of the plurality of fan blades are located at inversely disposed circumferential positions.

The turbofan engine of any preceding clause, wherein the one or more airfoil pitch control commands comprises: a first airfoil pitch control command configured to change the first pitch angle of the first one of the plurality of fan blades; and a second airfoil pitch control command configured to change the second pitch angle of the second one of the plurality of fan blades.

The turbofan engine of any preceding clause, wherein the one or more airfoil pitch control commands are configured to change at least one of: the first pitch angle of the first one of the plurality of fan blades at a circumferential position corresponding to a horizontally leftward orientation, and the second pitch angle of the second one of the plurality of fan blades at a circumferential position corresponding to a horizontally rightward orientation.

The turbofan engine of any preceding clause, wherein the circumferential position corresponding to the horizontally leftward orientation is from a seven o'clock position to an eleven o'clock position; and/or wherein the circumferential position corresponding to the horizontally rightward orientation is from a one o'clock position to a five o'clock position.

The turbofan engine of any preceding clause, comprising further computer-executable instructions, which when executed by the processor, cause the electronic controller to further perform the method of controlling the turbofan engine, including: determining, with the electronic controller, the excitation load acting upon the turbofan engine, wherein the excitation load is determined based at least in part on sensor data from one or more sensors.

The turbofan engine of any preceding clause, wherein the excitation load acts upon the turbofan engine as a result of, or in relation to, one or more airfoil excitation phenomenon, the one or more airfoil excitation phenomenon comprising at least one of: a cyclic excitation and an autogenous excitation.

The turbofan engine of any preceding clause, wherein determining the excitation load comprises determining a variation in sensor values indicative of an autogenous excitation.

The turbofan engine of any preceding clause, wherein determining the excitation load comprises at least one of: determining an amplitude of the sensor values and/or a slope of the amplitude of the sensor values; and/or determining a frequency of the sensor values and/or a slope of the frequency of the sensor values.

The turbofan engine of any preceding clause, wherein determining the airfoil pitch control command comprises: determining a baseline schedule for the pitch angle of respective ones of the plurality of fan blades; and determining one or more changes to the baseline schedule, the one or more changes to the baseline schedule configured to change the pitch angle of one or more of the plurality of fan blades.

The turbofan engine of any preceding clause, wherein determining the airfoil pitch control command comprises: determining a first airfoil pitch control command configured to actuate an ensemble actuator to collectively change the pitch angle of respective ones of the plurality of fan blades; and determining a second airfoil pitch control command configured to actuate one or more unitary actuators respectively configured to individually change the pitch angle of a respective one of the plurality of fan blades.

A turbofan engine for an aircraft, the turbofan engine comprising: a fan having a plurality of fan blades coupled to a fan shaft having one or more fan bearings, each of the plurality of fan blades being rotatable about a pitch axis and extending from a fan hub; a nacelle that circumferentially surrounds the fan; one or more sensors configured to provide sensor data indicative of an excitation load acting upon the turbofan engine; a fan actuation system disposed within the fan hub and including one or more actuators for rotating the plurality of fan blades about the pitch axis and one or more radial thrust bearings; and an electronic controller configured to perform a method comprising: determining the excitation load acting upon the turbofan engine based at least partially on the sensor data, determining an airfoil pitch control command based at least partially on the excitation load, and outputting the airfoil pitch control command to the fan actuation system, wherein the airfoil pitch control command is configured to augment or compensate for the excitation load; wherein the fan actuation system is characterized by a fan actuation system length envelope in a range of 8.5 to 13, the fan actuation system length envelope being given by:

$$\frac{{N}_{FB} \times {D}_{FT}}{{L}_{AXIAL} \times ( \frac{{R}_{TB}}{{N}_{FB}} )} ;$$

and wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 40 inches, and A_{FB} is in a range of 17 inches to 20 inches.

A turbofan engine for an aircraft, the turbofan engine comprising: a fan having a plurality of fan blades coupled to a fan shaft having one or more fan bearings, the fan being an open fan, and each of the plurality of fan blades being rotatable about a pitch axis and extending from a fan hub; one or more sensors configured to provide sensor data indicative of an excitation load acting upon the turbofan engine; a fan actuation system disposed within the fan hub and including one or more actuators for rotating the plurality of fan blades about the pitch axis and one or more radial thrust bearings; and an electronic controller configured to perform a method comprising: determining the excitation load acting upon the turbofan engine based at least partially on the sensor data, determining an airfoil pitch control command based at least partially on the excitation load, and outputting the airfoil pitch control command to the fan actuation system, wherein the airfoil pitch control command is configured to augment or compensate for the excitation load; wherein the fan actuation system is characterized by a fan actuation system length envelope in a range of 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )} ;$$

and wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{F}H is in a range of 25 inches to 75 inches, and A_{FB} is in a range of 16 inches to 23 inches, and D_{FT} is in a range of 120.0 inches to 180.0 inches.

The turbofan engine of any preceding clause, wherein the one or more sensors comprise at least one of: one or more aerodynamic incidence sensors; one or more vibration sensors configured to perform vibration-based condition monitoring; and one or more strain gauges.

The turbofan engine of any preceding clause, comprising: one or more position indicators configured to determine a circumferential position at least one of the plurality of fan blades, and/or one or more pitch angle indicators respectively configured to determine a pitch angle of at least one of the plurality of fan blades.

The turbofan engine of any preceding clause, wherein the turbofan engine comprises an open rotor aeronautical gas turbine engine.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. A turbofan engine for an aircraft, the turbofan engine comprising:
a fan having a plurality of fan blades coupled to a fan shaft having one or more fan bearings, each of the plurality of fan blades being rotatable about a pitch axis and extending from a fan hub;
one or more sensors configured to provide sensor data indicative of an excitation load acting upon the turbofan engine;
a fan actuation system disposed within the fan hub and including one or more actuators for rotating the plurality of fan blades about the pitch axis and one or more radial thrust bearings; and
an electronic controller configured to perform a method comprising:
determining the excitation load acting upon the turbofan engine based at least partially on the sensor data,
determining an airfoil pitch control command based at least partially on the excitation load, and
outputting the airfoil pitch control command to the fan actuation system, wherein the airfoil pitch control command is configured to augment or compensate for the excitation load;
wherein the fan actuation system is characterized by a fan actuation system length envelope in a range of 8.5 to 24, the fan actuation system length envelope being given by:
$$\frac{{N}_{FB} \times {D}_{FT}}{{L}_{AXIAL} \times ( \frac{{R}_{TB}}{{N}_{FB}} )}$$
wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

2. The turbofan engine of claim 1, wherein:
the airfoil pitch control command includes instructions to actuate an ensemble actuator assembly including one or more ensemble actuators mounted to a fan case, one or more unitary actuators, each of the one or more unitary actuators connected to one of the plurality of fan blades, and a unison ring operably connecting the one or more ensemble actuators to the one or more unitary actuators; and
the airfoil pitch control command includes instructions to actuate the one or more ensemble actuators to translate the unison ring to change the respective pitch angle of respective ones of the plurality of fan blades.

3. The turbofan engine of claim 1, further comprising a plurality of guide vanes, and wherein the airfoil pitch control command is configured to change a pitch angle of at least one of the plurality of guide vanes.

4. The turbofan engine of claim 1, further comprising a plurality of guide vanes, and wherein the excitation load acting upon the turbofan engine comprises an excitation load acting upon one or more of the plurality of fan blades, and wherein the airfoil pitch control command is configured to change a pitch angle of at least one of the plurality of guide vanes.

5. The turbofan engine of claim 1, wherein the excitation load comprises an asymmetric load corresponding to one or more circumferential positions of respective ones of the plurality of fan blades, and wherein the airfoil pitch control command is configured to at least partially offset the asymmetric load.

6. The turbofan engine of claim 1, wherein the airfoil pitch control command for the at least one of the plurality of fan blades comprises one or more airfoil pitch control commands configured to change a first pitch angle of a first one of the plurality of fan blades and a second pitch angle of a second one of the plurality of fan blades; and
wherein the first one of the plurality of fan blades and the second one of the plurality of fan blades are located at inversely disposed circumferential positions.

7. The turbofan engine of claim 6, wherein the one or more airfoil pitch control commands comprises:
a first airfoil pitch control command configured to change the first pitch angle of the first one of the plurality of fan blades; and
a second airfoil pitch control command configured to change the second pitch angle of the second one of the plurality of fan blades.

8. The turbofan engine of claim 6, wherein the one or more airfoil pitch control commands are configured to change at least one of: the first pitch angle of the first one of the plurality of fan blades at a circumferential position corresponding to a horizontally leftward orientation, and the second pitch angle of the second one of the plurality of fan blades at a circumferential position corresponding to a horizontally rightward orientation.

9. The turbofan engine of claim 8, wherein the circumferential position corresponding to the horizontally leftward orientation is from a seven o'clock position to an eleven o'clock position;
and/or wherein the circumferential position corresponding to the horizontally rightward orientation is from a one o'clock position to a five o'clock position.

10. The turbofan engine of claim 1, comprising further computer-executable instructions, which when executed by a processor, cause the electronic controller to further perform the method of controlling the turbofan engine, including:
determining, with the electronic controller, the excitation load acting upon the turbofan engine, wherein the excitation load is determined based at least in part on sensor data from one or more sensors.

11. The turbofan engine of claim 10, wherein the excitation load acts upon the turbofan engine as a result of, or in relation to, one or more airfoil excitation phenomenon, the one or more airfoil excitation phenomenon comprising at least one of: a cyclic excitation and an autogenous excitation.

12. The turbofan engine of claim 10, wherein determining the excitation load comprises determining a variation in sensor values indicative of an autogenous excitation.

13. The turbofan engine of claim 12, wherein determining the excitation load comprises at least one of:
determining an amplitude of the sensor values and/or a slope of the amplitude of the sensor values; and/or
determining a frequency of the sensor values and/or a slope of the frequency of the sensor values.

14. The turbofan engine of claim 1, wherein determining the airfoil pitch control command comprises:
determining a baseline schedule for the pitch angle of respective ones of the plurality of fan blades; and
determining one or more changes to the baseline schedule, the one or more changes to the baseline schedule configured to change the pitch angle of one or more of the plurality of fan blades.

15. The turbofan engine of claim 1, wherein determining the airfoil pitch control command comprises:
determining a first airfoil pitch control command configured to actuate an ensemble actuator to collectively change the pitch angle of respective ones of the plurality of fan blades; and
determining a second airfoil pitch control command configured to actuate one or more unitary actuators respectively configured to individually change the pitch angle of a respective one of the plurality of fan blades.

16. A turbofan engine for an aircraft, the turbofan engine comprising:
a fan having a plurality of fan blades coupled to a fan shaft having one or more fan bearings, each of the plurality of fan blades being rotatable about a pitch axis and extending from a fan hub;
a nacelle that circumferentially surrounds the fan;
one or more sensors configured to provide sensor data indicative of an excitation load acting upon the turbofan engine;
a fan actuation system disposed within the fan hub and including one or more actuators for rotating the plurality of fan blades about the pitch axis and one or more radial thrust bearings; and
an electronic controller configured to perform a method comprising:
determining the excitation load acting upon the turbofan engine based at least partially on the sensor data,
determining an airfoil pitch control command based at least partially on the excitation load, and
outputting the airfoil pitch control command to the fan actuation system, wherein the airfoil pitch control command is configured to augment or compensate for the excitation load;
wherein the fan actuation system is characterized by a fan actuation system length envelope in a range of 8.5 to 13, the fan actuation system length envelope being given by:
$$\frac{{N}_{FB} \times {D}_{FT}}{{L}_{AXIAL} \times ( \frac{{R}_{TB}}{{N}_{FB}} )}$$
wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{F}H is in a range of 25 inches to 40 inches, and A_{FB} is in a range of 17 inches to 20 inches.

17. A turbofan engine for an aircraft, the turbofan engine comprising:
a fan having a plurality of fan blades coupled to a fan shaft having one or more fan bearings, the fan being an open fan, and each of the plurality of fan blades being rotatable about a pitch axis and extending from a fan hub;
one or more sensors configured to provide sensor data indicative of an excitation load acting upon the turbofan engine;
a fan actuation system disposed within the fan hub and including one or more actuators for rotating the plurality of fan blades about the pitch axis and one or more radial thrust bearings; and
an electronic controller configured to perform a method comprising:
determining the excitation load acting upon the turbofan engine based at least partially on the sensor data,
determining an airfoil pitch control command based at least partially on the excitation load, and
outputting the airfoil pitch control command to the fan actuation system, wherein the airfoil pitch control command is configured to augment or compensate for the excitation load;
wherein the fan actuation system is characterized by a fan actuation system length envelope in a range of 8.5 to 24, the fan actuation system length envelope being given by:
$$\frac{{N}_{FB} \times {D}_{FT}}{{L}_{AXIAL} \times ( \frac{{R}_{TB}}{{N}_{FB}} )}$$
wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{F}H is in a range of 25 inches to 75 inches, and A_{FB} is in a range of 16 inches to 23 inches, and D_{FT} is in a range of 120.0 inches to 180.0 inches.

18. The turbofan engine of claim 17, wherein the one or more sensors comprise at least one of: one or more aerodynamic incidence sensors;
one or more vibration sensors configured to perform vibration-based condition monitoring; and
one or more strain gauges.

19. The turbofan engine of claim 18, comprising:
one or more position indicators configured to determine a circumferential position at least one of the plurality of fan blades, and/or
one or more pitch angle indicators respectively configured to determine a pitch angle of at least one of the plurality of fan blades.

20. The turbofan engine of claim 17, wherein the turbofan engine comprises an open rotor aeronautical gas turbine engine.
